(19) United States
(12) Patent Application Publication
(10) Pub. No.: US 2016/0320738 A1
(43) Pub. Date: Nov. 3, 2016

(54) PHOTOCONDUCTOR CLEANING DEVICE, PROCESS CARTRIDGE, AND IMAGE FORMING APPARATUS

(71) Applicants: Takaaki TAWADA, Kanagawa (JP); Kazuhiko WATANABE, Tokyo (JP); Yuu SAKAKIBARA, Hokkaido (JP); Eisuke SHIMIZU, Tokyo (JP); Takuya SEKINE, Kanagawa (JP); Ryuji YOSHIDA, Kanagawa (JP)

(72) Inventors: Takaaki TAWADA, Kanagawa (JP); Kazuhiko WATANABE, Tokyo (JP); Yuu SAKAKIBARA, Hokkaido (JP); Eisuke SHIMIZU, Tokyo (JP); Takuya SEKINE, Kanagawa (JP); Ryuji YOSHIDA, Kanagawa (JP)

(73) Assignee: Ricoh Company, Ltd., Tokyo (JP)

(21) Appl. No.: 15/138,779

(22) Filed: Apr. 26, 2016

(30) Foreign Application Priority Data
Apr. 28, 2015 (JP) 2015-091619
Aug. 18, 2015 (JP) 2015-161069
Aug. 21, 2015 (JP) 2015-163497
Nov. 17, 2015 (JP) 2015-224991

(51) Int. Cl. G03G 21/00

(52) U.S. Cl. CPC G03G 21/0005; G03G 21/18

(57) ABSTRACT

A photoconductor cleaning device includes a photoconductor, a cleaner, and a roller. The cleaner is disposed in contact with the photoconductor to remove adhered substances on a surface of the photoconductor. The charger charges the photoconductor. The roller is disposed between the cleaner and the charger to remove adhered substances on the surface of the photoconductor.

### CROSS-REFERENCE TO RELATED APPLICATIONS

This patent application is based on and claims priority pursuant to 35 U.S.C. §119(a) to Japanese Patent Application No. 2015-091619, filed on Apr. 28, 2015, Japanese Patent Application No. 2015-161069, filed on Aug. 18, 2015, Japanese Patent Application No. 2015-163497, filed on Aug. 21, 2015, and Japanese Patent Application No. 2015-224991, filed on Nov. 17, 2015, in the Japan Patent Office, the entire disclosure of each of which is incorporated by reference herein.

### BACKGROUND

1. Technical Field

Embodiments of this disclosure relate to a photoconductor cleaning device, a process cartridge, and an image forming apparatus.

2. Related Art

It is necessary to extend the service life of photoconductors to improve the reliability and the service life of image forming apparatuses. When the wear resistance of a photoconductor is improved to extend the service life of a photoconductor, a foreign substance such as toner or external additives thereof may adhere and accumulate on the surface of the photoconductor due to the property of rarely peeling off, and an abnormal image such as white spots may occur due to the foreign substance adhering to and accumulating on the surface of the photoconductor.

In the past, in order to reduce the occurrence of such an abnormal image, a photoconductor cleaning device in which a roller such as a cleaning roller and a cleaner such as a cleaning blade are disposed in contact with a photoconductor to remove an adhered substance on the surface of the photoconductor has been known.

### SUMMARY

In an aspect of the present disclosure, there is provided a photoconductor cleaning device that includes a photoconductor, a cleaner, and a roller. The cleaner is disposed in contact with the photoconductor to remove adhered substances on a surface of the photoconductor. The charger charges the photoconductor. The roller is disposed between the cleaner and the charger to remove adhered substances on the surface of the photoconductor.

In another aspect of the present disclosure, there is provided a process cartridge that includes the photoconductor cleaning device. The process cartridge is configured to be detachably attachable relative to an image forming apparatus.

In still another aspect of the present disclosure, there is provided an image forming apparatus that includes the photoconductor cleaning device and a transfer unit configured to transfer an image from the photoconductor onto a recording medium.

In still yet another aspect of the present disclosure, there is provided an image forming apparatus that includes the photoconductor cleaning device and the photoconductor. The photoconductor bears a toner image on the surface of the photoconductor and rotate forward and in reverse. The photoconductor rotates in reverse when image formation is not performed. The roller rotates following the photoconductor during forward rotation of the photoconductor and stops rotating or rotates in the direction opposite to the direction of rotation of the photoconductor during reverse rotation of the photoconductor.

### BRIEF DESCRIPTION OF THE SEVERAL VIEWS OF THE DRAWINGS

The aforementioned and other aspects, features, and advantages of the present disclosure would be better understood by reference to the following detailed description when considered in connection with the accompanying drawings, wherein:

FIG. 1 is a schematic view of a configuration of a printer 100 according to an embodiment;

FIGS. 2A and 2B are schematic views of a configuration of an example of an image forming unit provided in the printer;

FIG. 3 is a schematic view of a configuration of an example of an image forming unit provided in a conventional image forming apparatus;

FIGS. 4A and 4B are illustrations of a configuration of the surface of a photoconductor provided in an image forming unit according to Example 1;

FIGS. 5A and 5B are illustrations of a configuration of a polishing roller according to Example 1;

FIG. 6 is an illustration of a mechanism of removing an adhered substance from a photoconductor when an elastic material that forms projections of the polishing roller according to Example 1 is formed using a foamed urethane which is a foamed material;

FIGS. 7A and 7B are illustrations of a change in a longitudinal direction, in the thickness of toner supplied to a polishing roller depending on a difference in location;

FIG. 8 is a schematic view of a configuration of an image forming unit according to Example 2;

FIG. 9 is an illustration of a pressing direction in which a polishing roller of a photoconductor cleaning device according to Example 2 presses a photoconductor;

FIG. 10 is an illustration of a polishing roller provided in a photoconductor cleaning device according to Example 3;

FIG. 11 is a schematic view of a configuration of an image forming unit according to Example 4;

FIGS. 12A and 12B are illustrations of a change over time in a blade edge which deforms when a cleaning blade slides on the surface of a photoconductor;

FIGS. 13A and 13B are illustrations of a pressure regulator that regulates the pressure on a photoconductor, of a removing roller according to Example 4;

FIG. 14 is a graph illustrating an example of regulating the pressure of the removing roller according to Example 4, corresponding to a photoconductor use time;

FIG. 15 is a schematic view of a configuration of an image forming unit according to Example 5;

FIGS. 16A and 16B are illustrations of a change in an outer diameter of a melamine roller according to Example 5;

FIG. 17 is a graph illustrating a change in the pressure and the outer diameter of the melamine roller according to Example 5, corresponding to a photoconductor use time;

FIGS. 18A and 18B are illustrations of a method for manufacturing the melamine roller according to Example 5;

FIG. 19 is a schematic view of a configuration of an image forming unit according to Example 6;

FIG. 20 is a graph illustrating an example of regulating a number of rotations of a removing roller according to Example 6, corresponding to a photoconductor use time;

FIG. 21 is a schematic view of a configuration of an image forming unit according to Example 7;

FIGS. 22A and 22B are illustrations of a change over time of a melamine roller according to Example 7, in which inorganic fine particles are added to the surface thereof;

FIG. 23 is a schematic view of a configuration of an image forming unit 121 according to Example 8;

FIG. 24 is an illustration of a contact pressure variation occurring at the end and the center of a roller of which the outer diameter is uniform in a longitudinal direction;

FIG. 25 is an illustration of toner held on the surface of a roller disposed on an upstream side of a cleaning blade;

FIG. 26 is an illustration of an example of a melamine roller according to Example 8, in which the outer diameter at the center is larger than the outer diameter at the ends;

FIG. 27 is an illustration of a state in which the outer diameter at the center is larger than the outer diameter at the ends to reduce a contact pressure variation in an axial direction of a photoconductor;

FIGS. 28A, 28B, and 28C (collectively referred to as FIG. 28) illustrate a verification test result for a configuration in which an outer diameter at the center of a melamine roller is larger than the outer diameter at the ends;

FIG. 29 is an illustration of another example of a melamine roller according to Example 8 in which an outer diameter at the center is larger than the outer diameter at the ends;

FIG. 30 is an illustration of an example in which a central flat portion is provided in the melamine roller according to Example 8;

FIGS. 31A, 31B, and 31C (collectively referred to as FIG. 31) illustrate a verification test result for a configuration in which a flat portion is provided in a melamine roller;

FIG. 32 is a schematic view of a configuration of an image forming unit according to Example 9;

FIG. 33 is an illustration of a melamine roller according to Example 9;

FIG. 34 is an illustration of a contact pressure variation on a photoconductor, which can be reduced by the melamine roller according to Example 9;

FIGS. 35A, 35B, and 35C (collectively referred to as FIG. 35) illustrate a verification test result for a configuration in which the hardness at the center of a melamine roller is higher than the hardness at the ends;

FIGS. 36A through 36E (collectively referred to as FIG. 36) illustrate verification test result 1 for a configuration in which the outer diameter at the center of a melamine roller is different from the outer diameter at the ends and the hardness at the center is higher than the hardness at the ends;

FIGS. 37A through 36E (collectively referred to as FIG. 37) illustrate verification test result 2 for a configuration in which the outer diameter at the center of a melamine roller is different from the outer diameter at the ends and the hardness at the center is higher than the hardness at the ends;

FIG. 38 is an illustration of a configuration in which a buck-up support formed of a metal plate is disposed in contact with a contact portion between a melamine roller and a photoconductor on the opposite side from the melamine roller in a circumferential direction;

FIG. 39 is an illustration of a configuration in which a back-up roller formed of a metal plate is disposed in contact with a contact portion between a melamine roller and a photoconductor on the opposite side from the melamine roller in a circumferential direction;

FIG. 40 is an illustration of a configuration in which a buck-up support is disposed at the center of a melamine roller only;

FIG. 41 is an enlarged schematic front view of a portion near a photoconductor according to an embodiment of the present disclosure;

FIG. 42A is a schematic front view illustrating a configuration of a drive assembly of a polisher (shoal-shaped toner removing roller) according to an embodiment and an operation during forward rotation of a photoconductor and FIG. 42B is a perspective view seen from the downstream side in a conveyance direction;

FIG. 43A is a schematic front view illustrating a configuration of a drive assembly of the grinder according to the embodiment and an operation during reverse rotation of a photoconductor and FIG. 43B is a perspective view seen from the downstream side in a conveyance direction;

FIG. 44A is a schematic front view illustrating a configuration of a drive assembly of a polisher according to another embodiment and an operation during forward rotation of a photoconductor and FIG. 44B is a perspective view seen from the downstream side in a conveyance direction;

FIG. 45A is a schematic front view illustrating a configuration of a drive assembly of a polisher according to the embodiment and an operation during reverse rotation of a photoconductor and FIG. 45B is a perspective view seen from the downstream side in a conveyance direction;

FIG. 46A illustrates the relation between the amount of shoal-shaped toner aggregates formed on the surface of a photoconductor and the torque during reverse rotation of the photoconductor, FIG. 46B illustrates the relation between the torque during reverse rotation of the photoconductor and a reverse rotation operation time, FIG. 46C illustrates the correlation between a motor current value and the torque, and FIG. 46D illustrates a configuration of a circuit that calculates the torque of a photoconductor from the value of electric current flowing into a motor to control the reverse rotation time;

FIG. 47 illustrates an example of a configuration for removing toner aggregates according to another embodiment of the present disclosure;

FIGS. 48A and 48B are a perspective view and a front view illustrating an example of a configuration for detecting the rotational position of a photoconductor; and

FIG. 49 illustrates an example of a configuration of coating a polisher with alumina.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

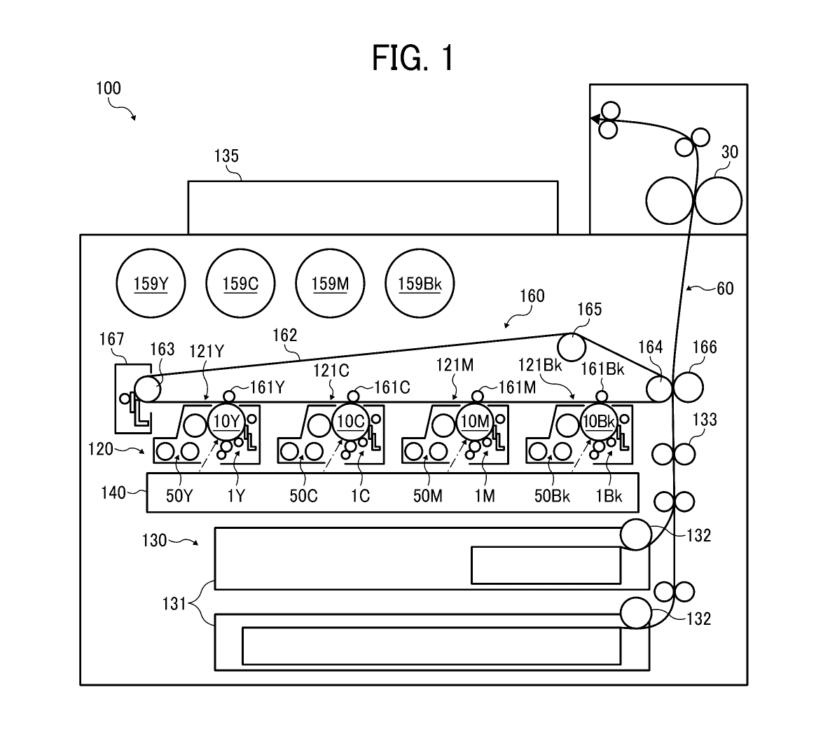

Hereinafter, an embodiment of an electrophotographic printer (hereinafter referred to as a printer 100) will be described as an example of an image forming apparatus having a photoconductor cleaning device to which the present disclosure is applied. FIG. 1 is a schematic view of a configuration of the printer 100 according to the present embodiment. The printer 100 is a tandem-system image forming apparatus that forms full-color images and forms color images using toner of the colors yellow (Y), cyan (C), magenta (M), and black (Bk). The printer 100 mainly includes an image forming section 120, an intermediate transfer section 160, and a sheet feeder 130. In the following description, components indicated by reference codes with the letters Y, C, M, and Bk are components for the colors yellow, cyan, magenta, and black, respectively.

The printer 100 includes a sheet feeder 130 in which two sheet feed cassettes 131 that store sheets of paper as a recording medium are disposed in a lower portion and an image forming section 120 and an intermediate transfer section 160 are disposed on an upper side. In the image forming section 120, an image forming unit 121Y for yellow toner, an image forming unit 121C for cyan toner, an image forming unit 121M for magenta toner, and an image forming unit 121Bk for black toner are provided. These image forming units 121Y, 121C, 121M, and 121Bk are arranged in a line approximately in a horizontal direction and are configured as a process cartridge 122 and are integrally detachably attached to the printer 100.

The intermediate transfer section 160 includes an intermediate transfer belt 162 as an intermediate transfer body configured as a flexible endless belt wound around a plurality of stretching rollers, primary transfer rollers 161Y, 161C, 161M, and 161Bk, and a secondary transfer roller 166. The intermediate transfer belt 162 is disposed above the image forming units 121Y, 121C, 121M, and 121Bk along a direction of movement of the surface of drum-shaped photoconductors 10Y, 10C, 10M, and 10Bk as an image bearer (latent image bearer) which is provided in each image forming unit 121 to perform surface movement. The intermediate transfer belt 162 performs surface movement in synchronization with the surface movement of the photoconductors 10Y, 10C, 10M, and 10Bk. The primary transfer rollers 161Y, 161C, 161M, and 161Bk are disposed along an inner circumferential surface of the intermediate transfer belt 162, and the surface of the intermediate transfer belt 162 is weakly pressed against the surfaces of the photoconductors 10Y, 10C, 10M, and 10Bk by the primary transfer rollers 161Y, 161C, 161M, and 161Bk.

The plurality of stretching rollers around which the intermediate transfer belt 162 is wound include a drive roller 163 on the left side in FIG. 1, a secondary transfer back-up roller 164 on the right side in FIG. 1, and a driven roller 165 and the primary transfer rollers 161Y, 161C, 161M, and 161Bk on the upper side in FIG. 1. Moreover, a secondary transfer roller 166 as a secondary transfer device is disposed around the intermediate transfer belt 162 at a position at which the secondary transfer roller 166 faces a conveyance path 60 of sheets opposite the secondary transfer back-up roller 164. On the other hand, the belt cleaning device 167 that cleans the belt surface is provided at a position opposite the drive roller 163.

Toner bottles 159Y, 159C, 159M, and 159Bk corresponding to the image forming units 121Y, 121C, 121M, and 121Bk are arranged above the intermediate transfer section 160 approximately in a horizontal direction. Moreover, an exposure device 140 that irradiates the uniformly charged surfaces of the photoconductors 10Y, 10C, 10M, and 10Bk with laser light to form electrostatic latent images is disposed below the image forming units 121Y, 121C, 121M, and 121Bk.

The sheet feeder 130 is disposed below the exposure device 140. A sheet feed cassette 131 that stores sheets as a recording medium and a sheet feed roller 132 are provided in the sheet feeder 130. A sheet is fed toward a secondary transfer nip between the intermediate transfer belt 162 and the secondary transfer roller 166 via a registration roller pair 133 at a predetermined timing. The fixing device 30 that fixes a toner image to a sheet is disposed on the downstream side in a sheet conveyance direction of the secondary transfer nip, and a sheet ejection roller and a sheet ejection stack 135 that stores ejected sheets are disposed on the downstream side in the sheet conveyance direction of the fixing device 30. Moreover, a conveyance path 60 along which sheets are conveyed is formed between the fixing device 30 and the two sheet feed cassettes 131 of the sheet feeder 130.

The image forming section 120 is disposed opposite to a lower belt traveling side of the intermediate transfer belt 162 disposed between the drive roller 163 and the secondary transfer back-up roller 164. In the image forming units 121Y, 121C, 121M, and 121Bk, the photoconductors 10Y, 10C, 10M, and 10Bk are disposed to make contact with the intermediate transfer belt 162. Primary transfer rollers 161Y, 161C, 161M, and 161Bk as a transfer device that performs primary transfer are provided on an inner side of the intermediate transfer belt 162 at a position at which the photoconductors 10Y, 10C, 10M, and 10Bk make contact with the intermediate transfer belt 162. Toner bottles 159Y, 159C, 159M, and 159Bk that store replenished toner are provided above the intermediate transfer belt 162.

In this printer 100, the photoconductors 10Y, 10C, 10M, and 10Bk of the image forming units 121Y, 121C, 121M, and 121Bk are exposed in a predetermined pattern by the exposure device 140. Moreover, when the photoconductors 10Y, 10C, 10M, and 10Bk are developed by developing devices 50Y, 50C, 50M, and 50Bk, respectively, sheets conveyed from any one of the sheet feed cassettes 131 are conveyed to the image forming section 120. After that, toner is sequentially transferred from the photoconductors 10Y, 10C, 10M, and 10Bk by the intermediate transfer section 160, and color toner images borne on the intermediate transfer belt 162 are secondarily transferred. After that, the color toner images are fixed by the fixing device 30 and the sheet to which the toner images are fixed is ejected.

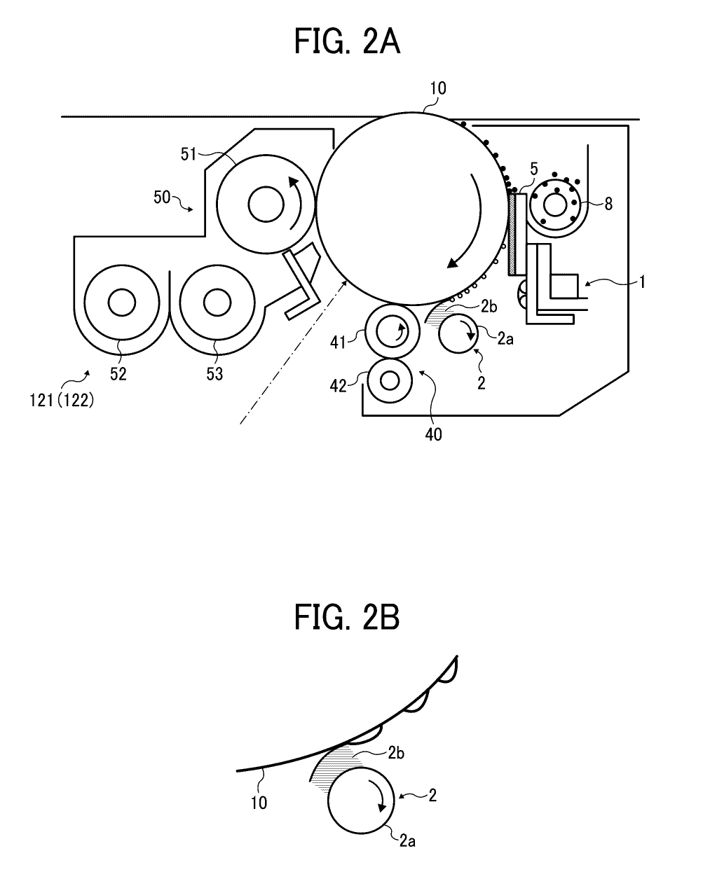

Next, an outline of the image forming units 121Y, 121C, 121M, and 121Bk provided in the printer 100 of the present embodiment will be described with reference to the drawings. FIGS. 2A and 2B are schematic views of a configuration of an example of the image forming unit 121 provided in the printer 100 and are illustrations of the outline of the photoconductor cleaning device 1 of Example 1 described later. Moreover, FIG. 2A is a schematic view of a configuration of an example of the image forming unit 121 and FIG. 2B is an enlarged illustration of the polishing roller 2 provided in the photoconductor cleaning device 1. Here, since the configurations of the image forming units 121Y, 121C, 121M, and 121Bk are substantially the same, the color coding letters Y, C, M, and Bk will be appropriately omitted in the following description, and the configuration and the operation of the image forming unit 121 will be described. As illustrated in FIG. 2A, the image forming unit 121 includes the drum-shaped photoconductor 10, and the photoconductor cleaning device 1, a charging device 40, and the developing device 50 disposed around the photoconductor 10.

The photoconductor cleaning device 1 includes, as a cleaner, a cleaning blade 5 having a stacked structure formed of a strip-shaped elastic member which is long in a rotation axis direction of the photoconductor 10 and the polishing roller 2 which is a roller having spiral projections formed using an elastic member. The polishing roller 2 will be described in detail in respective examples described later, and the outline thereof will be described briefly in the following description.

Moreover, a leading ridge of the cleaning blade 5, which is an edge ridge extending in a direction perpendicular to the direction of rotation of the photoconductor 10, is pressed against the surface of the photoconductor 10 to scrape and remove unnecessary adhered substances such as residual toner on the surface of the photoconductor. After that, foreign substances such as external additives remaining on the surface of the photoconductor without being removed are also scraped and removed by being ground by edge portions of projections (foreign substance removers) formed using the elastic member, of the polishing roller 2 illustrated in FIG. 2B. The adhered substances such as the residual toner removed by the cleaning blade 5 are discharged outside the photoconductor cleaning device 1 by a discharge screw 8. Moreover, the foreign substances such as the external additives removed by the polishing roller 2 are temporarily dropped inside a case that houses the photoconductor cleaning device 1 and are then discharged outside the case. The cleaning blade 5 and the polishing roller 2 are held in the case that houses the photoconductor cleaning device 1 by a support 3 and a bearing, respectively.

The charging device 40 mainly includes a charging roller 41 which is a charger that is opposite the photoconductor 10 and a charging-roller cleaner 42 that rotates in contact with the charging roller 41. The developing device 50 supplies toner to the surface of the photoconductor 10 to make an electrostatic latent image a visible image and includes a developing roller 51 as a developer bearer that bears developer (carrier and toner) on its surface. The developing device 50 mainly includes the developing roller 51, a stirring screw 52 that stirs and conveys the developer stored in a developer container, and a supply screw 53 that supplies and conveys the stirred developer to the developing roller 51.

The four image forming units 121 having the above-described configuration are configured integrally as the process cartridge 122 and can be individually detached and replaced by a serviceman or a user. Moreover, in the process cartridge 122 in a state of being detached from the printer 100, the photoconductor 10, the charging device 40, the developing device 50, and the photoconductor cleaning device 1 can be individually replaced with new devices. The image forming unit 121 may include a waste toner tank that collects residual toner collected by the photoconductor cleaning device 1. Further, in this case, the convenience is improved if the waste toner tank of the image forming unit 121 can be individually detached and replaced.

As described above, since the image forming unit 121 includes the process cartridge 122 which includes the photoconductor 10 and at least one of the charging device 40, the developing device 50, and the photoconductor cleaning device 1, the printer 100 can provide the following effects. Thus, it is possible to provide the printer 100 in which a plurality of image forming portions is integrated and which provides satisfactory setting and maintenance properties. Further, since these components are integrated with the photoconductor 10, the positioning accuracy in relation to the photoconductor 10, of the developing roller 51 of the integrated developing device 50, the charging roller 41 of the charging device 40, and the cleaning blade 5 and the polishing roller 2 of the photoconductor cleaning device 1 is improved.

Next, the operation of the printer 100 will be described. The printer 100 receives a print instruction from an operation panel provided in an apparatus body or an external device such as a personal computer. First, the photoconductor 10 is rotated in a clockwise direction indicated by an arrow in FIG. 2A so that the surface of the photoconductor 10 is uniformly charged with a predetermined polarity by the charging roller 41 of the charging device 40. The exposure device 140 irradiates the charged photoconductor 10 with laser light modulated according to input color image data for each color. In this way, an electrostatic latent image of each color is formed on the surface of each photoconductor 10. Moreover, developer of each color is supplied from the developing roller 51 of the developing device 50 of each color to each electrostatic latent image, and the electrostatic latent image of each color is developed with the developer of each color to form and make the toner image corresponding to each color a visible image.

Subsequently, when a transfer voltage of the opposite polarity from the toner image is applied to the primary transfer roller 161, a primary transfer field is formed between the photoconductor 10 and the primary transfer roller 161 with the intermediate transfer belt 162 interposed. At the same time, the primary transfer roller 161 is weakly pressed against the intermediate transfer belt 162 to form a primary transfer nip. With these operations, the toner image on each photoconductor 10 is efficiently primarily transferred to the intermediate transfer belt 162. The toner images of the respective colors formed on the respective photoconductors 10 are transferred to the intermediate transfer belt 162 in a superimposed manner and a stacked toner image is formed.

A sheet stored in the sheet feed cassette 131 is fed to the stacked toner image primarily transferred to the intermediate transfer belt 162 at a predetermined timing via the sheet feed roller 132 and the registration roller pair 133. Moreover, when a transfer voltage of the opposite polarity from the toner image is applied to the secondary transfer roller 166, a secondary transfer field is formed between the intermediate transfer belt 162 and the secondary transfer roller 166 with the sheet interposed, and a stacked toner image is transferred to the sheet. The sheet having the stacked toner image transferred thereto is fed to the fixing device 30 and is fixed by heat and pressure. The sheet having the toner image fixed thereto is ejected to and set on the sheet ejection stack 135 by the sheet ejection roller. On the other hand, the residual toner remaining on each photoconductor 10 after the primary transfer is performed is removed by the cleaning blade 5 of the photoconductor cleaning device 1, and foreign substances such as external additives remaining on the surface of the photoconductor without being removed are also removed by the polishing roller 2. Moreover, the residual toner and the like remaining on the intermediate transfer belt 162 after the secondary transfer is performed are removed by the belt cleaning device 167.

Here, before detailed description of the photoconductor cleaning device 1 provided in the image forming unit 121 of the present embodiment is provided, the problems of a photoconductor cleaning device provided in a conventional image forming unit will be described in more detail with reference to the drawings. Components identical or similar to the components of the photoconductor cleaning device 1 of the present embodiment will be appropriately denoted by the same reference codes unless it is necessary to distinguish between them.

With the progress in recent years in improvement of colors, speed, and image quality, 4-tandem-system image forming apparatuses have become the mainstream of electrophotographic image forming apparatuses. Moreover, due to growing awareness of environmental issues, recycling, high-reliability, and extended service life have become more important. Further, there is a growing awareness about the ozone and dust generated by the image forming apparatuses in consideration of office environments. Thus, many electrophotographic image forming apparatuses employ a charging roller type which generates a small amount of ozone as a charger. Moreover, to comply with the demand for high image quality, an alternating-current voltage (which allows a sufficient amount of charging current to flow and provides a stable charging potential) is often applied to a charging roller as a charger.

A photoconductor degrades and wears by receiving various types of stress such as charge injection, discharge, or sliding in an image forming process (that is, charging, developing, transferring, and cleaning). Thus, it is necessary to extend the service life of a photoconductor in order to realize high reliability and extended service life. In order to extend the service life of a photoconductor, the photoconductor may be coated with a lubricant to prevent adhesion of foreign substances to the photoconductor to reduce wearing of the photoconductor. Alternatively, the hardness of the photoconductor may be increased or a protecting layer having high hardness and resistant to stress may be formed on the surface of the photoconductor to improve the wear resistance. When the photoconductor is coated with a lubricant, the costs of the lubricant and a coating device increase. Moreover, when the wear resistance of the photoconductor is improved, toner or external additives thereof may adhere and accumulate on the surface of the photoconductor due to the property of rarely peeling off, and there has been a disadvantage that an abnormal image such as white spots may occur due to the foreign substance adhering to and accumulating on the surface of the photoconductor.

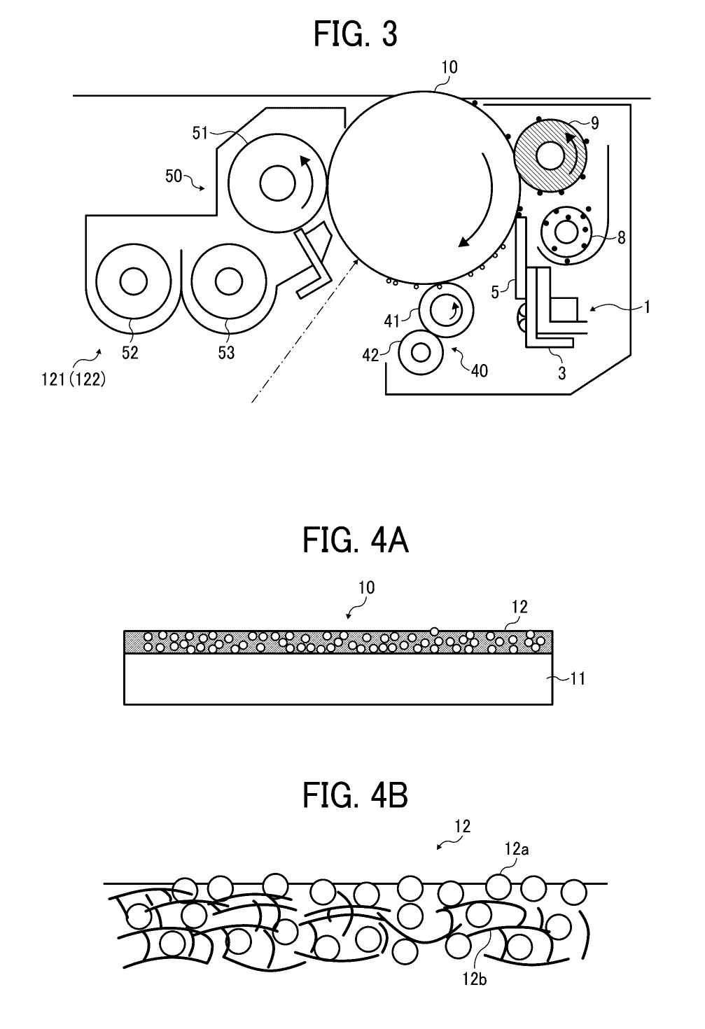

In order to reduce the occurrence of such an abnormal image, a photoconductor cleaning device in which a roller such as a cleaning roller and a cleaner such as a cleaning blade are disposed in contact with a photoconductor to remove adhered substances on the surface of the photoconductor has been known. For example, for a photoconductor cleaning device, when a roller and a cleaner are disposed in contact with a photoconductor, the cleaner is disposed between the roller and a charger that charges the photoconductor. Here, an example of a conventional image forming unit which is disposed around a photoconductor of which the hardness is increased to extend the service life thereof is illustrated in FIG. 3. A photoconductor 10 illustrated in FIG. 3 is formed of amorphous silicon having high hardness. Since this photoconductor has high hardness and satisfactory wear resistance and rarely peels off, foreign substances adhered to the surface of the photoconductor are rarely removed with wearing of the surface of the photoconductor. As a result, the foreign substances adhered to the surface of the photoconductor accumulate and grow and an abnormal image such as white spots occurs.

Thus, in order to remove foreign substances such as toner or external additives adhered to the surface of the photoconductor, a columnar cleaning roller 9 as a roller being in contact with the surface of the photoconductor is disposed on the upstream side in the direction of rotation of the photoconductor, of the cleaning blade 5 in an axial-position fixed state. Moreover, the cleaning roller 9 is rotated following the photoconductor 10 to slide at a linear velocity of 1.1 times the linear velocity of the surface of the photoconductor so that the foreign substances adhered to the photoconductor 10 are removed by the polishing components contained in the toner and the sliding of the cleaning roller 9. This cleaning roller 9 is formed of an EPDM foamed rubber having high hardness (for example, 50°: Asker-C). In order to reduce the amount of generated ozone and stabilize a charging potential, the charging roller 41 which is a contact AC charging roller in which an alternating-current voltage is superimposed on a direct-current voltage is used as a charger.

However, since the cleaning roller 9 is disposed on the upstream side of the direction of rotation of the photoconductor, of the cleaning blade 5, the amount of toner supplied to the cleaning roller 9 is different depending on an image to be formed. In a high-density image forming mode, an excessively large amount of toner is supplied to the cleaning roller 9, the contact area with the photoconductor 10 decreases, and the photoconductor sliding action of the cleaning roller 9 weakens. When high-density images are to be formed continuously, the photoconductor sliding and removing performance of the cleaning roller 9 becomes insufficient. Moreover, the amount of toner supplied to the cleaning roller 9 according to an image to be formed is different in a longitudinal direction (axial direction) of the cleaning roller 9, and the photoconductor sliding and removing performance of the cleaning roller 9 may become insufficient depending on a difference in the thickness in the longitudinal direction of the supplied toner. Further, in a high-temperature environment in which the ability of foreign substances to adhere to the photoconductor increases, it is difficult to completely remove foreign substances adhered to the surface of the photoconductor due to the insufficient photoconductor sliding and removing performance. Moreover, the foreign substances on the surface of the photoconductor accumulate and grow and an abnormal image such as white spots occurs.

Moreover, the cleaning roller 9 formed of a material having high hardness (for example, 50°: Asker-C) slides on the photoconductor in the axial-position fixed state. Thus, a variation in the pushing pressure on the photoconductor increases due to a variation in the outer diameter of the cleaning roller 9. Moreover, when the pushing depth is large, a photoconductor driving load increases and an abnormal image such as banding or jitter also occurs. On the other hand, when the pushing depth is small, a foreign substance removal defect occurs due to insufficient pressure. Moreover, when the photoconductor driving load is large, the sliding load may increase and the wearing of the photoconductor 10 may be accelerated.

Hereinafter, a configuration of the photoconductor cleaning device 1 provided in the image forming unit 121 invented by the inventors of the present disclosure to solve the problems of the conventional photoconductor cleaning device described above will be described by way of a plurality of examples.

### Example 1

Example 1 of a photoconductor cleaning device 1 provided in the image forming unit 121 of the present embodiment will be described. Here, as described with reference to FIGS. 2A and 2B, the polishing roller 2 which is a roller of this example is disposed on the upstream side in the direction of rotation of the photoconductor, of the charging roller 41 and on the downstream side of the direction of rotation of the photoconductor, of the cleaning blade 5. That is, the polishing roller 2 is disposed between the charging roller 41 and the cleaning blade 5. First, a configuration of the image forming unit 121 according to this example will be described in more detail with reference to the drawings.

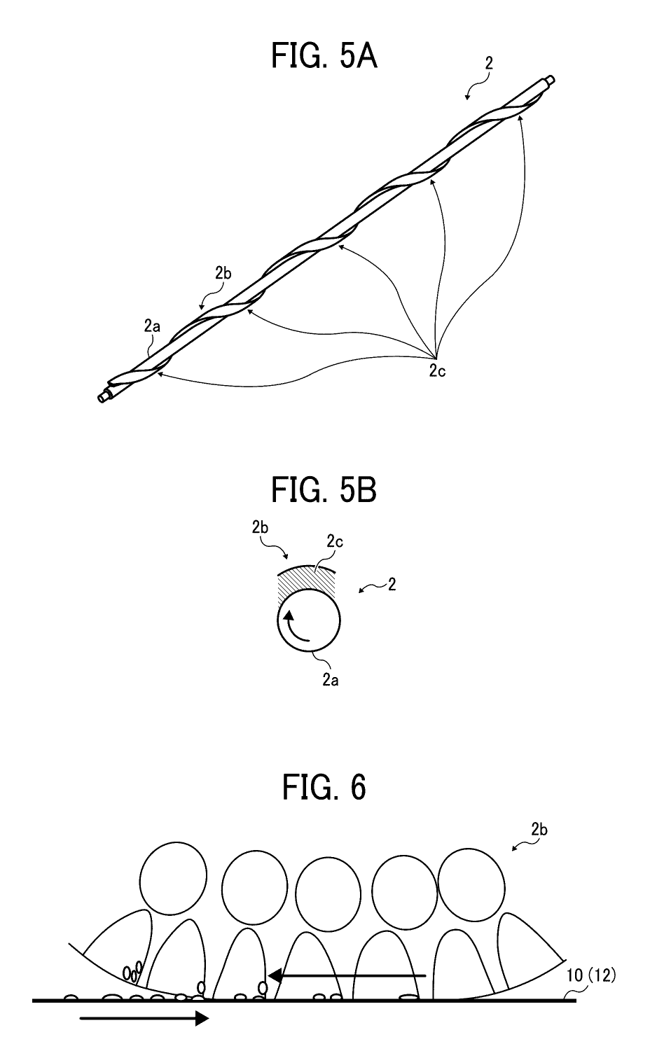

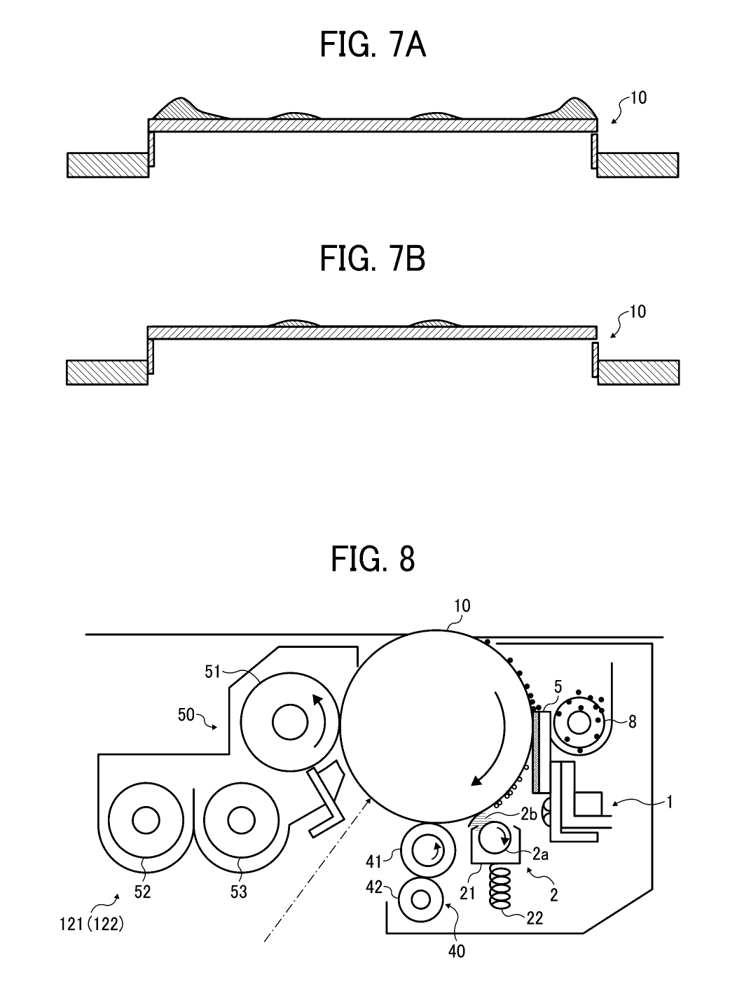

FIGS. 4A and 4B are illustrations of a configuration of the surface of the photoconductor 10 provided in the image forming unit 121 according to this example, FIG. 4A is an illustration of a layer structure of the surface of the photoconductor 10, and FIG. 4B is an enlarged illustration of the protecting layer 12 illustrated in FIG. 4A. FIGS. 5A and 5B are illustrations of a configuration of the polishing roller 2 according to this example, FIG. 5A is a perspective view, and FIG. 5B is a cross-sectional view. FIG. 6 is an illustration of a mechanism of removing adhered substances from the photoconductor 10 when a foamed urethane 2b which is a foamed material is used as an elastic material that forms projections of the polishing roller 2 according to this example. FIGS. 7A and 7B are illustrations of a change in a longitudinal direction in the thickness of the toner supplied to the polishing roller 2 depending on a difference in location. Moreover, FIG. 7A is an illustration of a case in which the polishing roller 2 is provided on the upstream side in the direction of rotation of the photoconductor, of the cleaning blade 5 as in the conventional photoconductor cleaning device, and FIG. 7B is an illustration of a case in which the polishing roller 2 is provided on the downstream side in the direction of rotation of the photoconductor, of the cleaning blade 5 as in this example.

In the image forming unit 121 of this example, a photoconductor which has a diameter (φ) of 30 mm and has a protecting layer 12 formed on a photoconductive layer 11 (the surface of the photoconductor) as illustrated in FIG. 4A is used as a drum-shaped photoconductor 10. Moreover, a hard layer which contains alumina fillers 12a which are inorganic fine particles and is hardened by a cross-linked resin 12b as illustrated in FIG. 4B is used as the protecting layer 12 provided on the surface of the photoconductor.

In the charging device 40, similarly to the conventional device, in order to reduce the amount of generated ozone and stabilize the charging potential, a charging roller 41 which is a contact AC charging roller in which an alternating-current voltage is superimposed on a direct-current voltage is used as a charger. This charging roller 41 has an elastic layer which is formed of hydrin rubber having a thickness of 2 mm and formed on a cored metal bar having a diameter (φ) of 8 mm. Further, a surface layer having a thickness of approximately 5 μm is formed on the surface thereof to prevent contamination of the photoconductor resulting from contamination components leaking from the elastic rubber layer.

A double-layer blade including an edge layer having such hardness as to improve the cleaning performance and a backup layer having lower hardness than the edge layer is used as the cleaning blade 5. Specifically, the double-layer blade includes an edge layer having high edge hardness of 90° (JISK), the 100% modulus of 10 Mpas, and the thickness of 0.5 mm and a backup layer having a lower hardness (hardness: 65°) than the edge layer and the thickness of 1.5 mm. Moreover, a free length of the cleaning blade 5 is 8 mm, and a contact edge pushes into the photoconductor 10 approximately by 0.8 mm. When the edge hardness is high (that is, the 100% modulus is large), since the retraction of the edge of the cleaning blade 5 disappears and the behavior thereof is stable, the cleaning performance is improved.

In the image forming unit 121 of this example, the configuration of the polishing roller 2 which is a roller (photoconductor adhered substance remover) provided in the photoconductor cleaning device 1 is different from that of the cleaning roller provided in the conventional photoconductor cleaning device. In this example, in order to remove foreign substances (adhered substances) such as toner or external additives adhered to the surface of the photoconductor, the polishing roller 2 in which the foamed urethane 2b is formed in a spiral form on a metal core 2a as illustrated in FIGS. 5A and 5B is used as the roller. Specifically, the polishing roller 2 is a roller in which the foamed urethane 2b having the hardness of 50° (Asker-C), the thickness of 2 mm, and the width of 4 mm is formed in a spiral form at a pitch of 70 mm on the metal core 2a which is a metal shaft having the diameter (φ) of 5 mm. Moreover, a contact portion 2c on the outer circumference side of the foamed urethane 2b provided in a spiral form slides on the surface of the photoconductor 10.

This polishing roller 2 is disposed between the charging roller 41 and the cleaning blade 5 on the surface of the photoconductor as illustrated in FIGS. 2A and 2B. The polishing roller 2 of this example forms the spiral form of the foamed urethane 2b on the metal core 2a according to molding.

The polishing roller 2 is rotated by a drive source so as to slide on the surface of the photoconductor with a linear velocity difference from the surface of the photoconductor 10. Due to this, the contact portion 2c which is the surface of the foamed urethane 2b provided in the polishing roller 2 illustrated in FIG. 5A and makes contact with the photoconductor 10 can slide on the surface of the photoconductor with a linear velocity difference from the surface of the photoconductor 10, and the adhered substances on the surface of the photoconductor can be effectively removed by the sliding effect.

Moreover, a photoconductor pushing depth of the polishing roller 2 (the foamed urethane 2b) is set to approximately 0.3 mm. Moreover, as illustrated in FIG. 6, since the foamed urethane 2b has a cell structure having an enormously large number of fine holes, the edges of the fine holes effectively slide on the surface of the photoconductor to remove the foreign substances adhered to the surface of the photoconductor. That is, since the elastic material that forms the spiral projections (is spirally disposed) on the polishing roller 2 has a cell structure having an enormously large number of fine holes, the edges of the fine holes effectively slide on the surface of the photoconductor, and the effect of removing adhered substances on the surface of the photoconductor is improved.

Moreover, as illustrated in FIGS. 2A and 2B, the polishing roller 2 is rotated by a drive source in the opposite direction which is a counter-clockwise direction in the drawing from the direction of rotation of the photoconductor 10 rotating in the clockwise direction in the drawing while making contact with the surface of the photoconductor. Due to this, since the polishing roller 2 rotates in the opposite direction from the photoconductor 10 at the contact portion with the photoconductor 10, it is possible to increase the linear velocity difference of the polishing roller 2 in relation to the surface of the photoconductor. When the linear velocity difference is increased in this manner, the photoconductor surface sliding effect of the polishing roller 2 increases and the effect of removing adhered substances on the surface of the photoconductor is improved. In the photoconductor cleaning device 1 of this example, the polishing roller 2 is rotated by a drive source at a linear velocity of 0.5 times the linear velocity of the surface of the photoconductor 10 to slide on the photoconductor 10. When the spiral projections make contact with and are separated from the surface of the photoconductor with rotation, since the edge portions (near the ends of the contact portion 2c) of the projections slide on the surface of the photoconductor 10, it is possible to effectively remove adhered substances on the surface of the photoconductor by the scraping effect of the edge portions.

Moreover, since the polishing roller 2 is disposed on the downstream side in the direction of rotation of the photoconductor, of the cleaning blade 5, the amount of toner supplied to the polishing roller 2 may not change depending on an image area. That is, the foreign substance removing performance may not change resulting from a change in a contact area between the polishing roller 2 and the photoconductor 10. Due to this, the polishing roller 2 can provide the foreign substance removing performance stably.

Moreover, since the polishing roller 2 is driven at a linear velocity of 0.5 times the photoconductor linear velocity in the opposite direction from the direction of rotation of the photoconductor 10, the sliding speed (relative moving speed) of the polishing roller 2 in relation to the surface of the photoconductor is 1.5 times the linear velocity of the photoconductor 10 and the sliding effect increases. Since the polishing roller 2 is rotated in the opposite direction from the direction of rotation of the photoconductor, it is not necessary to increase the linear velocity of the polishing roller 2 itself up to 1.5 times the linear velocity of the photoconductor 10 as in the case of the polishing roller 2 and the photoconductor 10 rotating in the same direction. Due to this, the number of rotations of the polishing roller 2 is reduced and the load on the rolling bearing of the polishing roller 2 can be reduced. Moreover, due to the sliding and scraping effect of the edge portions of the spiral projections of the polishing roller 2, in a high-temperature environment in which the ability of foreign substances to adhere to the photoconductor 10 increases, it is possible to prevent foreign substances from adhering to and accumulating on the photoconductor 10 and to prevent the occurrence of an abnormal image such as white spots.

Moreover, since the polishing roller 2 has a configuration in which the projections that make contact with the photoconductor 10 and have a thickness of 2 mm and a width of 4 mm and are disposed in a spiral form at a pitch of 70 mm are formed on the metal core 2a having a diameter (φ) of 5 mm to form projections, the contact area is reduced by up to approximately ¼. Since the contact area can be reduced in this manner, the entire pressure on the photoconductor 10, of the polishing roller 2 can be reduced by up to approximately ¼. Due to this, even when the outer diameter of the polishing roller 2 varies up to ±0.15 mm in relation to the set pushing depth of 0.3 mm of the polishing roller 2 pushing into the photoconductor 10, the variation in the photoconductor pressure is reduce by up to approximately ¼.

Even when the outer diameter of the polishing roller 2 is large within the variation range, the load of the polishing roller 2 in relation to the driving of the photoconductor is reduced and the occurrence of an abnormal image such as banding or jitter can be prevented. In this way, since an increase in the pressure resulting from a large outer diameter of the polishing roller 2 within the variation range can be reduced, the pushing depth of the polishing roller 2 is set as large as 0.3 mm. Due to this, the pushing depth is set to be large to an extent that the deficiency in the performance of the polishing roller 2 removing adhered substances (foreign substances) adhered to the surface of the photoconductor 10 can be prevented notwithstanding the outer diameter variation of the polishing roller 2.

Moreover, due to the effect of reducing the contact pressure on the photoconductor 10, of the polishing roller 2 and the effect of reducing the photoconductor driving load resulting from the reduced variation thereof, it is possible to reduce wearing of the photoconductor 10. Moreover, since the polishing roller 2 is disposed on the upstream side (front side) of the charging roller 41 in relation to the direction of rotation of the photoconductor 10, it is possible to remove toner external additives such as silica on the surface of the photoconductor before the surface of the photoconductor is activated by the charging current and the ability of foreign substances to adhere to the surface of the photoconductor increases. Due to this, it is possible to effectively prevent toner external additives or the like from adhering to the surface of the photoconductor 10.

As described above, the photoconductor cleaning device 1 of this example includes the polishing roller 2 as a roller and the cleaning blade 5 as a cleaner, which are disposed in contact with the photoconductor 10 to remove residual toner and external additives on the surface of the photoconductor. Moreover, spiral projections are formed on the metal core 2a which is the shaft of the polishing roller 2 using the foamed urethane 2b as an elastic material, and the polishing roller 2 is disposed between the cleaning blade 5 and the charging roller 41 as a charger that charges the photoconductor 10. With such a configuration, in the photoconductor cleaning device 1 of this example, since the polishing roller 2 is disposed on the downstream side of the cleaning blade 5 in relation to the direction of rotation of the photoconductor, it is possible to reduce the amount of residual toner supplied to the contact portion between the polishing roller 2 and the photoconductor 10. Due to this, it is possible to reduce a difference in the longitudinal direction in the thickness of the supplied toner while reducing a decrease or a variation in the contact area between the polishing roller 2 and the photoconductor 10. In this way, since the foreign substance removing performance of the polishing roller 2 removing foreign substances adhered to the photoconductor 10 does not become insufficient but becomes stable, it is possible to remove foreign substances (adhered substances) on the photoconductor stably.

Moreover, since the polishing roller 2 is disposed on the upstream side in the direction of rotation of the photoconductor, of the charging roller 41, it is possible to remove toner external additives such as silica on the surface of the photoconductor before the surface of the photoconductor 10 is activated by the charging current and foreign substances easily adhere to the surface. Due to these reasons, it is possible to prevent foreign substances from adhering to the photoconductor 10 and to reduce the occurrence of an abnormal image such as white spots resulting from the adhered foreign substances. Therefore, it is possible to provide the photoconductor cleaning device 1 capable of reducing the occurrence of an abnormal image such as white spots resulting from the adhered foreign substances.

Moreover, in the photoconductor cleaning device 1 of this example, it is possible to improve the foreign substance removing performance by the scraping effect of the edge portions of the projections sliding on the surface of the photoconductor when the spiral projections formed of a foamed urethane rotate to make contact with and separate from the surface of the photoconductor. Due to this, it is possible to reduce the pressure on the photoconductor 10, of the polishing roller 2 as a roller. Further, since the projections making contact with the photoconductor 10 are formed (disposed) on the polishing roller 2 in a spiral form and the contact area with the photoconductor 10 decreases, it is possible to reduce the pressure on the photoconductor 10, of the polishing roller 2. Moreover, due to these pressure reducing effects, it is possible to reduce a variation in the pushing pressure on the photoconductor 10, of the polishing roller 2 and to prevent the occurrence of an abnormal image such as banding or jitter which may occur when the photoconductor driving load increases. Further, it is possible to prevent the occurrence of a foreign substance removal defect which may occur when the pressure is insufficient.

Moreover, due to the effect of reducing the photoconductor driving load resulting from a reduction in the pressure when the polishing roller 2 makes contact with the photoconductor 10, it is possible to reduce the wearing of the photoconductor 10. Thus, it is possible to provide the photoconductor cleaning device 1 capable of reducing the wearing of the photoconductor 10 while reducing the occurrence of an abnormal image such as banding or jitter.

Moreover, since the process cartridge 122 of this example includes at least the photoconductor 10 and the photoconductor cleaning device 1 as described above, the process cartridge 122 can provide the same effects as the photoconductor cleaning device 1. Moreover, since the printer 100 of this example includes the photoconductor cleaning device 1 described above as the photoconductor cleaning device, the printer 100 can provide the same effects as the photoconductor cleaning device 1 described above.

For example, a roller (cleaner) may have spiral projections that are formed on a metal core (core body) using an elastic material (foamed elastic material) to remove adhered substances on a cleaning target. However, there is no clear definition about the relation between the locations of a cleaning blade and a roller when the cleaning target is a photoconductor and adhered substances on the photoconductor are removed using the cleaning blade and the roller.

Here, a change in the longitudinal direction, in the thickness of toner supplied to the polishing roller 2 depending on a difference in the location will be described with reference to FIGS. 7A and 7B. Since the input image of toner supplied to the photoconductor 10 has a thin portion and a thick portion in the longitudinal direction of the photoconductor 10, the thickness of the residual toner on the surface of the photoconductor after the primary transfer is performed is different in the longitudinal direction depending on a position. Due to this, when the polishing roller 2 is disposed on the upstream side in the direction of rotation of the photoconductor, of the cleaning blade 5 as in the conventional photoconductor cleaning device, toner having different thickness in the longitudinal direction is supplied to the polishing roller 2 as illustrated in FIG. 7A. Even when the polishing roller 2 is pressed against the surface of the photoconductor 10 in this state, it is difficult to remove external additives or the like on the surface of the photoconductor due to a difference in the toner thickness in the longitudinal direction.

On the other hand, when the polishing roller 2 is disposed on the downstream side in the direction of rotation of the photoconductor, of the cleaning blade 5 as in the photoconductor cleaning device 1 of this example, even when the thickness of residual toner on the surface of the photoconductor after the primary transfer is performed is different in the longitudinal direction depending on a position, the residual toner is first scraped by the cleaning blade 5. Due to this, as illustrated in FIG. 7B, the difference in the thickness of residual toner in the longitudinal direction, on the surface of the photoconductor is reduced, and most of the adhered substances supplied to the polishing roller 2 are external additives. When the polishing roller 2 is pressed against the surface of the photoconductor 10 in this state, it becomes easier to remove external additives or the like on the surface of the photoconductor.

### Example 2

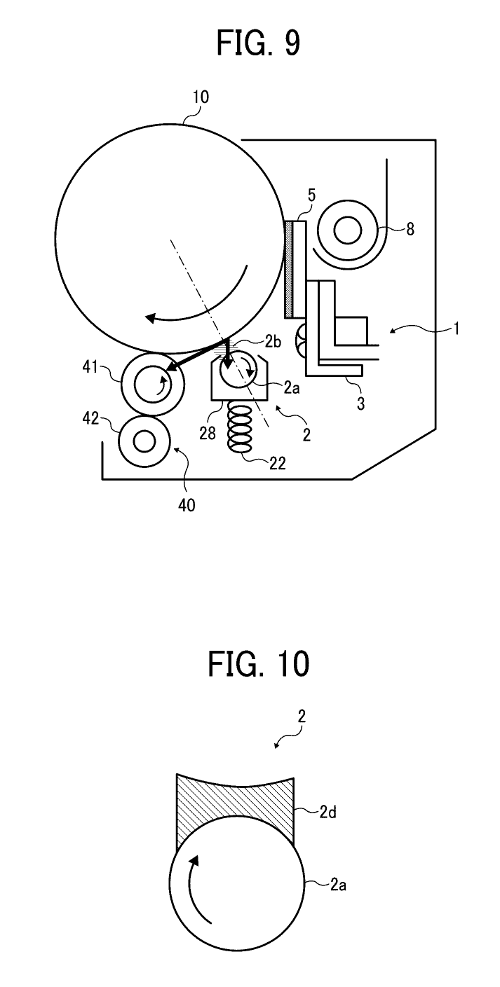

Next, Example 2 of the photoconductor cleaning device 1 provided in the image forming unit 121 of the present embodiment will be described with reference to the drawings. FIG. 8 is a schematic view of a configuration of the image forming unit 121 according to this example, and FIG. 9 is an illustration of a pressing direction of the polishing roller 2 pressing the photoconductor 10 in the photoconductor cleaning device 1 according to this example.

The photoconductor cleaning device 1 of this example is different from that of Example 1 in terms of an arrangement method of the polishing roller 2 which is a roller. Thus, the description of the same configuration, operation, and effect as those described in Example 1 will be appropriately omitted. Moreover, components identical or similar to the components of the photoconductor cleaning device 1 of Example 1 will be appropriately denoted by the same reference codes unless it is necessary to distinguish between them.

As described above, the photoconductor cleaning device 1 of this example is different from that of Example 1 in terms of an arrangement method of the polishing roller 2 which is a roller. Specifically, as illustrated in FIG. 8, in this example, the polishing roller 2 is pressed against the photoconductor 10 by a pressure spring 22 which is an elastic member with a holder 28 having a bearing interposed. Moreover, as illustrated in FIG. 9, the spiral projections (foreign substance remover) formed on the polishing roller 2 are pressed toward the photoconductor 10 from the downstream side in the direction of rotation of the photoconductor in relation to a normal direction of the contact portion (see 2c in FIG. 5A) between the photoconductor 10 and the polishing roller 2.

In this example, since the axial position of the polishing roller 2 is not secured to the photoconductor 10 but one side thereof is pressed by the pressure spring 22 having the force of 5N, it is possible to reduce a pressure variation on the photoconductor 10 resulting from a dimensional variation in the roller outer diameter. Moreover, the polishing roller 2 is pressed against the photoconductor 10 from the downstream side in the direction of rotation of the photoconductor in relation to the normal direction of the contact portion between the photoconductor 10 and the polishing roller 2. Due to this, the friction force applied from the photoconductor 10 to the polishing roller 2 with rotation of the photoconductor 10 acts in a direction (the direction of pushing the pressure spring 22) of increasing the pressure of the polishing roller 2 pressing the photoconductor 10. Due to such an action, pressure leakage is prevented and a stable pressing state is obtained notwithstanding a variation in a contact state resulting from bending of the polishing roller 2. Moreover, it is possible to obtain a stable foreign substance removing performance of the polishing roller 2 removing foreign substances adhered to the photoconductor 10.

As described above, in the photoconductor cleaning device 1 of this example, the axial position of the polishing roller 2 is not secured to the photoconductor 10 but is pressed against the photoconductor 10 by the pressure spring 22. Due to this, it is possible to reduce a pressure variation on the photoconductor 10 resulting from a dimensional variation in the outer diameter of the polishing roller 2. Moreover, the polishing roller 2 is pressed against the photoconductor 10 from the downstream side in the direction of rotation of the photoconductor in relation to the normal direction of the contact portion between the photoconductor 10 and the polishing roller 2. Due to this, since the polishing roller 2 is pressed against the photoconductor 10 with rotation of the photoconductor 10, a leakage of pressure on the photoconductor 10, of the polishing roller 2 is prevented and a stable pressing state is realized.

### Example 3

Next, Example 3 of the photoconductor cleaning device 1 provided in the image forming unit 121 of the present embodiment will be described with reference to the drawings. FIG. 10 is an illustration of the polishing roller 2 provided in the photoconductor cleaning device 1 according to this example.

The photoconductor cleaning device 1 of this example is different from that of Examples 1 and 2 in terms of a method of forming spiral projections on the polishing roller 2 which is a roller. Thus, the description of the same configuration, operation, and effect as those described in Examples 1 and 2 will be appropriately omitted. Moreover, components identical or similar to the components of the photoconductor cleaning device 1 of Examples 1 and 2 will be appropriately denoted by the same reference codes unless it is necessary to distinguish between them.

As described above, the photoconductor cleaning device 1 of this example is different from that of Examples 1 and 2 in terms of a method of forming spiral projections on the polishing roller 2 which is a roller. Specifically, as illustrated in FIG. 10, the polishing roller 2 has a configuration in which a foamed urethane sheet 2d which is an elastic sheet having the hardness of 10° (Asker-C), a thickness of 2 mm, and a width of 4 mm is wound around the surface of a metal core 2a having a diameter (φ) of 5 mm at a pitch of 70 mm. Since a foamed sheet is wound around the curved surface of the metal core 2a, as illustrated in FIG. 10, the foamed urethane sheet 2d which is a foamed material is deformed to enhance the edge portions on the outer circumferential surface side of the roller. Thus, the surface sliding effect of the photoconductor 10 is improved.

As described above, in the polishing roller 2 of the photoconductor cleaning device 1 of this example, the foamed urethane sheet 2d which is an elastic sheet is wound around the metal core 2a which is a shaft in a spiral form. Due to this, since the foamed urethane sheet 2d is deformed to enhance the edge portions on the outer circumferential surface side of the roller, the photoconductor surface sliding effect is improved.

Here, in Examples 1 to 3, the hardness of the elastic projections is approximately 10 to 60° (Asker-C) in order to improve the sliding effect without the surface of the photoconductor being damaged by the edges of the projections formed (disposed) on the polishing roller 2 in a spiral form. When the hardness is higher than 60°, the edges of projections may damage the photoconductor 10. When the hardness is lower than 10°, the edges of projections become too soft and a sliding effect is not obtained.

### Example 4

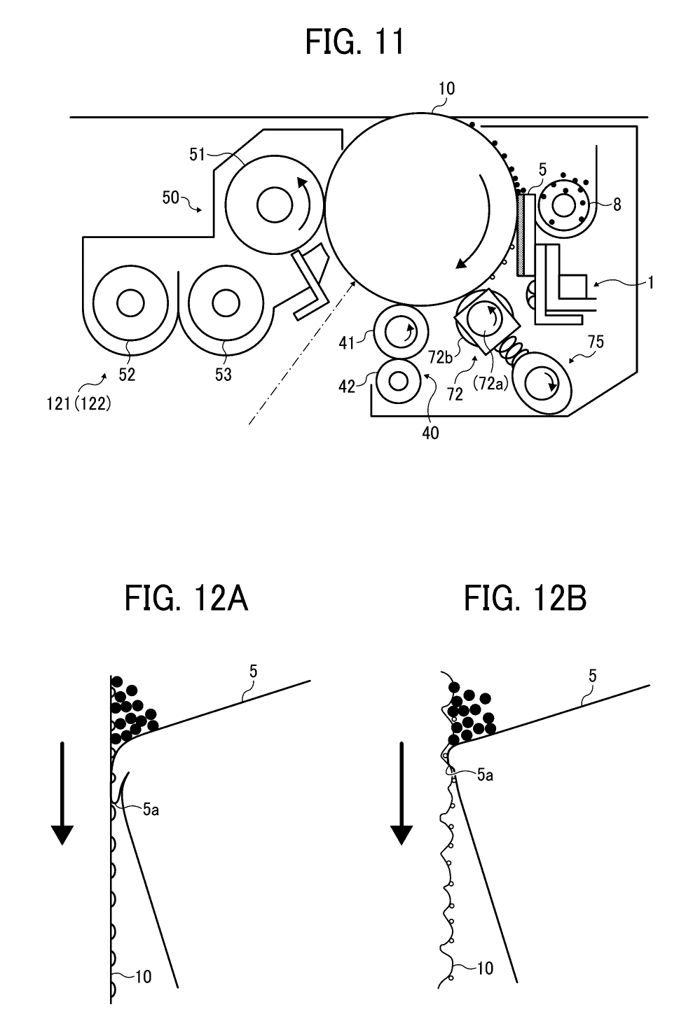

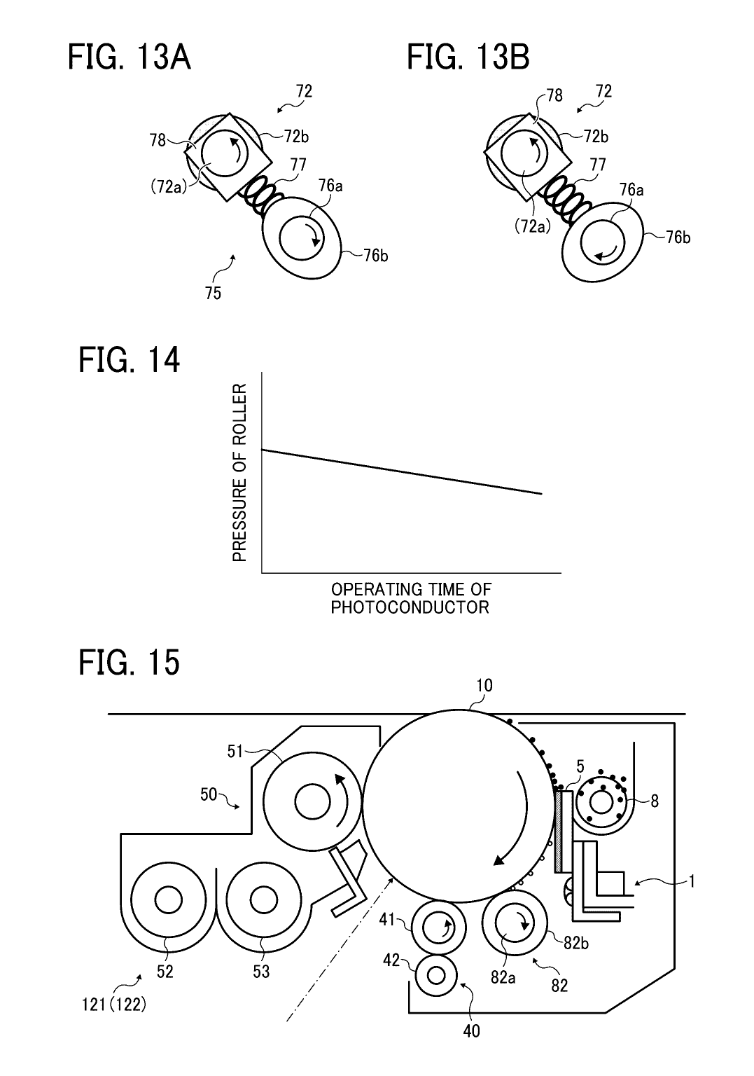

Next, Example 4 of the photoconductor cleaning device 1 provided in the image forming unit 121 of the present embodiment will be described with reference to the drawings. FIG. 11 is a schematic view of a configuration of the image forming unit 121 according to this example. FIGS. 12A and 12B are illustrations of a change over time in a blade edge deformed when the cleaning blade 5 slides on the surface of the photoconductor 10, FIG. 12A illustrates a state when the surface of the photoconductor 10 slides in an initial use state, and FIG. 12B illustrates the time-elapsed state. FIGS. 13A and 13B are illustrations of a pressure regulator that regulates the pressure on the photoconductor 10, of a removing roller 72 according to this example, FIG. 13A illustrates an initial use state of the photoconductor 10, and FIG. 13B illustrates the state when time has elapsed. FIG. 14 is a graph illustrating an example of regulating the pressure of the removing roller 72 corresponding to the use time (drive time) of the photoconductor 10.

The photoconductor cleaning device 1 of this example is different from that of Examples 1 to 3 in terms of the configuration of a roller and in that a configuration in which the foreign substance removing performance (adhered substance removing performance) of the removing roller 72 which is a roller of this example is decreased (degraded) with the elapse of time is provided. Thus, the description of the same configuration, operation, and effect as those described in Examples 1 to 3 will be appropriately omitted. Moreover, components identical or similar to the components of the photoconductor cleaning device 1 of Examples 1 to 3 will be appropriately denoted by the same reference codes unless it is necessary to distinguish between them.

As described above, the photoconductor cleaning device 1 of this example is different from that of Examples 1 to 3 in terms of the configuration of the removing roller 72 which is a roller and in that a configuration in which the foreign substance removing performance of the removing roller 72 removing foreign substances adhered to the photoconductor 10 is decreased with the elapse of time is provided. Specifically, the removing roller 72 illustrated in FIG. 11 is a roller which has an outer diameter (φ) of 11.0 mm and in which a foamed EPDM material layer 72b having a hardness of 15° (Asker-C) and a thickness of 2.5 mm is formed on a removing roller metal core 72a having a diameter (φ) of 6 mm. Similarly to the polishing roller 2 of Examples 1 to 3, this removing roller 72 is disposed on the upstream side in the direction of rotation of the photoconductor, of the charging roller 41 and on the downstream side in the direction of rotation of the photoconductor, of the cleaning blade 5. That is, the removing roller 72 is disposed between the charging roller 41 and the cleaning blade 5. On the other hand, a photoconductor pushing depth of the removing roller 72 (the foamed EPDM material layer 72b) is set to approximately 0.2 mm. Moreover, since the foamed EPDM material layer 72b has a cell structure having an enormously large number of fine holes similarly to the foamed urethane 2b illustrated in FIG. 6, the edges of the fine holes effectively slide on the surface of the photoconductor and remove foreign substances adhered to the surface of the photoconductor.

Moreover, the following configuration is provided as a configuration of decreasing the foreign substance removing performance with the elapse of time. As illustrated in FIG. 11, in relation to the photoconductor 10, the removing roller 72 is disposed to be pressed against the surface of the photoconductor 10 by a pressure spring formed of a compression spring. Moreover, the removing roller 72 is rotated by a driving device at a linear velocity of 1.5 times the linear velocity of the surface of the photoconductor 10 in a direction following the direction of rotation of the photoconductor to slide on the photoconductor 10. Moreover, an end portion of the pressure spring on the opposite side from a roller pressing end portion abuts against a cam, the cam is driven by a drive source, and the pressure of the pressure spring is variable with rotation of the cam.

As described above, since the removing roller 72 is disposed on the upstream side of the charging roller 41 in relation to the direction of rotation of the photoconductor 10, it is possible to remove toner external additives such as silica on the surface of the photoconductor before the surface of the photoconductor is activated by the charging current and the ability of foreign substances to adhere to the surface of the photoconductor increases. Due to this, it is possible to effectively prevent toner external additives or the like from adhering to the surface of the photoconductor 10. Moreover, since the removing roller 72 is disposed on the downstream side of the cleaning blade 5, the amount of toner supplied to the removing roller 72 may not change depending on an image area. Moreover, the foreign substance removing performance may not change resulting from a change in a contact area between the removing roller 72 and the photoconductor 10. Due to this, the removing roller 72 can provide the foreign substance removing performance stably. That is, it is possible to obtain a stable foreign substance sliding and scraping effect.

Due to such a stable foreign substance sliding and scraping effect, in a high-density image forming mode and in a high-temperature environment in which the ability of foreign substances to adhere to the photoconductor 10 increases, it is possible to prevent foreign substances from adhering to and accumulating on the photoconductor 10 and to prevent the occurrence of an abnormal image such as white spots. Here, a verification test performed to verify the foreign substance removing effect (adhered substance removing effect) of the removing roller 72 of this example and the verification test result thereof will be described with reference to Table 1.

TABLE 1

| | | | Roller Sliding | |
|---|---|---|---|---|
| | | | Speed | |
| | | | (Photoconductor | Photoconductor |
| | | | Linear Velocity: | Adhered |
| Roller | Location | Drive Method | Ratio) | Substance |
| None | | | | Poor |
| | | | | (Adhered |
| | | | | Substance |
| | | | | Present) |
| EPDM Roller | Before Cleaning | Counter Drive | 1.5 | Poor |
| | Blade | | | (Adhered |
| | | | | Substance |
| | | | | Present) |
| EPDM Roller | Between | Co-Rotation | 0.0 | Poor |
| | Charging Roller | Drive | | (Adhered |
| | and Cleaning | | | Substance |
| | Blade | | | Present) |
| EPDM Roller | Between | Following | 0.5 | Very good |
| | Charging Roller | Rotation Drive | | (Adhered |
| | and Cleaning | | | Substance Not |
| | Blade | | | Present) |
| EPDM Roller | Between | Following | 0.8 | Very good |
| | Charging Roller | Rotation Drive | | (Adhered |
| | and Cleaning | | | Substance Not |
| | Blade | | | Present) |
| EPDM Roller | Between | Counter Drive | 1.5 | Very good |
| | Charging Roller | | | (Adhered |
| | and Cleaning | | | Substance Not |
| | Blade | | | Present) |

In the test, the hardness of the foamed EPDM material layer 72b provided in the removing roller 72 (an EPDM roller in Table 1) was 15° (Asker-C), the linear pressure (contact pressure) on the photoconductor 10, of the removing roller 72 was 5.0 N/m, and a three-layer photoconductor was used as the photoconductor 10.

After a full solid image was printed on 10,000 pages of A4-size sheet in a lateral orientation under a high-temperature and high-humidity environment (30° C., 80%) and the conditions illustrated in Table 1, the presence of adhered substances on the photoconductor 10 was evaluated with the naked eyes in the three grades “very good”, “good”, and “poor”. The term “very good” indicates that no adhered substance was observed on the photoconductor 10. That is, adhered substances were not present. The term “good” indicates that such a small amount of adhered substance that may not cause a practical problem was observed on the photoconductor 10. That is, a small amount of adhered substance was present. The term “poor” indicates that adhered substances which can cause an abnormal image were observed on the photoconductor 10. That is, adhered substances were present.

(Verification Result)

A verification result of “poor” was obtained when the removing roller 72 was not provided. That is, adhered substances which can cause an abnormal image were observed on the photoconductor 10. A verification result of “poor” was obtained when the removing roller 72 was provided on the upstream side (front side) in the direction of rotation of the photoconductor, of the cleaning blade 5 and was driven in the opposite direction from the photoconductor 10 according to counter drive, and the sliding speed was 1.5 times the photoconductor linear velocity. That is, adhered substances which can cause an abnormal image were observed on the photoconductor 10.

A verification result of “poor” was obtained when the removing roller 72 was provided between the charging roller 41 and the cleaning blade 5 and was driven to rotate with the photoconductor 10, and the sliding speed (relative moving speed) in relation to the photoconductor 10 was 0 (that is, the sliding speed is 0.0 times the photoconductor linear velocity). That is, even when the removing roller 72 was provided between the charging roller 41 and the cleaning blade 5, if a linear velocity difference from the photoconductor 10 was not provided, adhered substances which can cause an abnormal image were observed on the photoconductor 10.

A verification result of “very good” (that is, no adhered substance observed on the photoconductor 10) was obtained when the removing roller 72 was provided between the charging roller 41 and the cleaning blade 5 and driven in a direction following the photoconductor 10, and the sliding speed was 0.5 times the photoconductor linear velocity. A verification result of “very good” (that is, no adhered substance observed on the photoconductor 10) was obtained when the removing roller 72 was provided between the charging roller 41 and the cleaning blade 5 and was driven in a direction following the photoconductor 10, and the sliding speed was 0.8 times the photoconductor linear velocity. A verification result of “very good” (that is, no adhered substance observed on the photoconductor 10) was obtained when the removing roller 72 was provided between the charging roller 41 and the cleaning blade 5 and was driven in the opposite direction from the photoconductor 10 according to counter drive, and the sliding speed was 1.5 times the photoconductor linear velocity.

From these evaluation results, it was possible to confirm that the removing roller 72 of this example, which is provided between the charging roller 41 and the cleaning blade 5 and was driven with a linear velocity difference in relation to the photoconductor 10 can provide a satisfactory foreign substance removing effect of removing foreign substances adhered to the photoconductor 10. Due to such a stable sliding and scraping effect, the removing roller 72 of this example can prevent foreign substances from adhering to and accumulating on the photoconductor 10 in a high-temperature environment in which the ability of foreign substances to adhere to the photoconductor 10 increases. Due to this, it is possible to prevent the occurrence of an abnormal image such as white spots.

However, since the removing roller 72 slides on the photoconductor 10, the wearing of the photoconductor 10 may be accelerated. For example, when the contact pressure of the removing roller 72 is not appropriate but is excessively large, and the linear velocity difference (sliding speed) in relation to the photoconductor 10 is not appropriate but is excessively large, the foreign substance removing performance (adhered substance removing performance) becomes excessive and may accelerate the wearing of the photoconductor 10. This results from the following reasons. As illustrated in FIG. 12A, since the surface in an initial use state of the photoconductor 10 is flat and the friction force between the surface of the photoconductor 10 and the blade edge 5a of the cleaning blade 5 is large, the blade edge 5a is retracted greatly by rotation of the photoconductor. Due to this, in an initial use state of the photoconductor 10, the toner, external additives, or the like leaking from the blade edge 5a are pressed against the surface of the photoconductor 10 by the retracted blade edge 5a and easily adhere to the photoconductor 10.

On the other hand, as illustrated in FIG. 12B, the surface of the photoconductor 10 roughens gradually and projections are formed thereon as the use time increases, and the contact area with the blade edge 5a of the cleaning blade 5 decreases. Due to this, the friction force between the blade edge 5a and the surface of the photoconductor 10 decreases and the retraction of the blade edge 5a by the rotation of the photoconductor 10 decreases. Moreover, the action of allowing the toner, external additives, or the like leaking from the blade edge 5a to be pressed against the surface of the photoconductor 10 decreases, and these materials become difficult to adhere to the surface of the photoconductor 10. If the linear pressure (contact pressure) and the sliding speed of the removing roller 72 in relation to the photoconductor 10 are set so that adhesion of toner, external additives, or the like to the surface of the photoconductor 10 in an initial use state of the photoconductor 10, since the toner, external additives, or the like become difficult to adhere to the surface of the photoconductor 10 in the time-elapsed state, the foreign substance removing performance of the removing roller 72 becomes excessive and the wearing of the photoconductor 10 is accelerated.

Thus, in the photoconductor cleaning device 1 of this example, the foreign substance removing performance of the removing roller 72 was decreased with the elapse of time in order to maintain the foreign substance removing performance (adhered substance removing performance) of the removing roller 72 appropriately with the elapse of time and prevent acceleration of the wearing of the photoconductor 10 resulting from an excessive foreign substance removing performance. When the foreign substance removing performance is decreased with the elapse of time in this manner, it is possible to set a foreign substance removing performance capable of preventing adhesion of toner, external additives, or the like on the flat surface of the photoconductor 10 in an initial use state of the photoconductor 10 and to set a foreign substance removing performance capable of preventing acceleration of the wearing of the photoconductor 10 in the time-elapsed state. Thus, it is possible to provide the photoconductor cleaning device 1 capable of maintaining the foreign substance removing performance of the removing roller 72 appropriately with the elapse of time and preventing acceleration of the wearing of the photoconductor 10 resulting from an excessive foreign substance removing performance.

Moreover, in the photoconductor cleaning device 1 of this example, a configuration in which the linear pressure (contact pressure) of the removing roller 72 in relation to the photoconductor 10 is decreased with the elapse of time was provided as a method of decreasing the foreign substance removing performance of the removing roller 72 with the elapse of time. When the linear pressure of the removing roller 72 in relation to the photoconductor 10 is decreased with the elapse of time in this manner, it is possible to set the linear pressure at which the foreign substance removing performance capable of preventing adhesion of toner, external additives, or the like on the flat surface of the photoconductor 10 in an initial use state of the photoconductor 10 can be obtained. Moreover, it is possible to set the linear pressure at which acceleration of the wearing of the photoconductor 10 resulting from an excessive foreign substance removing performance (adhered substance removing performance) can be prevented in the time-elapsed state. Thus, it is possible to provide the photoconductor cleaning device 1 capable of maintaining the foreign substance removing performance of the removing roller 72 appropriately with the elapse of time and preventing acceleration of the wearing of the photoconductor 10 resulting from an excessive foreign substance removing performance.

Here, a specific configuration example of decreasing the linear pressure (contact pressure) on the photoconductor 10, of the removing roller 72 provided in the photoconductor cleaning device 1 of this example will be described in more detail with reference to FIGS. 13A and 13B and FIG. 14. As illustrated in FIGS. 13A and 13B, in this photoconductor cleaning device 1, the removing roller 72 has a configuration in which both ends of the removing roller metal core 72a rotated by a driving device are supported by a bearing 78 and the bearing 78 is pressed by a roller pressing end portion of the pressure spring 77. Moreover, an end portion of the pressure spring 77 on the opposite side from the roller pressing end portion abuts against the cam 76b, the cam shaft 76a of the cam 76b is connected to a drive source and is rotated, and the pressure of the pressure spring 77 is variable. Moreover, the pressure regulator 75 is configured such that the bearing 78 that supports the removing roller metal core 72a, the pressure spring 77, and the cam shaft 76a regulate the pressure of pressing the foamed EPDM material layer 72b of the removing roller 72 against the surface of the photoconductor 10 with the aid of the cam 76b connected to a drive source.

In the initial use state of the photoconductor 10 illustrated in FIG. 13A, the pressure regulator 75 is in a state in which the end portion of the pressure spring 77 on the opposite side from the roller pressing end portion is pressed toward the bearing 78 according to the rotational position of the cam 76b and the pressure increases. On the other hand, in the time-elapsed state illustrated in FIG. 13B, the end portion is distant from the bearing 78 according to the rotational position of the cam 76b and the pressure decreases. That is, the pressure regulator 75 is configured such that the cam 76b rotates gradually with the elapse of time from the state in which the pressure is increased in the initial use state of the photoconductor 10 illustrated in FIG. 13A so that the pressure of the pressure spring 77 pressing the removing roller 72 decreases. Due to this, the contact pressure on the photoconductor 10, of the removing roller 72 decreases with the elapse of time. The contact pressure (that is, the roller pressure) on the photoconductor 10, of the removing roller 72 is regulated so as to decrease at a certain rate with the elapse of the use time of the photoconductor 10 as illustrated in FIG. 14. When the roller pressure (contact pressure) decreases with the elapse of time in this manner, the foreign substance removing performance (adhered substance removing performance) decreases with the elapse of time and is maintained to an appropriate level. Thus, it is possible to obtain a foreign substance removing performance capable of preventing adhesion of toner, external additives, or the like on the flat surface of the photoconductor 10 in the initial use state of the photoconductor 10 and to prevent acceleration of the wearing of the photoconductor 10 resulting from an excessive foreign substance removing performance in the time-elapsed state.

### Example 5

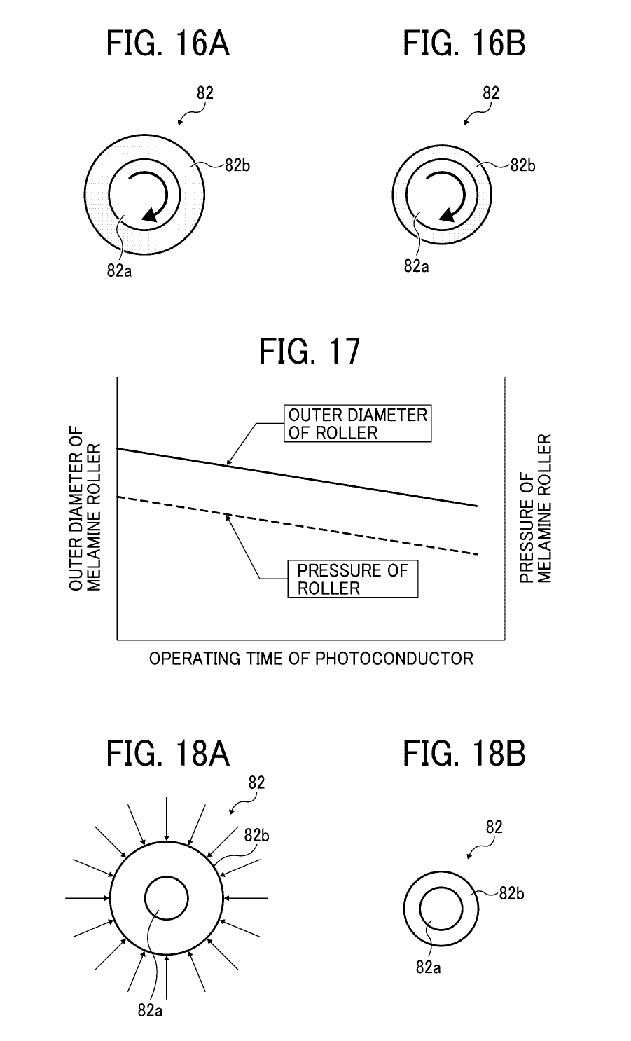

Next, Example 5 of the photoconductor cleaning device 1 provided in the image forming unit 121 of the present embodiment will be described with reference to the drawings. FIG. 15 is a schematic view of a configuration of the image forming unit 121 according to this example. FIGS. 16A and 16B are illustrations of a change in the outer diameter of a melamine roller 82 according to this example, FIG. 16A illustrates an initial use state of the photoconductor 10, and FIG. 16B illustrates the time-elapsed state. FIG. 17 is a graph illustrating a variation in the outer diameter and the pressure of the melamine roller 82 according to this example depending on the use time of the photoconductor 10. FIGS. 18A and 18B are illustrations of a method of forming the melamine roller 82 according to this example.

The photoconductor cleaning device 1 of this example is different from that of Example 4 in terms of a configuration (material) of a roller, a supporting method, a driving method, and a configuration of decreasing the foreign substance removing performance (adhered substance removing performance) of the melamine roller 82 which is the roller of this example with the elapse of time. Thus, the description of the same configuration, operation, and effect as those described in Example 4 will be appropriately omitted. Moreover, components identical or similar to the components of the photoconductor cleaning device 1 of Example 4 will be appropriately denoted by the same reference codes unless it is necessary to distinguish between them.

As described above, the photoconductor cleaning device 1 of this example is different from that of Example 4 in terms of a configuration of the melamine roller 82 which as a roller, a supporting method, a driving method, and a configuration of decreasing the foreign substance removing performance of the melamine roller 82 removing foreign substances adhered to the photoconductor 10 with the elapse of time. Specifically, the melamine roller 82 illustrated in FIG. 15 is a roller which has an outer diameter (φ) of 11.0 mm and in which a melamine foam 82b having a thickness of 2.5 mm is formed on the melamine roller metal core 82a having a diameter (φ) of 6 mm. Similarly to the removing roller 72 of Example 4, this melamine roller 82 is disposed on the upstream side in the direction of rotation of the photoconductor, of the charging roller 41 and on the downstream side in the direction of rotation of the photoconductor, of the cleaning blade 5. That is, the melamine roller 82 is disposed between the charging roller 41 and the cleaning blade 5. On the other hand, a photoconductor pushing depth of the melamine roller 82 (the melamine foam 82b) is set to approximately 0.3 mm. Moreover, since the melamine foam 82b has a cell structure having an enormously large number of fine holes similarly to the foamed urethane 2b illustrated in FIG. 6, the edges of the fine holes effectively slide on the surface of the photoconductor and remove foreign substances adhered to the surface of the photoconductor.

Moreover, the melamine roller 82 is disposed in contact with the surface of the photoconductor 10 in a shaft-to-shaft fixed state in relation to the photoconductor 10 and is rotated by a driving device at a linear velocity of 0.5 times the linear velocity of the surface of the photoconductor 10 in the opposite direction from the direction of rotation of the photoconductor 10 to slide on the photoconductor 10. Here, since the melamine roller 82 is disposed in a shaft-to-shaft fixed state, it is possible to drive the melamine roller 82 with a simple configuration. Moreover, since the melamine roller 82 is rotated at a linear velocity of 0.5 times the linear velocity of the surface of the photoconductor 10 in the opposite direction from the direction of rotation of the photoconductor 10, the sliding speed of the melamine foam 82b in relation to the surface of the photoconductor 10 is 1.5 times the linear velocity of the photoconductor 10 and the sliding effect increases. Since the melamine roller 82 is rotated in the opposite direction from the direction of rotation of the photoconductor 10, it is not necessary to increase the linear velocity of the melamine roller 82 itself by up to 1.5 times the linear velocity of the photoconductor 10 and the number of rotations (rotation speed) of the melamine roller 82 is reduced. Due to this, it is possible to reduce the load on the bearing that supports the melamine roller metal core 82a.

As described above, similarly to the removing roller 72 of Example 4, since the melamine roller 82 is disposed on the upstream side of the charger and on the downstream side of the cleaning blade 5 in relation to the direction of rotation of the photoconductor 10, the melamine roller 82 can provide the same effects as that of Example 4. That is, it is possible to effectively prevent adhesion of toner external additives and the like on the surface of the photoconductor 10 and to obtain a stable foreign substance sliding and scraping effect.

Due to such a stable foreign substance sliding and scraping effect, in a high-density image forming mode and in a high-temperature environment in which the ability of foreign substances to adhere to the photoconductor 10 increases, it is possible to prevent foreign substances from adhering to and accumulating on the photoconductor 10 and to prevent the occurrence of an abnormal image such as white spots. Here, a verification test performed to verify the foreign substance removing effect (adhered substance removing effect) of the melamine roller 82 of this example and the verification test result thereof will be described with reference to Table 2.

TABLE 2

| | | | Roller Sliding | |
|---|---|---|---|---|
| | | | Speed | |
| | | | (Photoconductor | Photoconductor |
| | | | Linear Velocity: | Adhered |
| Roller | Location | Drive Method | Ratio) | Substance |
| None | | | | Poor |
| | | | | (Adhered |
| | | | | substance |
| | | | | Present) |
| Melamine | Before Cleaning | Counter Drive | 1.5 | Poor |
| Roller | Blade | | | (Adhered |
| | | | | substance |
| | | | | Present) |
| Melamine | Between | Co-Rotation Drive | 0.0 | Good |
| Roller | Charging Roller | | | (Small amount |
| | and Cleaning | | | of Adhered |
| | Blade | | | Substance |
| | | | | Present) |
| Melamine | Between | Following | 0.5 | Very good |
| Roller | Charging Roller | Rotation Drive | | (Adhered |
| | and Cleaning | | | Substance Not |
| | Blade | | | Present) |
| Melamine | Between | Following | 0.8 | Very good |
| Roller | Charging Roller | Rotation Drive | | (Adhered |
| | and Cleaning | | | Substance Not |
| | Blade | | | Present) |
| Melamine | Between | Counter Drive | 1.5 | Very good |
| Roller | Charging Roller | | | (Adhered |
| | and Cleaning | | | Substance Not |
| | Blade | | | Present) |

In the test, a linear pressure (contact pressure) on the photoconductor 10, of the melamine roller 82 (a melamine roller in Table 2) was 10.0 N/m, and a three-layer photoconductor was used as the photoconductor 10.

After a full solid image was printed on 10,000 pages of A4-size sheet in a lateral orientation under a high-temperature and high-humidity environment (30° C., 80%) and the conditions illustrated in Table 2, the presence of adhered substances on the photoconductor 10 was evaluated with the naked eyes in the three grades “very good”, “good”, and “poor”. The term “very good” indicates that no adhered substance was observed on the photoconductor 10. That is, adhered substances were not present. The term “good” indicates that such a small amount of adhered substance that may not cause a practical problem was observed on the photoconductor 10. That is, a small amount of adhered substance was present. The term “poor” indicates that adhered substances which can cause an abnormal image were observed on the photoconductor 10. That is, adhered substances were present.

(Verification Result)

A verification result of “poor” was obtained when the melamine roller 82 was not provided. That is, adhered substances which can cause an abnormal image were observed on the photoconductor 10. A verification result of “poor” was obtained when the melamine roller 82 was provided on the upstream side (front side) in the direction of rotation of the photoconductor, of the cleaning blade 5 and was driven in the opposite direction from the photoconductor 10 according to counter drive, and the sliding speed was 1.5 times the photoconductor linear velocity. That is, adhered substances which can cause an abnormal image were observed on the photoconductor 10.

A verification result of “good” was obtained when the melamine roller 82 was provided between the charging roller 41 and the cleaning blade 5 and was driven to rotate with the photoconductor 10, and the sliding speed (relative moving speed) in relation to the photoconductor 10 was 0 (that is, the sliding speed is 0.0 times the photoconductor linear velocity). That is, even when the melamine roller 82 was provided between the charging roller 41 and the cleaning blade 5, and a linear velocity difference from the photoconductor 10 was not provided, only a small amount of adhered substances that does not cause a practical problem was observed on the photoconductor 10.

A verification result of “very good” (that is, no adhered substance observed on the photoconductor 10) was obtained when the melamine roller 82 was provided between the charging roller 41 and the cleaning blade 5 and driven in a direction following the photoconductor 10, and the sliding speed was 0.5 times the photoconductor linear velocity. A verification result of “very good” (that is, no adhered substance observed on the photoconductor 10) was obtained when the melamine roller 82 was provided between the charging roller 41 and the cleaning blade 5 and was driven in a direction following the photoconductor 10, and the sliding speed was 0.8 times the photoconductor linear velocity. A verification result of “very good” (that is, no adhered substance observed on the photoconductor 10) was obtained when the melamine roller 82 was provided between the charging roller 41 and the cleaning blade 5 and was driven in the opposite direction from the photoconductor 10 according to counter drive, and the sliding speed was 1.5 times the photoconductor linear velocity.

From these evaluation results, it was possible to confirm that the melamine roller 82 of this example, which is provided between the charging roller 41 and the cleaning blade 5 and was not driven with a linear velocity difference in relation to the photoconductor 10 can provide a satisfactory foreign substance removing effect. Due to such a stable sliding and scraping effect, the melamine roller 82 of this example can prevent or inhibit foreign substances from adhering to and accumulating on the photoconductor 10 in a high-temperature environment in which the ability of foreign substances to adhere to the photoconductor 10 increases. Due to this, it is possible to prevent or reduce the occurrence of an abnormal image such as white spots.

Moreover, the configuration of decreasing the foreign substance removing performance of the melamine roller 82 of this example with the elapse of time is a configuration in which the melamine foam 82b formed of a melamine foam is provided on the melamine roller metal core 82a and the melamine roller 82 is disposed in a shaft-to-shaft fixed state. The following is the reason why this configuration can decrease the foreign substance removing performance of the melamine roller 82 with the elapse of time. The melamine roller 82 of this example has a configuration in which the contact portion with the surface of the photoconductor 10 is formed of melamine foam (the melamine foam 82b). Due to this, when the use time of the hard and brittle melamine foam 82b increases, the melamine foam 82b wears at a certain rate with the elapse of the use time of the photoconductor 10 from the initial use state illustrated in FIG. 16A, the outer diameter decreases as illustrated in FIG. 16B, and the contact pressure of the melamine roller in the shaft-to-shaft fixed state also decreases.

As illustrated in the graph of FIG. 17, when the outer diameter of the melamine roller 82 decreases with the elapse of the use time of the photoconductor 10, the contact pressure (that is, the roller pressure) also decreases at a certain rate. When the roller pressure (contact pressure) decreases with the elapse of time in this manner, the foreign substance removing performance (adhered substance removing performance) decreases with the elapse of time and is maintained to an appropriate level. Thus, it is possible to obtain a foreign substance removing performance capable of preventing adhesion of toner, external additives, or the like on the flat surface of the photoconductor 10 in the initial use state of the photoconductor 10 and to prevent acceleration of the wearing of the photoconductor 10 resulting from an excessive foreign substance removing performance in the time-elapsed state.

That is, when the contact pressure on the photoconductor 10, of the melamine roller 82 is decreased with the elapse of time, it is possible to obtain a foreign substance removing performance capable of preventing adhesion of toner, external additives, or the like on the surface of the photoconductor 10 in the initial use state and to prevent acceleration of the wearing of the photoconductor 10 resulting from an excessive foreign substance removing performance in the time-elapsed state. Thus, it is possible to maintain the foreign substance removing performance of the melamine roller 82 appropriately with the elapse of time and to prevent acceleration of the wearing of the photoconductor 10 resulting from an excessive foreign substance removing performance.

Moreover, the melamine roller 82 of the photoconductor cleaning device 1 of this example is obtained by molding the melamine foam 82b as illustrated in FIG. 18A and compressing the melamine foam 82b in a roller diameter direction to create the state illustrated in FIG. 18B. In this manner, when the melamine foam 82b which is the contact portion of the melamine roller 82, making contact with the photoconductor 10 after molding the melamine foam 82b, the number of holes in the melamine foam 82b decreases and the melamine foam 82b becomes uniform. Due to this, the area of a non-contact portion between the melamine roller 82 and the surface of the photoconductor 10, which is the defective holes of the melamine foam material decreases, the contact becomes stable, and the foreign substance removing performance of the melamine roller 82 becomes stable. Moreover, since the melamine foam 82b is compressed in the roller diameter direction after the melamine foam 82b is formed, the surface of the melamine roller 82 is uniformly compressed in the circumferential direction and the contact between the outer circumferential surface of the melamine roller 82 and the surface of the photoconductor 10 becomes stable.

Here, in the melamine roller 82 of this example, the compression ratio of the melamine foam 82b is between 10 and 70% so that the removing performance of the melamine roller 82 is maintained to an appropriate level. When the compression ratio is smaller than 10%, since it is not possible to sufficiently remove holes in the melamine foam 82b, the contact between the melamine roller 82 and the photoconductor 10 becomes unstable. Moreover, when the compression ratio is larger than 70%, the melamine foam 82b becomes too hard, the surface of the photoconductor 10 is damaged, and the wearing of the photoconductor 10 is accelerated. Moreover, the cell diameter of the melamine foam 82b is between 20 μm and 800 μm so that the foreign substance removing performance (adhered substance removing performance) of the melamine roller 82 is maintained to an appropriate level. When the cell diameter of the melamine foam 82b is smaller than 20 μm, the density and hardness of the melamine foam 82b become excessively high and the wearing of the photoconductor 10 is accelerated. In contrast, when the cell diameter is larger than 800 μm, the melamine roller 82 and the photoconductor 10 cannot make stable contact due to defective holes in the cell, and the foreign substance removing performance becomes insufficient.

### Example 6

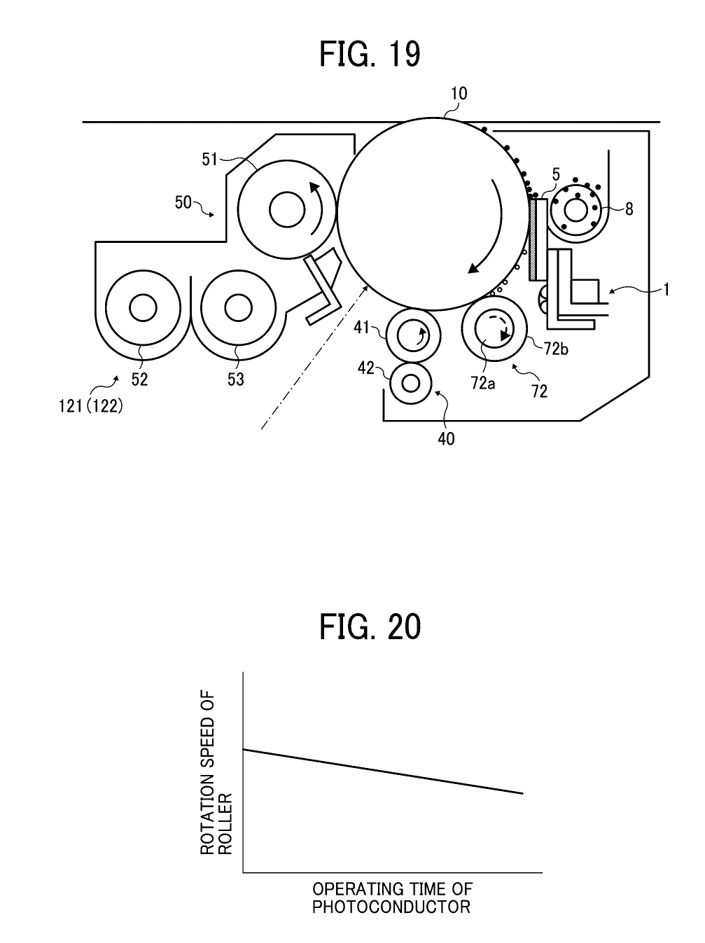

Next, Example 6 of the photoconductor cleaning device 1 provided in the image forming unit 121 of the present embodiment will be described with reference to the drawings. FIG. 19 is a schematic view of a configuration of the image forming unit 121 according to this example. FIG. 20 is a graph illustrating an example of regulating a number of rotations of the removing roller according to this example, corresponding to the use time of the photoconductor 10.

The photoconductor cleaning device 1 of this example is different from that of Example 4 in terms of a roller supporting method and a roller drive control method as a configuration of decreasing the foreign substance removing performance (adhered substance removing performance) of the roller with the elapse of time. Thus, the description of the same configuration, operation, and effect as those described in Example 4 will be appropriately omitted. Moreover, components identical or similar to the components of the photoconductor cleaning device 1 of Example 4 will be appropriately denoted by the same reference codes unless it is necessary to distinguish between them.

As described above, the photoconductor cleaning device 1 of this example is different from that of Example 4 in terms of a method of supporting the removing roller 72 which is a roller and a drive control method as a configuration of decreasing the foreign substance removing performance (adhered substance removing performance) of the removing roller 72 with the elapse of time. Specifically, similarly to Example 4, the removing roller 72 illustrated in FIG. 19 is a roller which has an outer diameter (φ) of 11.0 mm and in which a foamed EPDM material layer 72b having a hardness of 15° (Asker-C) and a thickness of 2.5 mm is formed on a removing roller metal core 72a having a diameter (φ) of 6 mm.

Moreover, the removing roller 72 of this example is disposed in contact with the surface of the photoconductor 10 in a shaft-to-shaft fixed state in relation to the photoconductor 10 and is rotated by a driving device at a linear velocity of 0.5 times the linear velocity of the surface of the photoconductor 10 in the opposite direction from the direction of rotation of the photoconductor 10 to slide on the photoconductor 10. Here, since the removing roller 72 is disposed in a shaft-to-shaft fixed state, it is possible to drive the removing roller 72 with a simple configuration.

Moreover, similarly to Example 4, the removing roller 72 of this example can provide the same effects as that of Example 4 since the removing roller 72 is disposed on the upstream side of the charger and the downstream side of the cleaning blade 5 in relation to the direction of rotation of the photoconductor 10. That is, it is possible to effectively prevent adhesion of toner external additives and the like on the surface of the photoconductor 10 and to obtain a stable foreign substance sliding and scraping effect. Due to such a stable foreign substance sliding and scraping effect, in a high-density image forming mode and in a high-temperature environment in which the ability of foreign substances to adhere to the photoconductor 10 increases, it is possible to prevent foreign substances from adhering to and accumulating on the photoconductor 10 and to prevent the occurrence of an abnormal image such as white spots.

Moreover, the removing roller 72 of this example features in a drive control method of the removing roller 72 as a configuration of decreasing the foreign substance removing performance of the removing roller 72 with the elapse of time. The drive control method of the removing roller 72 is a method of controlling the driving so that a sliding speed (relative moving speed) of a contact face of the removing roller 72 in relation to the photoconductor 10 decreases with the elapse of time. Specifically, as illustrated in the graph of FIG. 20, the driving of a driving device is controlled so that the number of rotations per unit time of the removing roller 72 having correlation with the sliding speed of the contact face of the removing roller 72 in relation to the photoconductor 10 decreases at a certain rate with the elapse of the use time of the photoconductor 10. That is, the photoconductor cleaning device 1 of this example is configured such that the number of rotations per unit time of the removing roller 72 can be changed.

When toner, external additives, or the like become difficult to adhere to the surface of the photoconductor 10 with the elapse of time, the number of rotations per unit time of the removing roller 72 is decreased to decrease the foreign substance removing performance (adhered substance removing performance). When the number of rotations per unit time of the removing roller 72 is decreased in this manner, it is possible to set the sliding speed of the contact face of the polishing roller 2 in relation to the surface of the photoconductor 10 so that the foreign substance removing performance capable of preventing adhesion of toner, external additives, or the like on the flat surface of the photoconductor 10 can be obtained in the initial use state of the photoconductor 10. Moreover, it is possible to set the sliding speed of the contact face of the polishing roller 2 in relation to the surface of the photoconductor 10 so that acceleration of the wearing of the photoconductor 10 resulting from an excessive foreign substance removing performance can be prevented in the time-elapsed state. That is, when the number of rotations per unit time (sliding speed) of the removing roller 72 is decreased with the elapse of time, the foreign substance removing performance decreases. Thus, it is possible to obtain a foreign substance removing performance capable of preventing adhesion of toner, external additives, or the like on the flat surface of the photoconductor 10 in the initial use state and to prevent acceleration of the wearing of the photoconductor 10 resulting from an excessive foreign substance removing performance in the time-elapsed state. Thus, it is possible to maintain the foreign substance removing performance of the removing roller 72 appropriately with the elapse of time and to prevent acceleration of the wearing of the photoconductor 10 resulting from an excessive foreign substance removing performance.

### Example 7

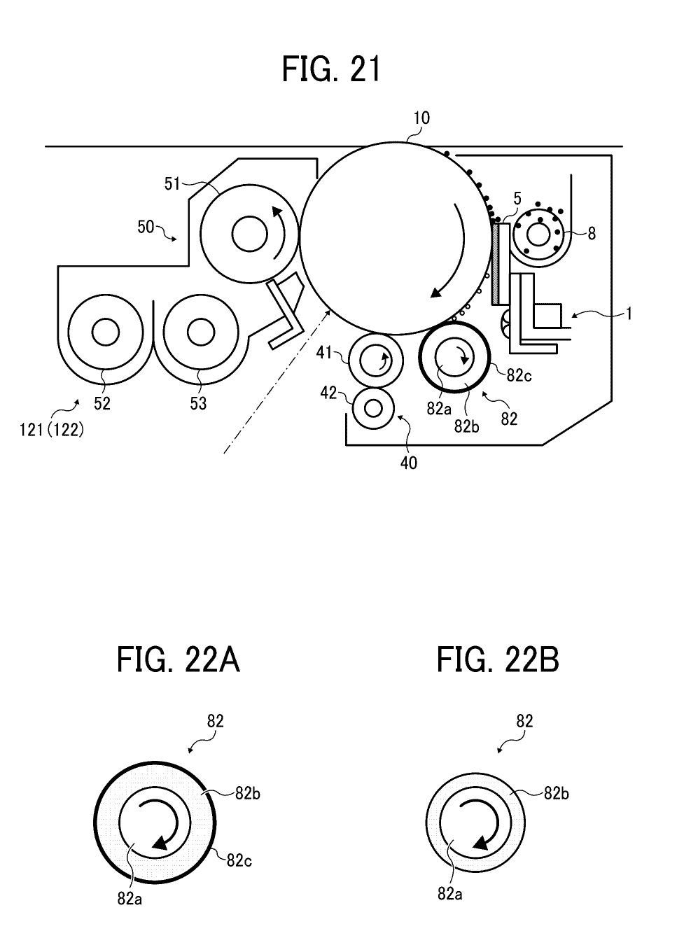

Next, Example 7 of the photoconductor cleaning device 1 provided in the image forming unit 121 of the present embodiment will be described with reference to the drawings. FIG. 21 is a schematic view of a configuration of the image forming unit 121 according to this example. FIGS. 22A and 22B are illustrations of a change over time of a melamine roller according to this example in which inorganic fine particles are added to the surface, FIG. 22A illustrates an initial use state of the photoconductor 10, and FIG. 22B illustrates the time-elapsed state.

The photoconductor cleaning device 1 of this example is different from that of Example 5 in terms of a configuration of the roller. Thus, the description of the same configuration, operation, and effect as those described in Example 5 will be appropriately omitted. Moreover, components identical or similar to the components of the photoconductor cleaning device 1 of Example 5 will be appropriately denoted by the same reference codes unless it is necessary to distinguish between them.

As described above, the photoconductor cleaning device 1 of this example is different from that of Example 5 in terms of a configuration of the melamine roller 82 which is a roller. Specifically, the photoconductor contact portion of the melamine roller 82 illustrated in FIG. 21 is formed using the melamine foam 82b. However, unlike Example 5, inorganic fine particles 82c (for example, aluminum oxides) are attached to the outer circumferential surface (surface) of the melamine foam 82b (the melamine roller 82). When the inorganic fine particles 82c are attached to the outer circumferential surface of the melamine foam 82b in this manner, it is possible to enhance of the foreign substance removing effect (adhered substance removing performance) of the surface of the melamine foam 82b.

In the initial use state of the melamine roller 82, as illustrated in FIG. 22A, the foreign substance removing effect of the melamine roller 82 is enhanced by the inorganic fine particles 82c attached to the surface of the melamine foam 82b. On the other hand, in the time-elapsed state, the surface of the melamine foam 82b wears, the inorganic fine particles 82c attached to the outer circumferential surface disappear as illustrated in FIG. 22B, and the foreign substance removing effect decreases.

### Example 8

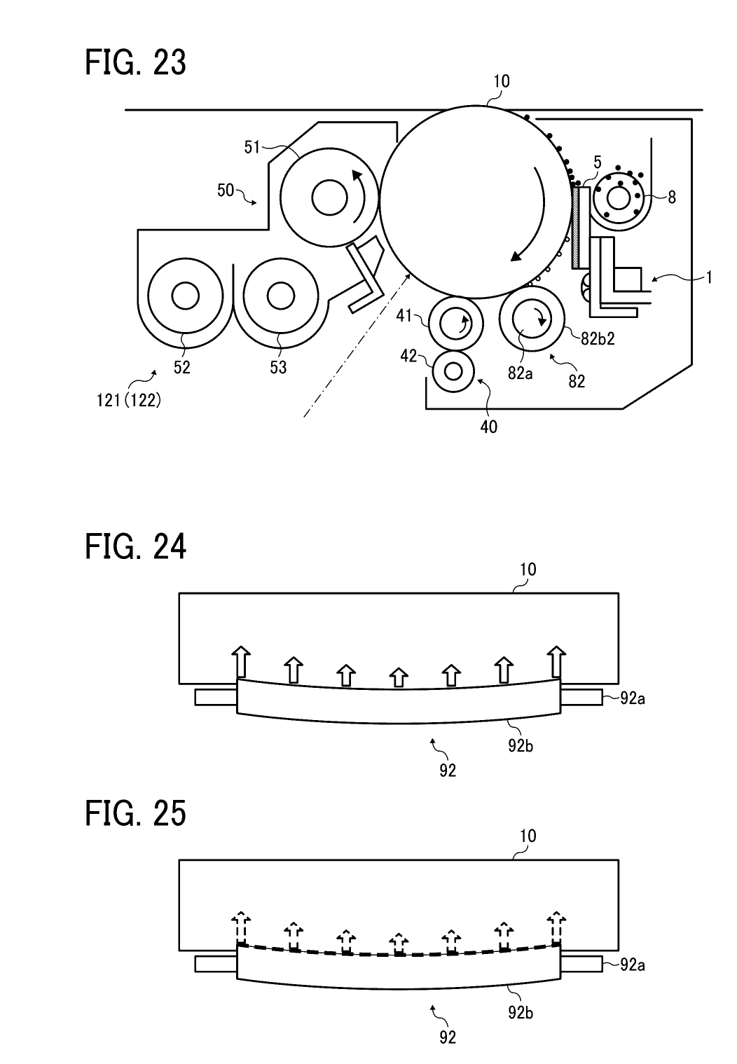

Next, Example 8 of the photoconductor cleaning device 1 provided in the image forming unit 121 of the present embodiment will be described with reference to the drawings. FIG. 23 is a schematic view of a configuration of the image forming unit 121 according to this example. FIG. 24 is an illustration of a contact pressure variation occurring at the ends and the center of a roller 92 of which the outer diameter is uniform in the longitudinal direction, and FIG. 25 is an illustration of toner held on the surface of the roller 92 disposed on the upstream side of the cleaning blade 5.

The photoconductor cleaning device 1 of this example is different from that of Example 5 in terms of a configuration of the roller. Thus, the description of the same configuration, operation, and effect as those described in Example 5 will be appropriately omitted. Moreover, components identical or similar to the components of the photoconductor cleaning device 1 of Example 5 will be appropriately denoted by the same reference codes unless it is necessary to distinguish between them.

As described above, the photoconductor cleaning device 1 of this example is different from that of Example 5 in terms of a configuration of the melamine roller 82 which is a roller. Specifically, the melamine roller 82 illustrated in FIG. 23 has a configuration in which the thickness of (the layer) of a melamine foam 82b2 which is an elastic material is made different in the longitudinal direction so that the outer diameter at the center is larger than that at the ends unlike Example 5 in which the roller outer diameter is uniform in the longitudinal direction. The reason why the thickness of the melamine foam 82b2 is made different in the longitudinal direction so that the outer diameter at the center is larger than that at the ends will be described.

The following failures may occur in the roller 92 in which the thickness of an elastic material 92b that forms an elastic layer on a metal core 92a is uniform in the longitudinal direction and the roller outer diameter is uniform in the longitudinal direction as in the melamine roller of Example 5. The roller 92 which is a photoconductor adhered substance removing roller bends in a direction in which the axial center of the photoconductor 10 is moved away from the photoconductor 10 when the roller 92 presses against the photoconductor 10. When the roller 92 bends in a direction away from the photoconductor 10 in this manner, the contact pressure on the center of the photoconductor 10 of the roller 92 is smaller than that at the ends. Due to this, as illustrated in FIG. 24, a contact pressure variation occurs at the ends and the center, and an adhered substance removing performance variation occurs at the ends and the center due to the contact pressure variation.

Here, in the case of the roller 92 disposed on the upstream side of the cleaning blade 5 like the cleaning roller 9 illustrated in FIG. 3, toner held on the surface of the roller 92 slides on the photoconductor 10 with rotation of the roller 92 and a removing performance is obtained. Due to this, the influence on the removing performance, of the amount of toner held on the surface of the roller 92 is large and the influence of the contact pressure of the roller 92 is small. Thus, it is important to maintain an appropriate amount of toner to be held on the surface of the roller 92 as illustrated in FIG. 25 in order to maintain the adhered substance removing performance. On the other hand, in the case of the roller 92 disposed on the downstream side of the cleaning blade 5, a toner layer is not formed on the surface of the roller 92 unlike a roller disposed on the upstream side of the cleaning blade 5. Due to this, a removing performance variation of the roller 92 becomes remarkable due to the contact pressure variation on the photoconductor 10, of the roller 92.

In the roller 92 of which the outer diameter is uniform in the longitudinal direction, since a linear contact pressure variation occurs at the ends and the center of the photoconductor 10, a removing performance variation occurs at the ends and the center of the roller, and a variation in the photoconductor wearing amount occurs at the ends and the center of the roller with the elapse of time. That is, photoconductor wearing at the ends is more accelerated than at the center and the photoconductor wearing amount at the center becomes larger than that at the ends. As a result, a photoconductor thickness variation occurs at the ends and the center with the elapse of time and an abnormal image such as unevenness of image density occurs. That is, even when the removing roller bends when the outer diameter at the center is increased so that the photoconductor contact pressure variation falls within an appropriate range, the photoconductor contact pressure variation between the ends and the center does not become excessively large. Due to this, it is possible to maintain a uniform photoconductor contact pressure (that is, the removing performance) of the roller or to prevent the removing performance variation from becoming excessively large. Moreover, it is possible to reduce (prevent) an unevenness of photoconductor wearing resulting from the removing performance variation, a deviation in film thickness of a photoconductor resulting therefrom, and the occurrence of an abnormal image such as an unevenness of image density between the ends and the center resulting from deviation in film thickness of a photoconductor.

Thus, the melamine roller 82 of this example is configured such that the outer diameter at the center is larger than that at the ends to reduce the contact pressure variation in the axial direction of the photoconductor, of the melamine roller 82 to maintain the contact pressure uniformly so that the removing performance of the roller is maintained uniformly at the axial direction of the photoconductor. Moreover, the unevenness of photoconductor wearing occurring due to the removing performance variation of the melamine roller 82 between the ends and the center and the occurrence of an abnormal image such as the unevenness of image density like the unevenness of halftone image density between the ends and the center resulting therefrom are reduced.

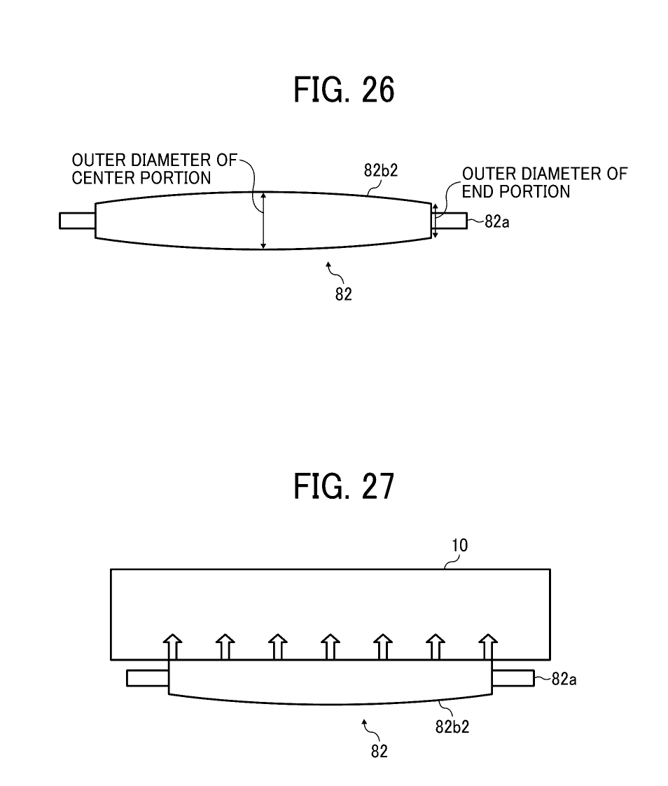

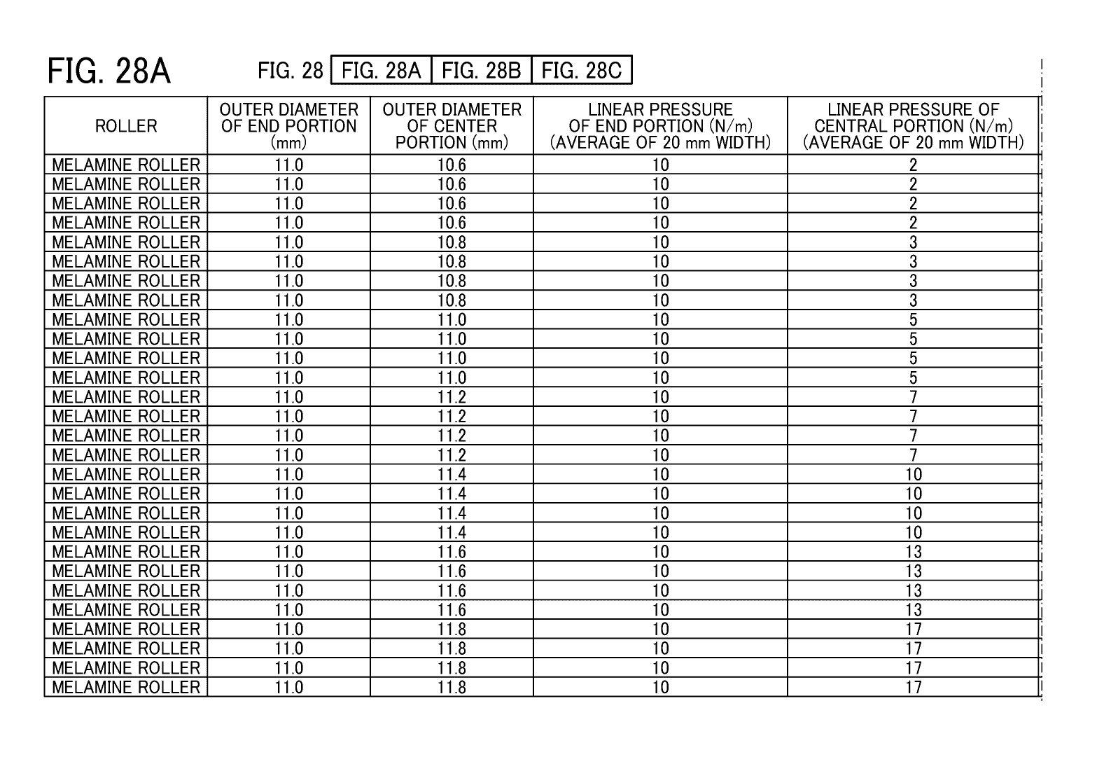

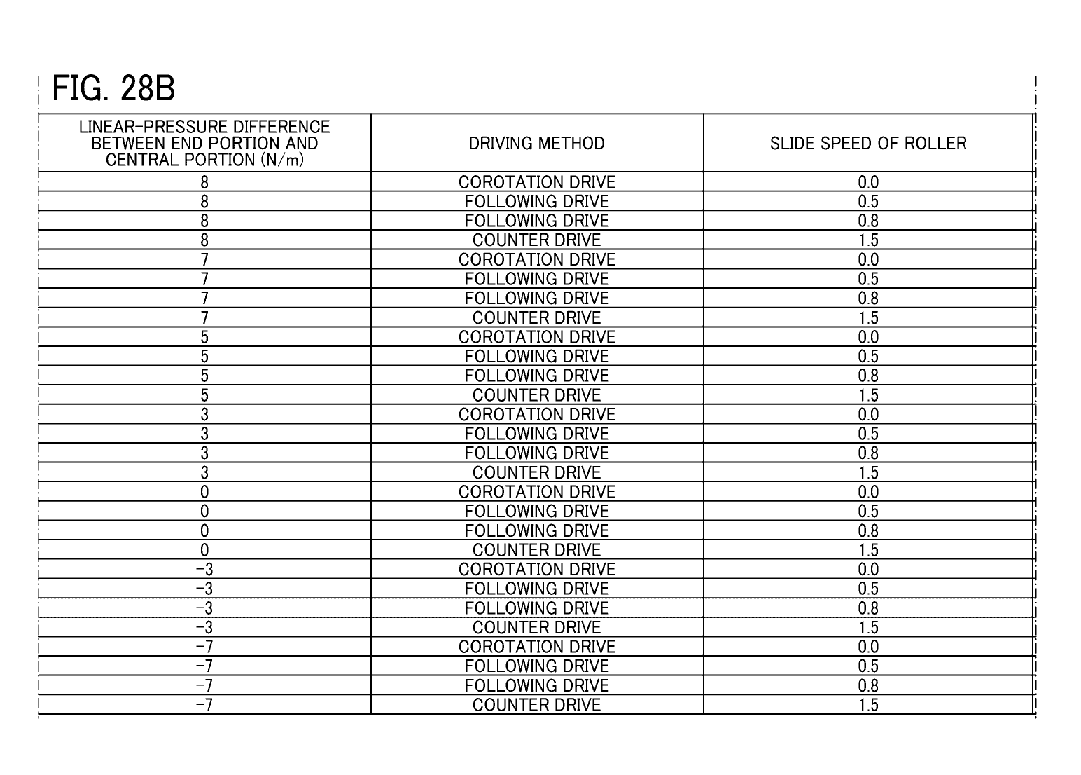

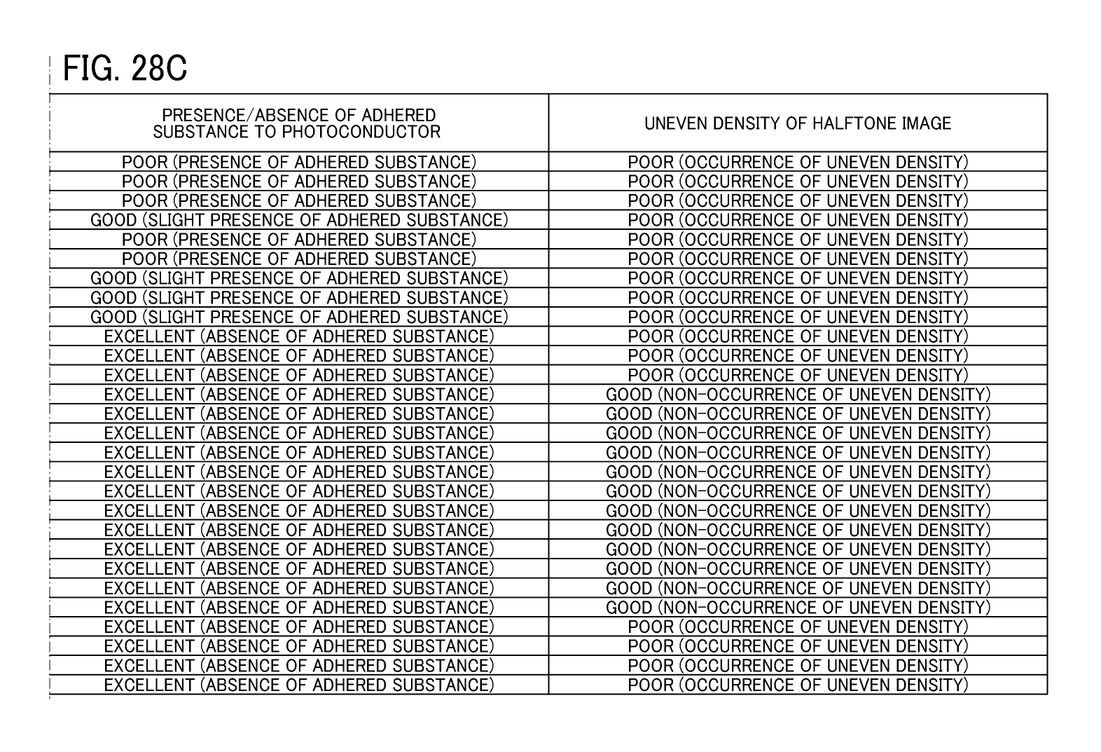

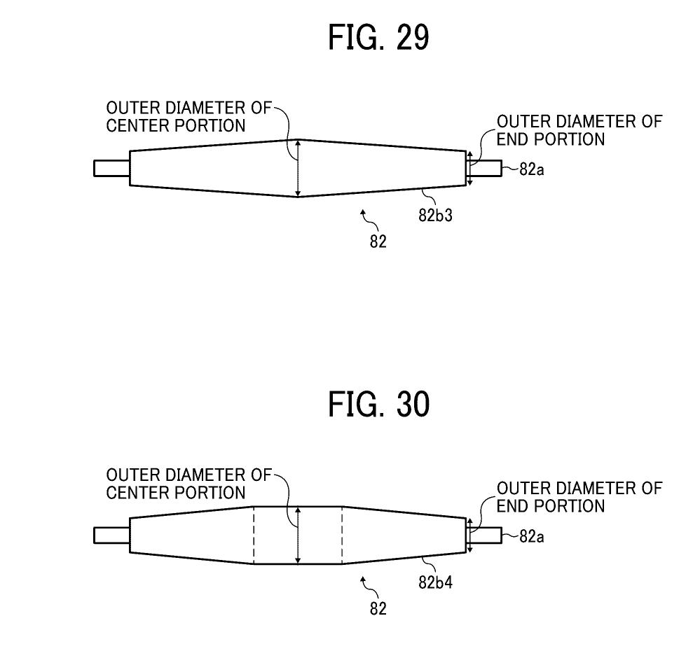

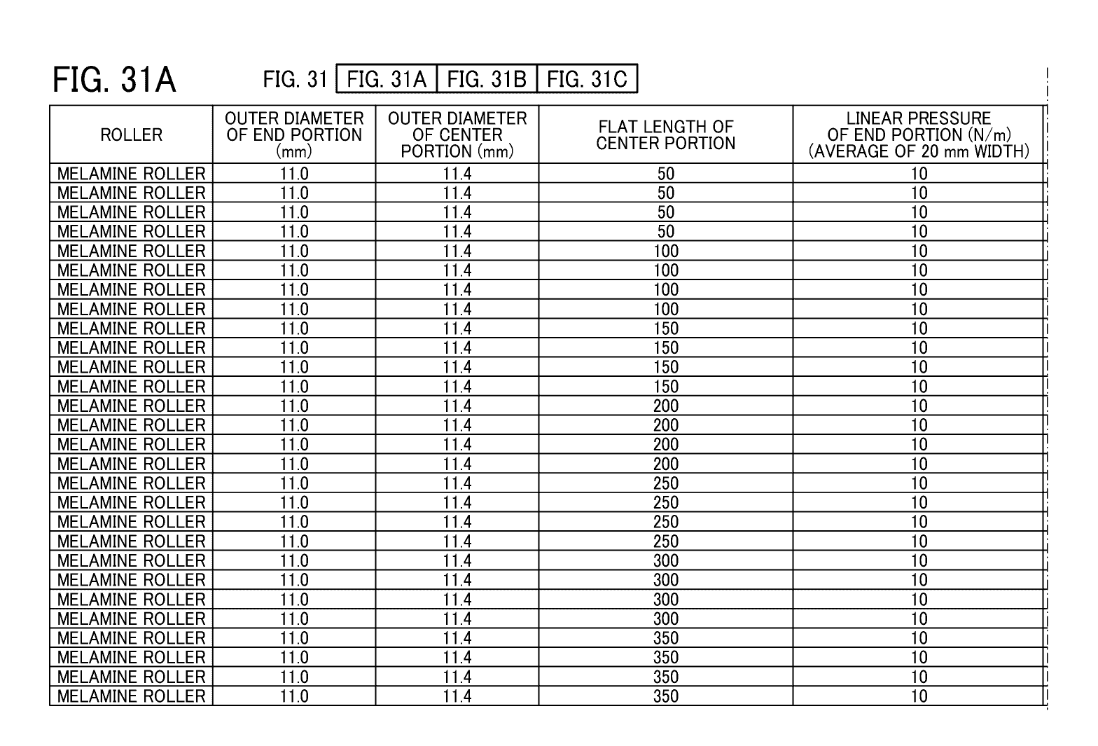

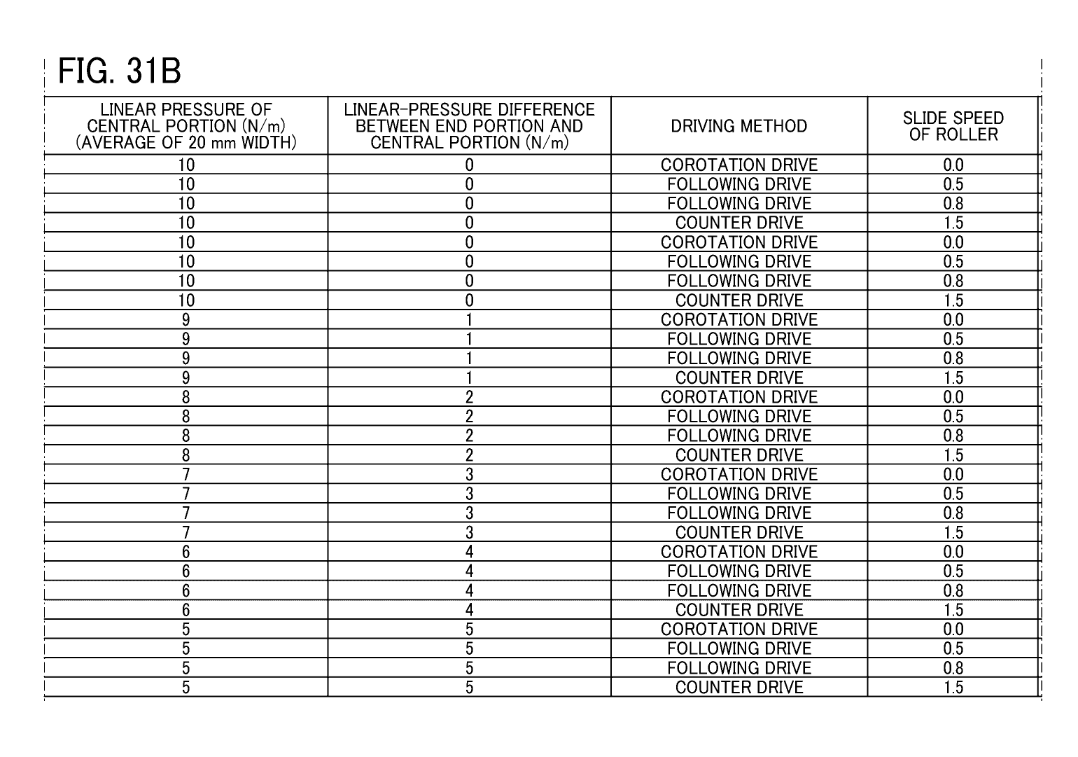

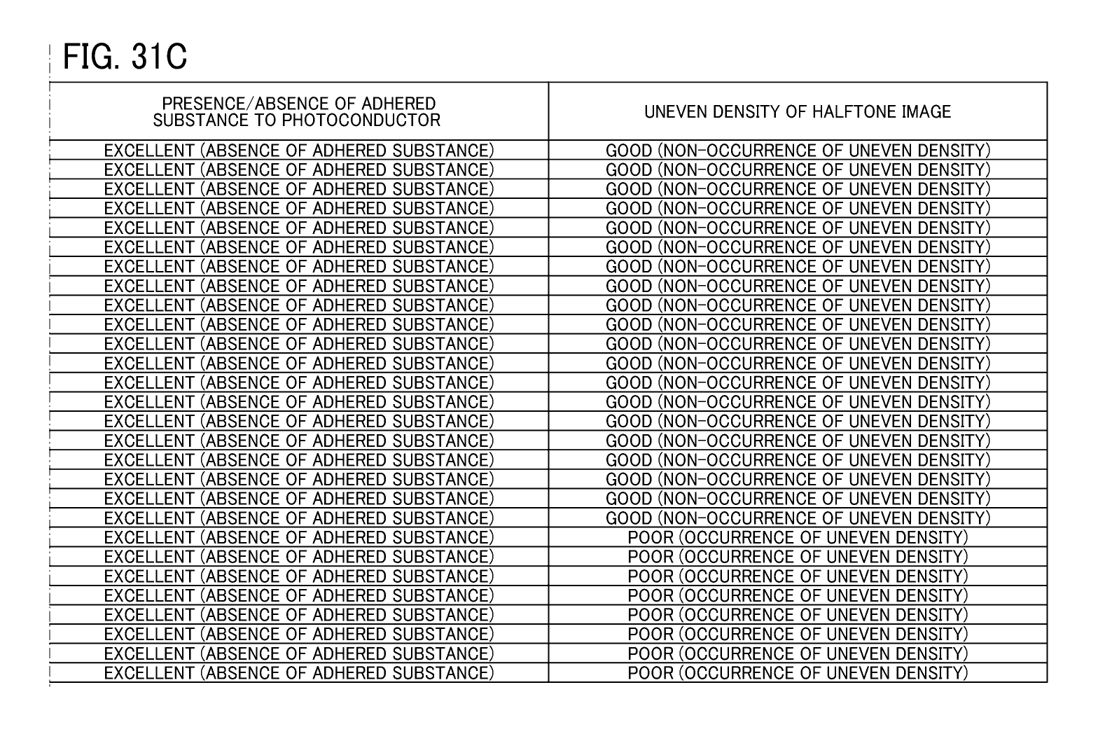

Next, a specific configuration example will be described with reference to the drawings. FIG. 26 is an illustration of an example of the melamine roller 82 according to this example, in which the outer diameter at the center is larger than that at the ends, and FIG. 27 is an illustration of a state in which the outer diameter at the center is larger than that at the ends to reduce a contact pressure variation in the axial direction of the photoconductor. FIG. 28 is a verification test result of a configuration in which the outer diameter at the center of the melamine roller 82 is larger than that at the ends. FIG. 29 is an illustration of another example of the melamine roller 82 according to this example, in which the outer diameter at the center is larger than that at the ends, and FIG. 30 is an illustration of an example in which a central flat portion is provided in the melamine roller 82 according to this example. FIG. 31 is a verification test result of a configuration in which a flat portion is provided in the melamine roller 82.

The melamine roller 82 of this example is configured and disposed in the following manner. The melamine roller 82 is a roller which has an outer diameter (φ) of approximately 11 mm and in which a melamine foam 82b2 having a thickness of approximately 2.5 mm is formed on a melamine roller metal core 82a having a diameter (φ) of 6 mm in order to remove foreign substances such as toner, external additives, or the like adhered on the surface of the photoconductor 10. Moreover, as illustrated in FIG. 23, the melamine roller 82 is disposed on the upstream side in the direction of rotation of the photoconductor, of the charging roller 41 and on the downstream side in the direction of rotation of the photoconductor, of the cleaning blade 5. That is, the melamine roller 82 is disposed between the charging roller 41 and the cleaning blade 5. Moreover, the roller length is set to 350 mm, the photoconductor pushing depth is set to approximately 0.3 mm, and the linear contact pressure is set to approximately 10 N/m. Moreover, since the melamine foam 82b2 has a cell structure having an enormously large number of fine holes similarly to the foamed urethane 2b illustrated in FIG. 6, the edges of the fine holes effectively slide on the surface of the photoconductor to remove the foreign substances adhered to the surface of the photoconductor.

As illustrated in FIG. 26, this melamine roller 82 is configured such that the outer diameter (φ) of the melamine foam 82b2 continuously increases from 11.0 mm at the ends to 11.4 mm at the center while drawing a circular arc shape up to the center. Moreover, the melamine roller 82 is disposed to be presses against the photoconductor 10 in the axial-position fixed state and is rotated by a driving device at a linear velocity of 0.5 times the linear velocity of the surface of the photoconductor 10 in the opposite direction from the direction of rotation of the photoconductor 10 to slide on the photoconductor 10. Since the melamine roller 82 performs such a sliding operation, as described with reference to Table 2, it is possible to remove adhered substance satisfactorily and to obtain the effect of reducing the occurrence of shoal-shaped toner. Moreover, since the melamine roller 82 is disposed in the shaft-to-shaft fixed state, it is possible to drive the roller with a simple configuration. Moreover, since the melamine roller 82 is driven at a linear velocity of 0.5 times the photoconductor linear velocity in the opposite direction from the direction of rotation of the photoconductor 10, the sliding speed of the melamine roller 82 in relation to the surface of the photoconductor 10 is 1.5 times the photoconductor linear velocity and the sliding effect increases. Since the melamine roller 82 is rotated in the opposite direction from the direction of rotation of the photoconductor 10, it is not necessary to increase the linear velocity of the melamine roller 82 itself by up to 1.5 times the photoconductor linear velocity and the number of rotations of the melamine roller 82 is reduced. Thus, it is possible to reduce the load on the rolling bearing of the roller.

Moreover, as illustrated in FIG. 23, since the melamine roller 82 is disposed on the upstream side of the charger in relation to the direction of rotation of the photoconductor 10, it is possible to remove toner external additives such as silica on the surface of the photoconductor 10 before the surface of the photoconductor 10 is activated by the charging current and the ability of foreign substances to adhere to the surface of the photoconductor 10 increases. Due to this, it is possible to effectively prevent toner external additives or the like from adhering to the surface of the photoconductor 10.

Since the melamine roller 82 is disposed on the downstream side of the cleaning blade 5, the amount of toner supplied to the melamine roller 82 may not change depending on an image area. Moreover, the foreign substance removing performance may not change resulting from a change in a contact area between the melamine roller 82 and the photoconductor 10. Due to this, the melamine roller 82 can provide the removing performance stably. Due to such a stable sliding and scraping effect of the melamine roller 82, in a high-density image forming mode and in a high-temperature environment in which the ability of foreign substances to adhere to the photoconductor 10 increases, it is possible to prevent foreign substances from adhering to and accumulating on the photoconductor 10 and to prevent the occurrence of an abnormal image such as white spots.

A roller of which the diameter is uniform in the longitudinal direction bends by approximately 0.2 mm in a direction in which the axial center of the photoconductor is moved away from the photoconductor when the roller presses against the photoconductor 10 with linear contact pressure of 10 N/m. On the other hand, in the melamine roller 82 of this example, since the outer diameter at the center is larger by 0.4 mm than that of the ends, as illustrated in FIG. 27, the pushing of the roller center into the photoconductor 10 is maintained similarly to the ends. Due to this, the linear contact pressure can be maintained uniformly to an appropriate value (10 N/m) in the axial direction of the photoconductor and the adhered substance removing performance is uniform. Moreover, it is possible to reduce an unevenness of photoconductor wearing resulting from the removing performance variation of the roller between the ends and the center, a deviation in film thickness of a photoconductor resulting therefrom, and the occurrence of an abnormal image such as an unevenness of image density between the ends and the center resulting from the deviation in film thickness of a photoconductor.

Here, a verification test performed to verify the foreign substance removing effect (photoconductor adhered substance removing effect) of the melamine roller 82 of this example and the effect of reducing the unevenness of image density with the lapse of time and the verification test result thereof will be described with reference to FIG. 28. The verification test result described in FIG. 28 is an evaluation result for the melamine roller 82 of FIG. 26, of the occurrence of the photoconductor adhered substances and the unevenness of image density when the outer diameter at the center and the sliding speed of the melamine roller 82 were changed. Moreover, the test was performed under a high-temperature and high-humidity (30° C., 80%) environment condition, the pushing depth at the ends of the melamine roller 82 was set to 0.3 mm, and a three-layer photoconductor was used as the photoconductor 10. Moreover, a running evaluation was performed by printing a full solid image on 30,000 pages of A4-size sheet in a lateral orientation.

After 30,000 pages of sheet were passed under the respective conditions illustrated in FIG. 28, the presence of adhered substances on the photoconductor 10 were evaluated with the naked eyes in the three grades “very good”, “good”, and “poor”. The term “very good” indicates that no adhered substance was observed on the photoconductor 10. That is, adhered substances were not present. The term “good” indicates that such a small amount of adhered substance that may not cause a practical problem was observed on the photoconductor 10. That is, a small amount of adhered substance was present. The term “poor” indicates that adhered substances which can cause an abnormal image were observed on the photoconductor 10. That is, adhered substances were present. Moreover, after 30,000 pages of sheet were passed under the respective conditions illustrated in FIG. 28, the occurrence of the unevenness of halftone image density were evaluated with the naked eyes in the two grades “poor” (occurrence of unevenness of image density) and “good” (non-occurrence of unevenness of image density).

From the verification test result of FIG. 28, it was possible to confirm that the following effects can be obtained. When an outer diameter difference between the ends and the center is set within an appropriate range (0.2 mm to 0.6 mm), the linear contact pressure difference between the ends and the center is 3 N/m or smaller. Moreover, it is possible to remove adhered substances satisfactorily and to reduce the occurrence of the unevenness of image density between the ends and the center resulting from the unevenness of photoconductor wearing.

Moreover, as for the shape of the melamine roller 82 in which the outer diameter difference is provided, if the linear pressure difference between the ends and the center is 3 N/m or smaller, there is no difference in the effect even when the outer diameter changes linearly from the ends to the center as illustrated in FIG. 29 and a flat shape is provided at the center as illustrated in FIG. 30. That is, there is no difference in the effect between a melamine foam 82b3 in which the outer diameter of the melamine foam changes linearly from the ends to the center as illustrated in FIG. 29 and a melamine foam 82b4 in which a flat shape is provided at the center as illustrated in FIG. 30.

However, as illustrated in the verification result of the verification test performed while changing the length of the flat portion of the melamine roller 82 of which the outer diameter (φ) is 11.0 mm at the ends and is 11.4 mm at the central flat portion, illustrated in FIG. 31, if the width of the flat portion exceeds 250 mm, the flat portion bends, the linear contact pressure difference of the roller becomes larger than 3 N/m and the unevenness of photoconductor wearing and the unevenness of image density occur. Here, the verification test of which the verification test result is illustrated in FIG. 31 was performed under the same conditions as the verification test of which the verification test result is illustrated in FIG. 28 except for additional conditions, and the same evaluation was performed.

### Example 9

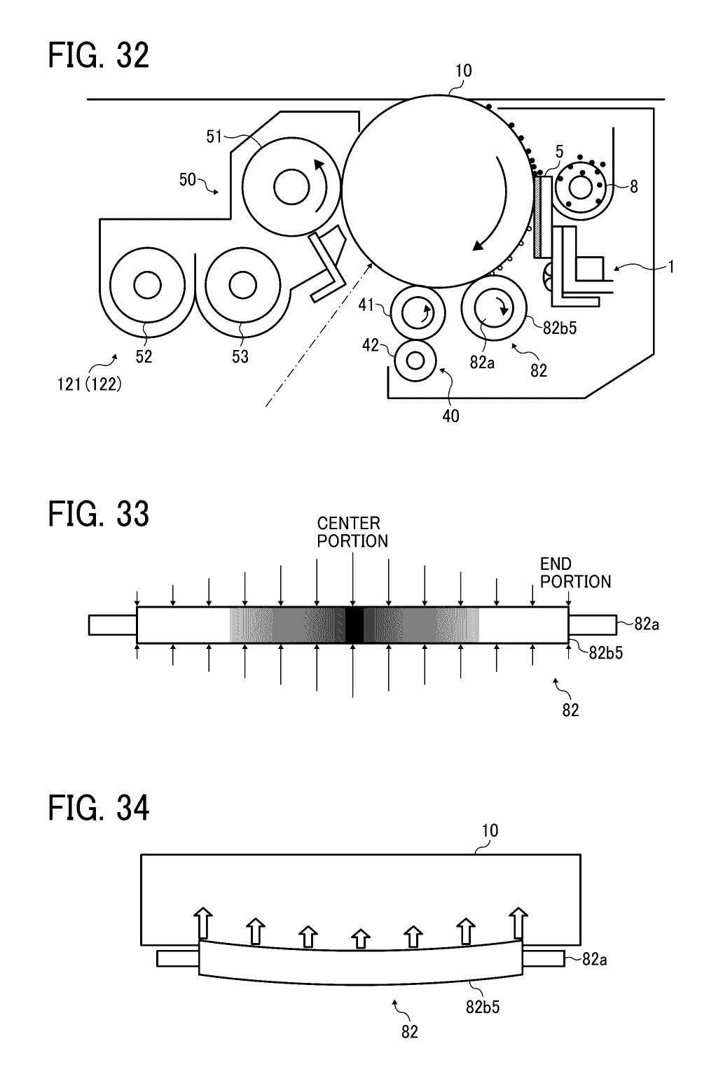

Next, Example 9 of the photoconductor cleaning device 1 provided in the image forming unit 121 of the present embodiment will be described with reference to the drawings. FIG. 32 is a schematic view of a configuration of the image forming unit 121 according to this example. FIG. 33 is an illustration of the melamine roller 82 according to this example, and FIG. 34 is an illustration of a contact pressure variation on the photoconductor 10, which can be reduced by the melamine roller 82 of this example.

The photoconductor cleaning device 1 of this example is different from that of Example 8 in terms of a configuration of reducing the contact pressure variation on the photoconductor 10, of the roller. Thus, the description of the same configuration, operation, and effect as those described in Example 8 will be appropriately omitted. Moreover, components identical or similar to the components of the photoconductor cleaning device 1 of Example 8 will be appropriately denoted by the same reference codes unless it is necessary to distinguish between them.

As described above, the photoconductor cleaning device 1 of this example is different from that of Example 8 in terms of a configuration of reducing the contact pressure variation on the photoconductor 10, of the melamine roller 82 which is a roller. Specifically, the melamine roller 82 illustrated in FIG. 32 is configured such that the outer diameter of a melamine foam 82b5 which is a photoconductor contact portion is uniform in the longitudinal direction as illustrated in FIG. 33 unlike Example 8. Moreover, the hardness at the center in the longitudinal direction of the melamine foam 82b5 that forms an elastic layer of the melamine roller 82 is higher than that at the ends by increasing the compression ratio. When the hardness at the center in the longitudinal direction of the melamine foam 82b5 that forms an elastic layer of the melamine roller 82 is higher than that at the ends by increasing the compression ratio, it is possible to reduce the contact pressure variation on the photoconductor 10, of the melamine roller 82. When the melamine roller 82 is configured in this manner, it is possible to reduce the contact pressure variation on the photoconductor 10 and reduce (prevent) the occurrence of failures resulting from the contact pressure variation similarly to the melamine roller of Example 8.

The melamine roller 82 of this example is configured and disposed in the following manner. The melamine roller 82 is a roller which has an outer diameter (φ) of approximately 11 mm and in which a melamine foam 82b5 having a thickness of approximately 2.5 mm is formed on a melamine roller metal core 82a having a diameter (φ) of 6 mm in order to remove foreign substances such as toner or external additives adhered on the surface of the photoconductor 10. Moreover, as illustrated in FIG. 32, the melamine roller 82 is disposed on the upstream side in the direction of rotation of the photoconductor, of the charging roller 41 and on the downstream side in the direction of rotation of the photoconductor, of the cleaning blade 5. That is, the melamine roller 82 is disposed between the charging roller 41 and the cleaning blade 5. Moreover, the roller length is set to 350 mm, and the photoconductor pushing depth is set to approximately 0.3 mm. Moreover, since the melamine foam 82b5 has a cell structure having an enormously large number of fine holes similarly to the foamed urethane 2b illustrated in FIG. 6, the edges of the fine holes effectively slide on the surface of the photoconductor to remove the foreign substances adhered to the surface of the photoconductor.

Moreover, the melamine foam 82b5 illustrated in FIG. 33 is formed of a compressed material by changing the compression ratio in the axial direction (longitudinal direction) of the photoconductor. The compression ratio is linearly increased from 10% at the ends to 30% at the center so that the hardness at the center is higher (larger) than that at the center. With such a configuration, the melamine foam bends in a direction in which the center is moved away from the photoconductor 10 when the melamine roller 82 is pressed against the photoconductor 10. Thus, even when the pushing depth at the center is smaller than that at the ends, since the center is harder than the ends, a decrease in the contact pressure at the center is prevented. As a result, as illustrated in FIG. 34, the linear contact pressure is maintained uniformly in the axial direction of the photoconductor.

As described above, since the linear contact pressure is maintained approximately uniformly, it is possible to reduce the removing performance variation of the melamine roller 82 between the ends and the center. Due to this, it is possible to reduce an unevenness of photoconductor wearing resulting from the removing performance variation of the melamine roller 82, deviation in film thickness of a photoconductor resulting therefrom, and the occurrence of an abnormal image such as an unevenness of image density between the ends and the center resulting from the deviation in film thickness of a photoconductor.

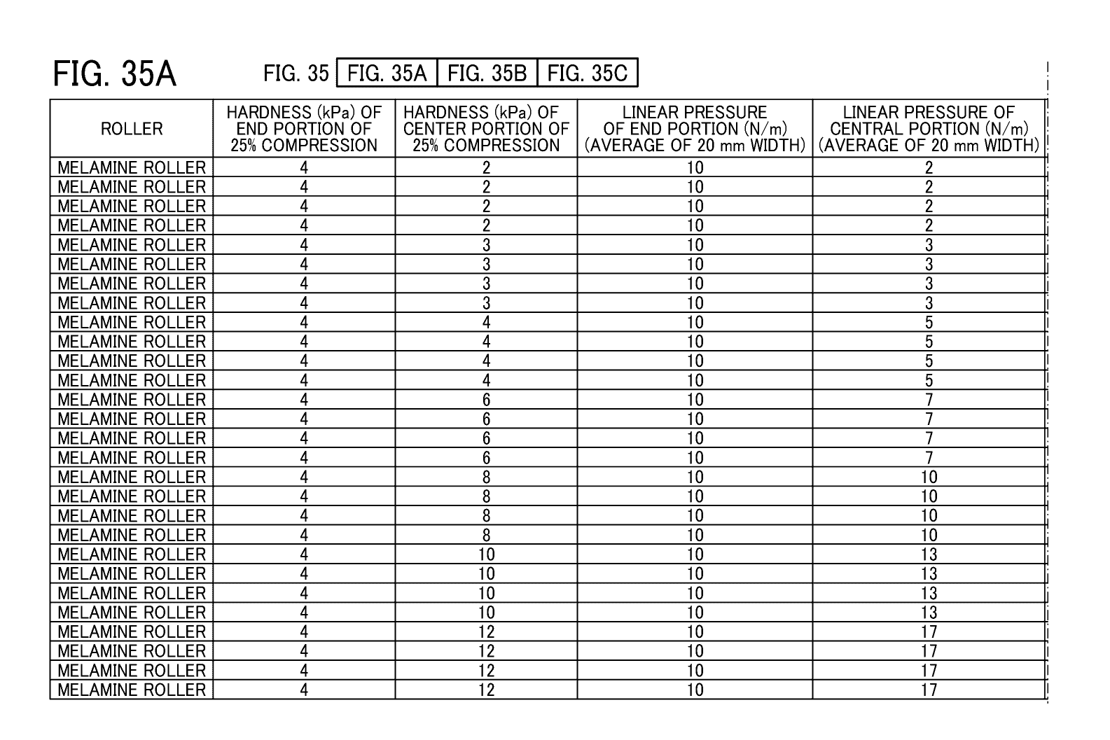

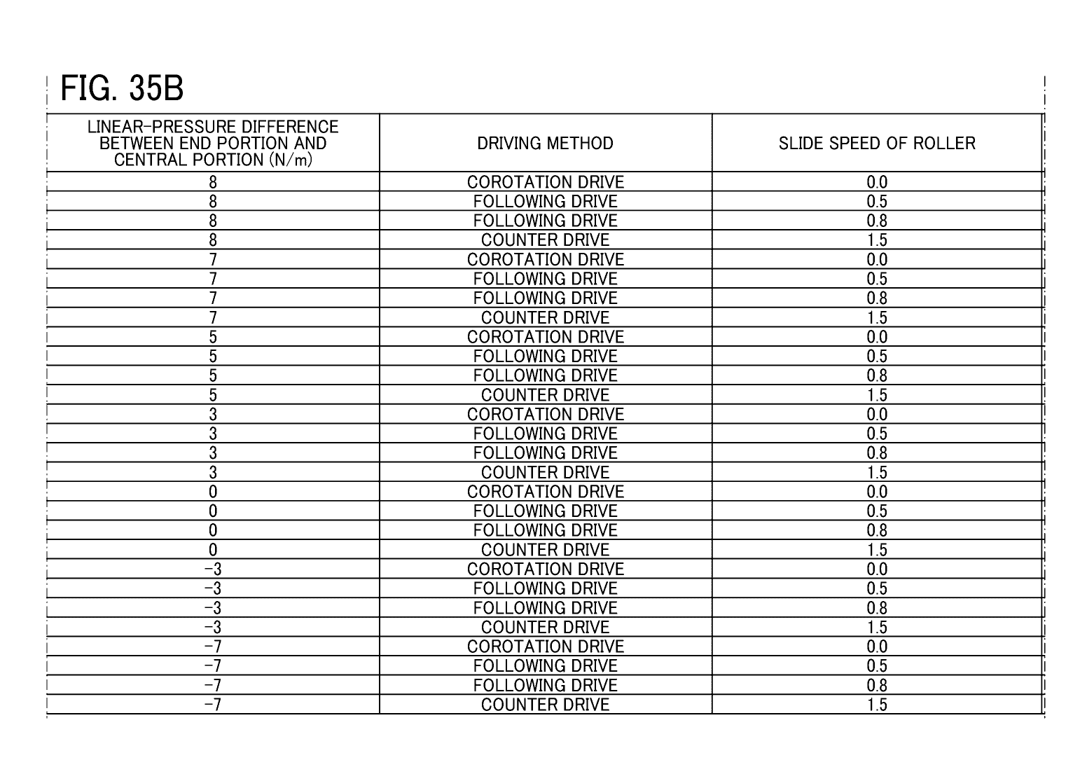

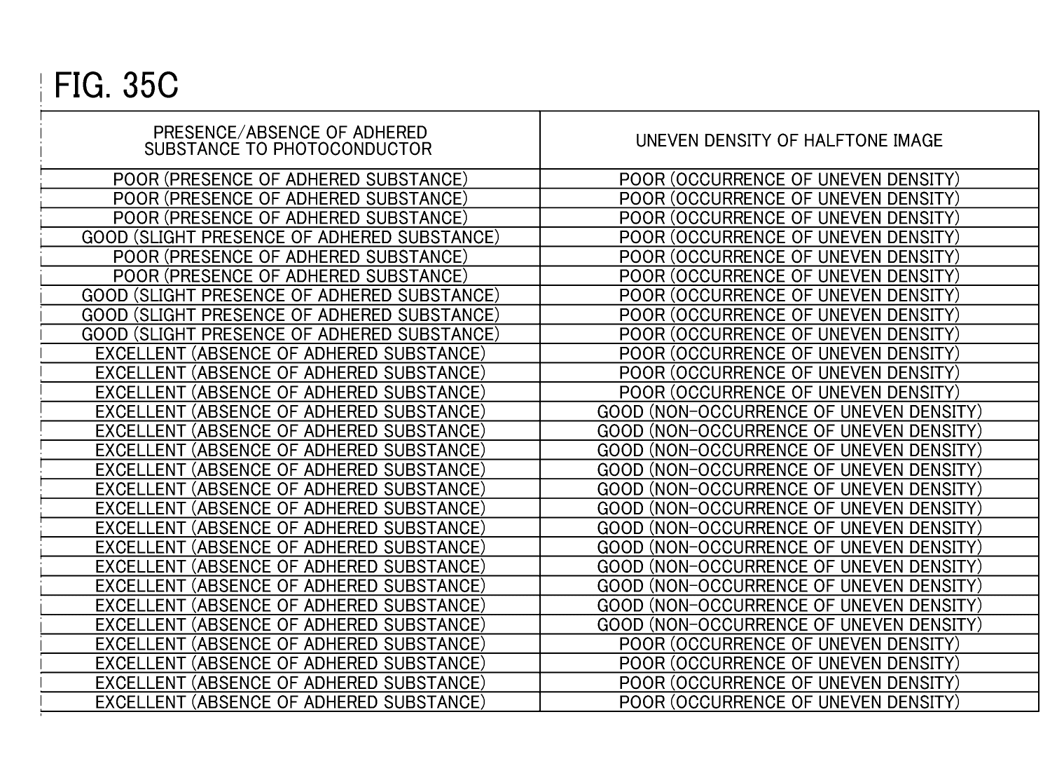

Here, a verification test performed to verify the foreign substance removing effect (photoconductor adhered substance removing effect) of the melamine roller 82 of this example and the effect of reducing the unevenness of halftone image density and the verification test result thereof will be described with reference to FIGS. 35, 36, and 37. First, the verification test of FIG. 35 and the verification test result thereof will be described. The verification test result described in FIG. 35 is an evaluation result for the melamine roller 82 of FIG. 33, of the occurrence of photoconductor adhered substances and unevenness of image density when the hardness at the center and the sliding speed of the melamine roller 82 were changed. Moreover, the test was performed under a high-temperature and high-humidity (30° C., 80%) environment condition, the pushing depth at the ends of the melamine roller 82 was set to 0.3 mm, and a three-layer photoconductor was used as the photoconductor 10. Moreover, a running evaluation was performed by printing a full solid image on 30,000 pages of A4-size sheet in a lateral orientation.

After 30,000 pages of sheet were passed under the respective conditions illustrated in FIG. 35, the presence of adhered substances on the photoconductor 10 were evaluated with the naked eyes in the three grades “very good”, “good”, and “poor”. The term “very good” indicates that no adhered substance was observed on the photoconductor 10. That is, adhered substances were not present. The term “good” indicates that such a small amount of adhered substance that may not cause a practical problem was observed on the photoconductor 10. That is, a small amount of adhered substance was present. The term “poor” indicates that adhered substances which can cause an abnormal image were observed on the photoconductor 10. That is, adhered substances were present. Moreover, after 30,000 pages of sheet were passed under the respective conditions illustrated in FIG. 35, the occurrence of the unevenness of halftone image density were evaluated with the naked eyes in the two grades “poor” (occurrence of unevenness of image density) and “good”, (non-occurrence of unevenness of image density).

From the verification test result of FIG. 35, it was possible to confirm that the following effects can be obtained. When a hardness difference between the ends and the center is set within an appropriate range (2 kPa to 6 kPa), the linear contact pressure difference between the ends and the center is 3 N/m or smaller, and the occurrence of the unevenness of image density between the ends and the center resulting from the unevenness of photoconductor wearing can be reduced.

That is, the hardness of the melamine foam 82b5 that forms the elastic layer of the melamine roller 82 is increased at the center so that the contact pressure variation on the photoconductor 10 is within an appropriate range. Due to this, even when the melamine roller 82 bends and the pushing depth on the photoconductor 10 at the roller center decreases, it is possible to reduce (prevent) the contact pressure variation between the melamine roller 82 and the photoconductor 10 from becoming excessively large. When the contact pressure variation is reduced in this manner, it is possible to maintain the removing performance uniformly and to prevent the removing performance variation from becoming excessively large. Thus, it is possible to prevent the unevenness of wearing of the photoconductor 10 resulting from the removing performance variation of the melamine roller 82 between the ends and the center, and the deviation in film thickness of the photoconductor 10 resulting therefrom, and the occurrence of an abnormal image such as the unevenness of image density between the ends and the center resulting from the deviation in film thickness of the photoconductor 10.

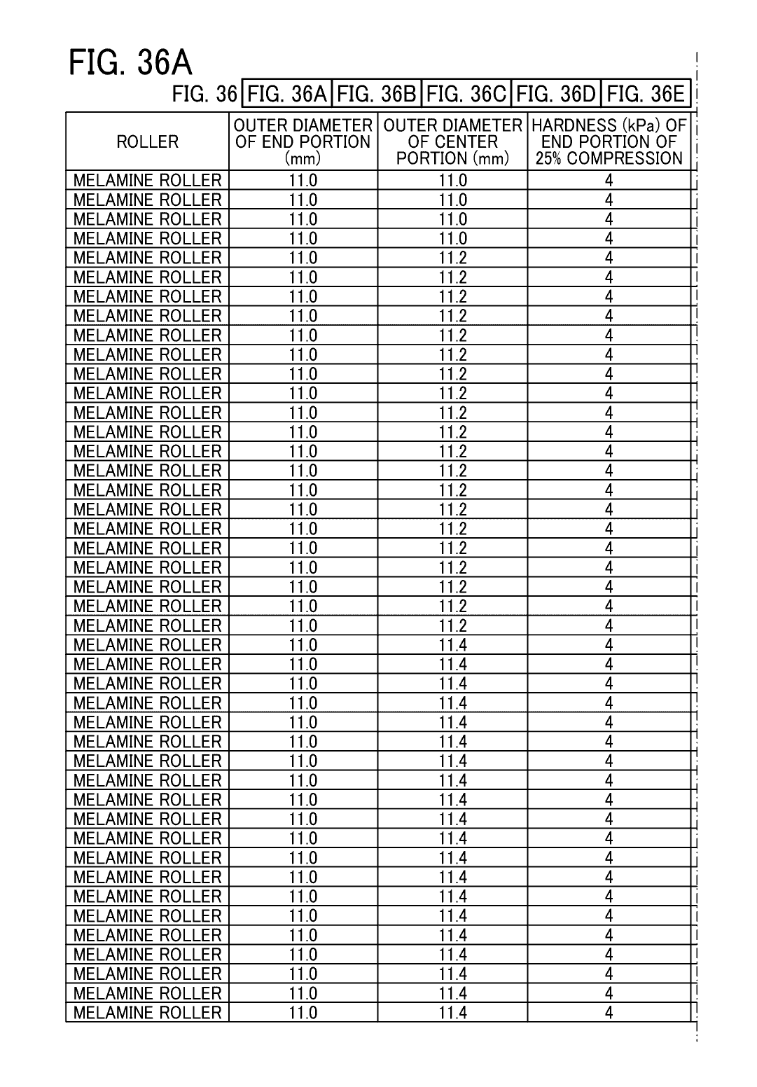

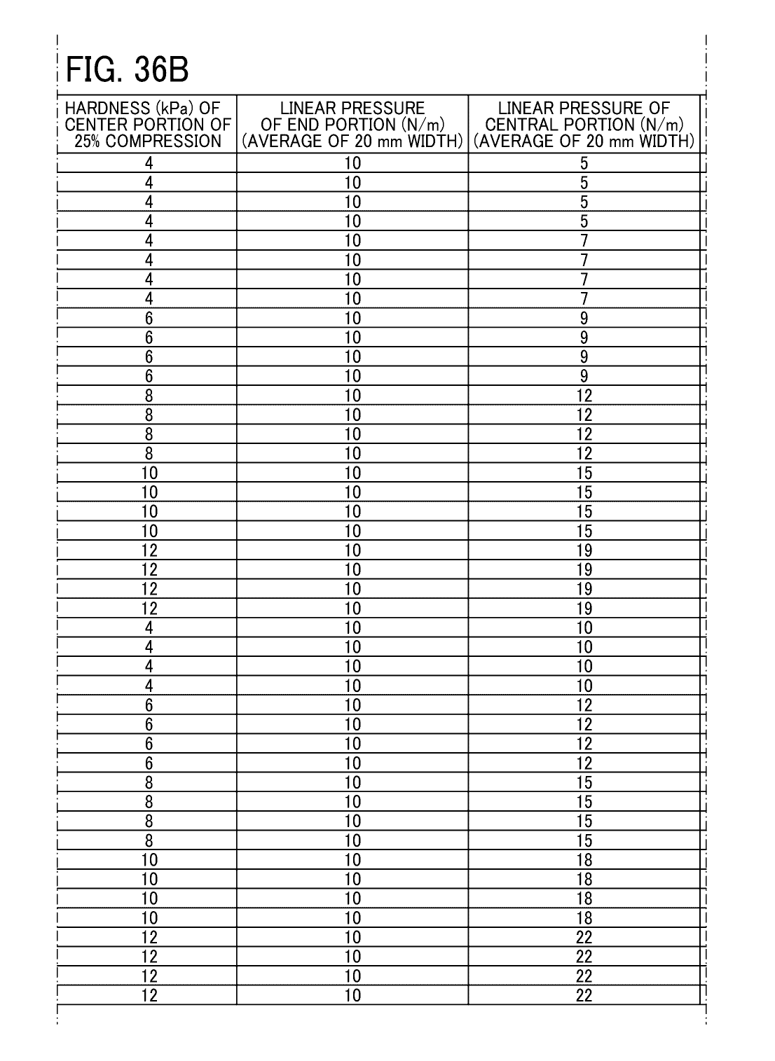

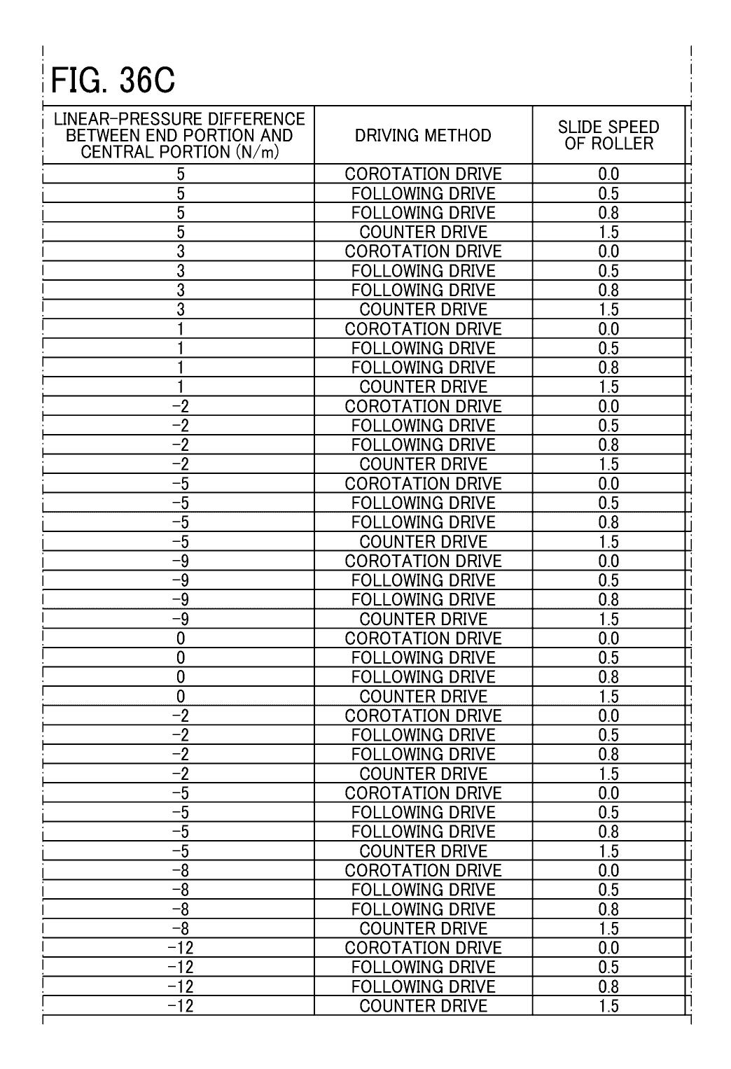

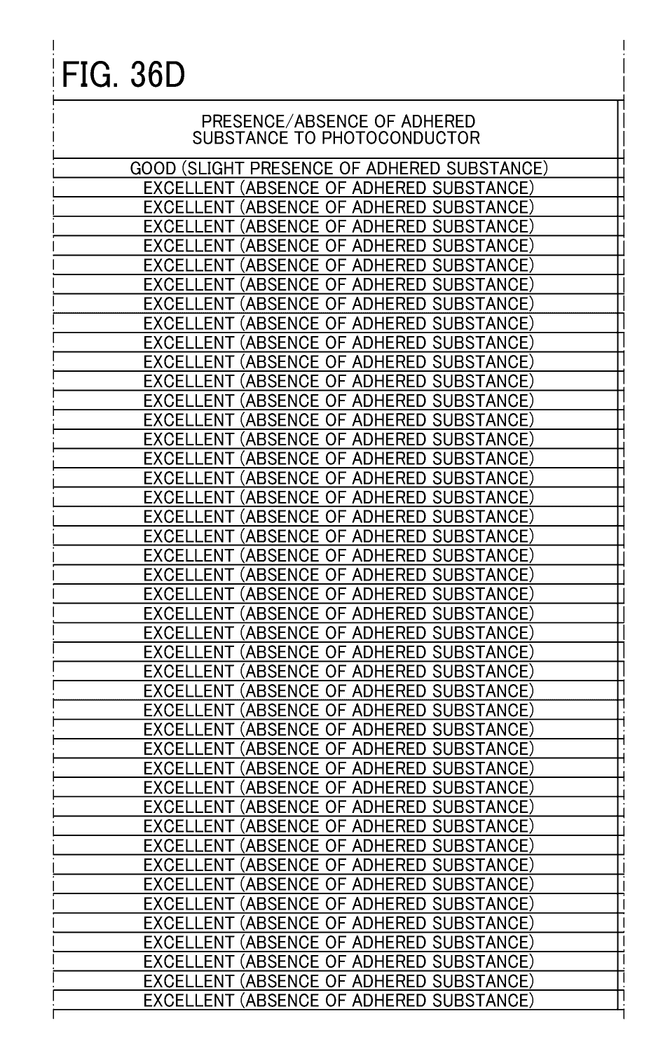

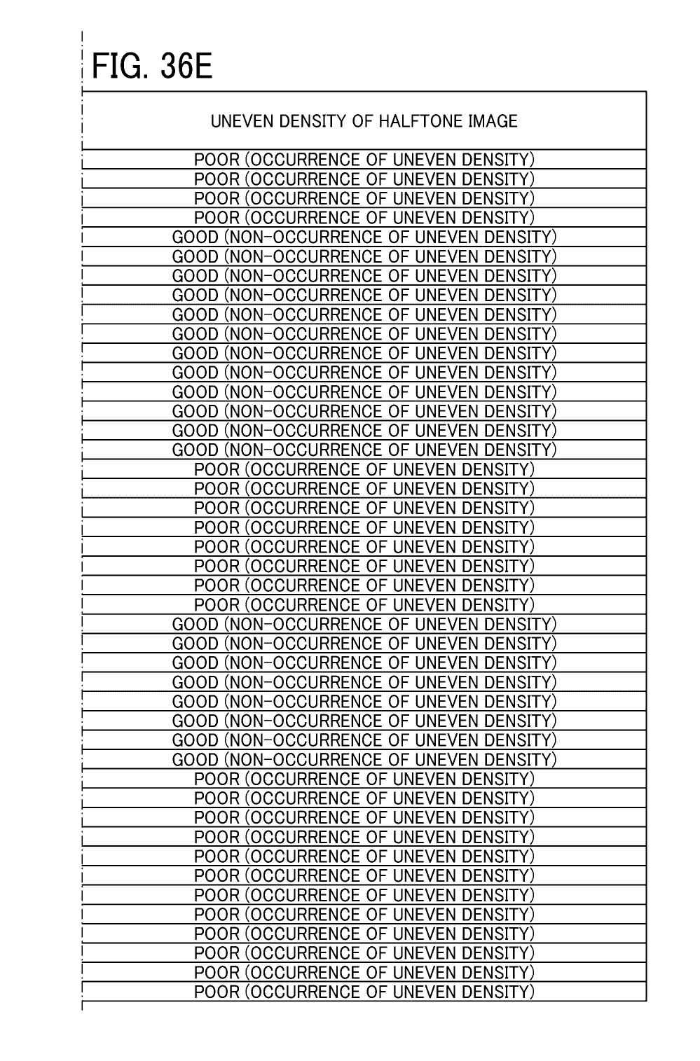

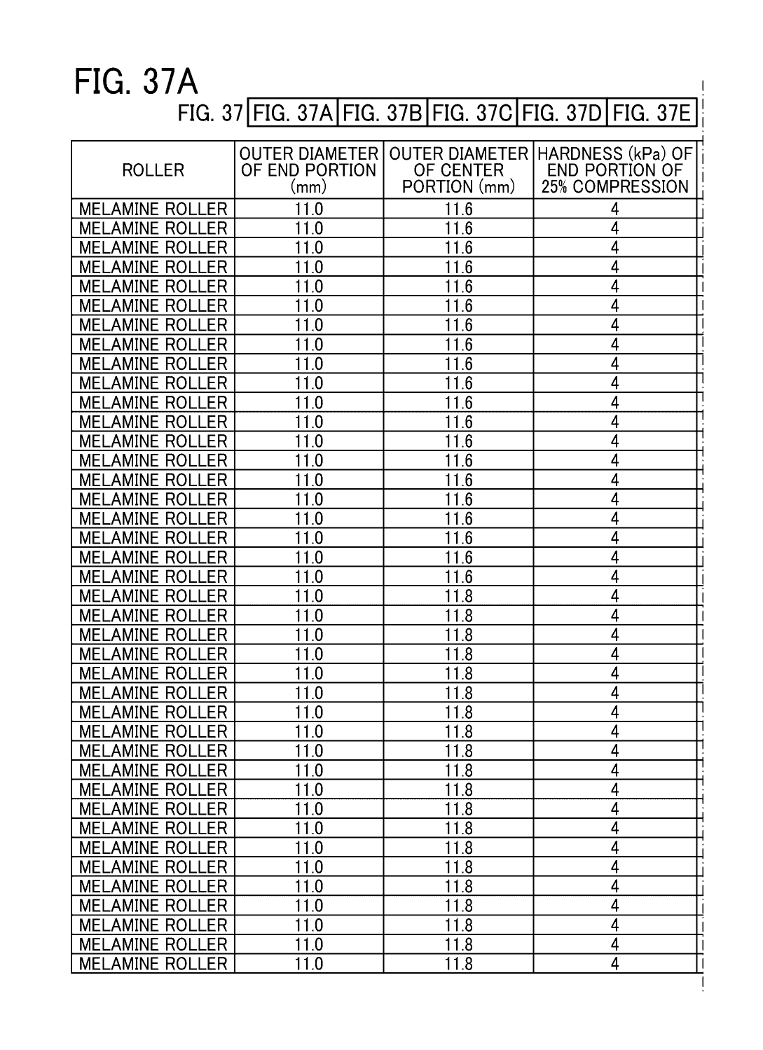

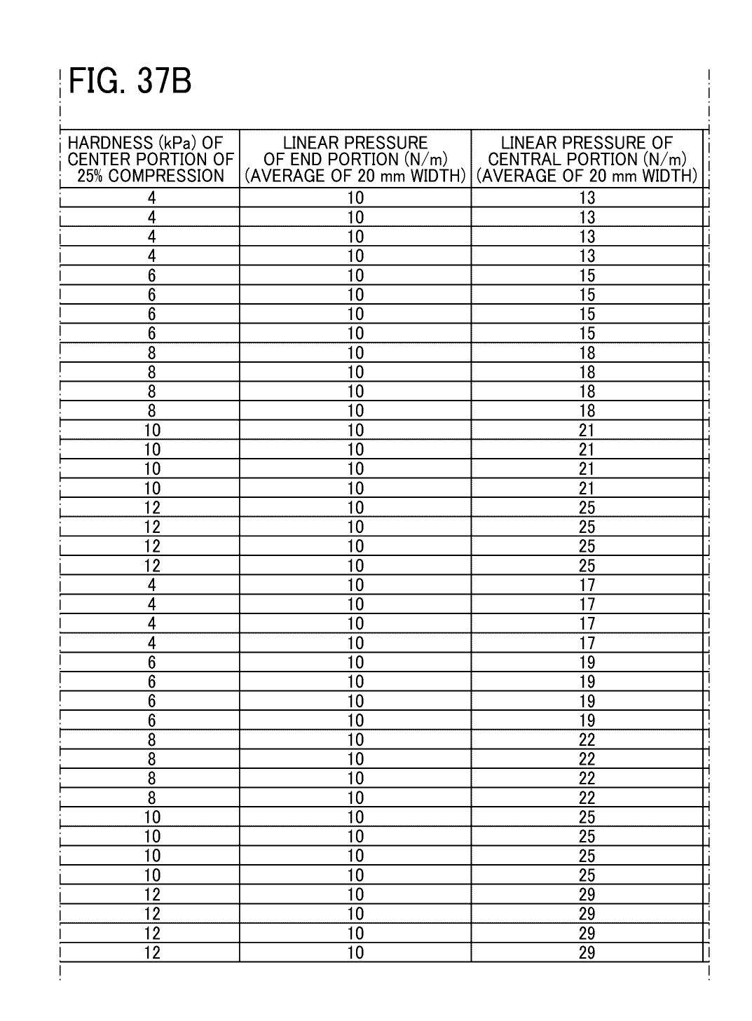

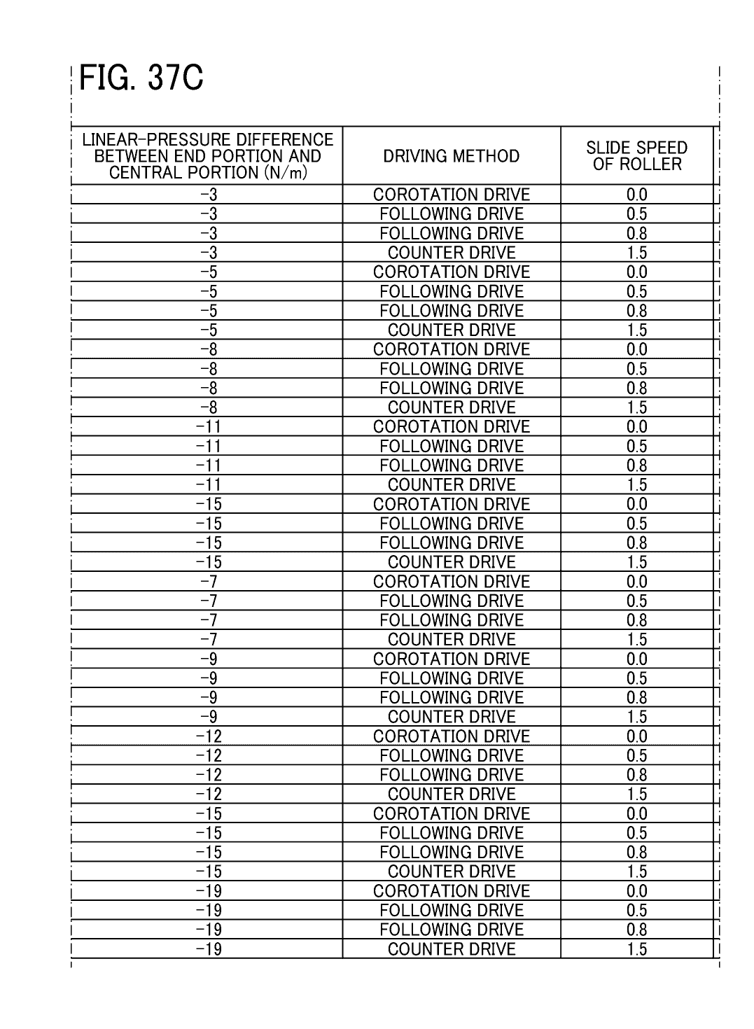

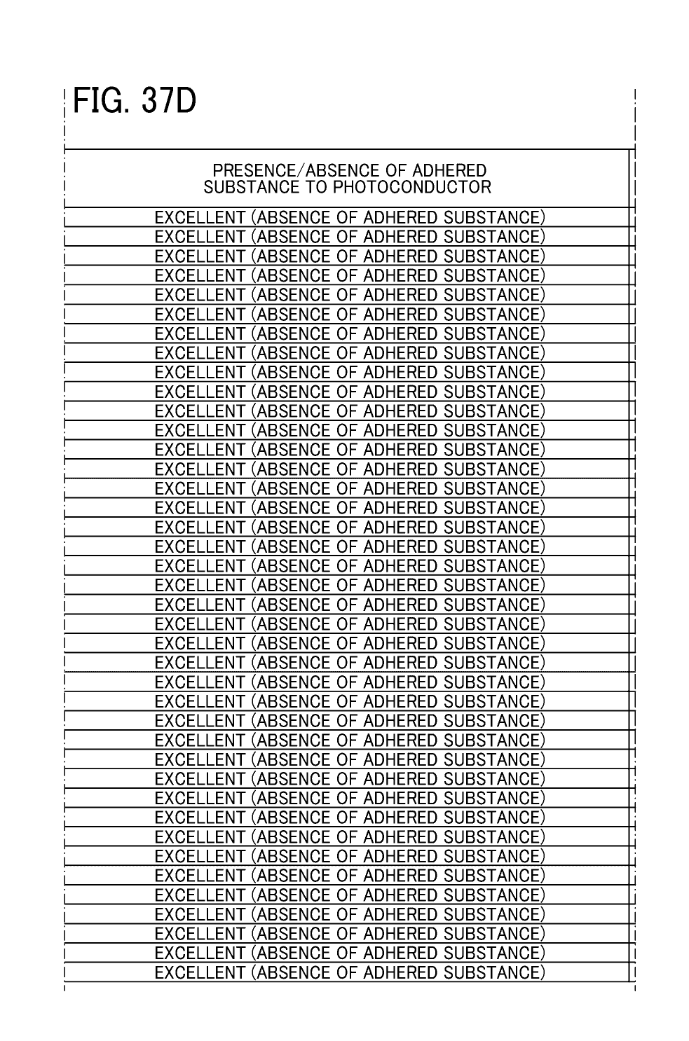

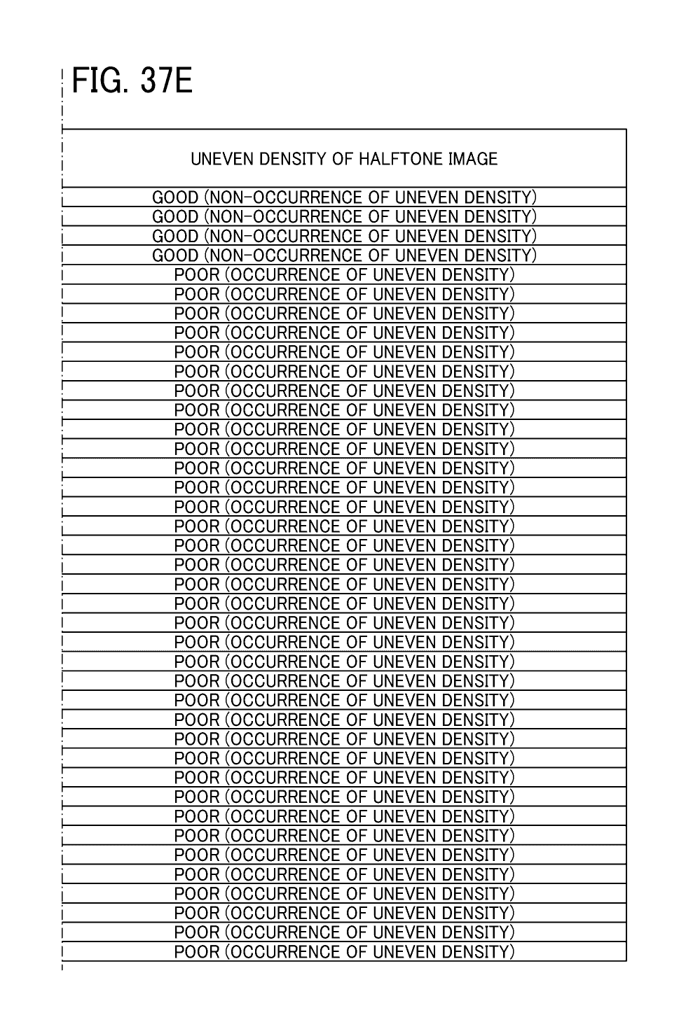

Next, the verification test of FIGS. 36 and 37 and the verification test result thereof will be described. The verification test and the verification test result are the verification test and the verification test result thereof, performed to verify the foreign substance removing effect of the melamine roller 82 and the effect of preventing the unevenness of image density with the lapse of time when an outer diameter difference was provided between the center and the ends and the hardness at was changed at the ends and the center.

The verification test result is an evaluation result of the occurrence of the photoconductor adhered substance and the unevenness of image density when the outer diameter at the center of the melamine roller 82, the hardness at the center of the melamine roller 82, and the sliding speed were changed. Here, the verification test of which the verification test result is illustrated in FIGS. 36 and 37 was performed under the same conditions as the verification test of which the verification test result is illustrated in FIG. 35 except for additional conditions, and the same evaluation was performed. From the verification test result of FIGS. 36 and 37, it was possible to confirm that the following effects can be obtained. Even when an outer diameter difference is provided between the ends and the center and the hardness is changed between the ends and the center, when the outer diameter difference and the hardness difference are set to appropriate values, the linear contact pressure between the ends and the center is 3 N/m or smaller. Due to this, it is possible to reduce (prevent) the occurrence of unevenness of image density between the ends and the center resulting from the unevenness of photoconductor wearing.

Moreover, in this example, as illustrated in FIG. 32, the melamine roller 82 is disposed on the upstream side of the charger and on the downstream side of the cleaning blade 5 in relation to the direction of rotation of the photoconductor 10. Due to this, by the same effect as Example 8, a stable sliding and scraping effect of the melamine roller 82 is obtained, and in a high-density image forming mode and in a high-temperature environment in which the ability of foreign substances to adhere to the photoconductor 10 increases, it is possible to prevent foreign substances from adhering to and accumulating on the photoconductor 10. Moreover, it is possible to prevent the occurrence of an abnormal image such as white spots.

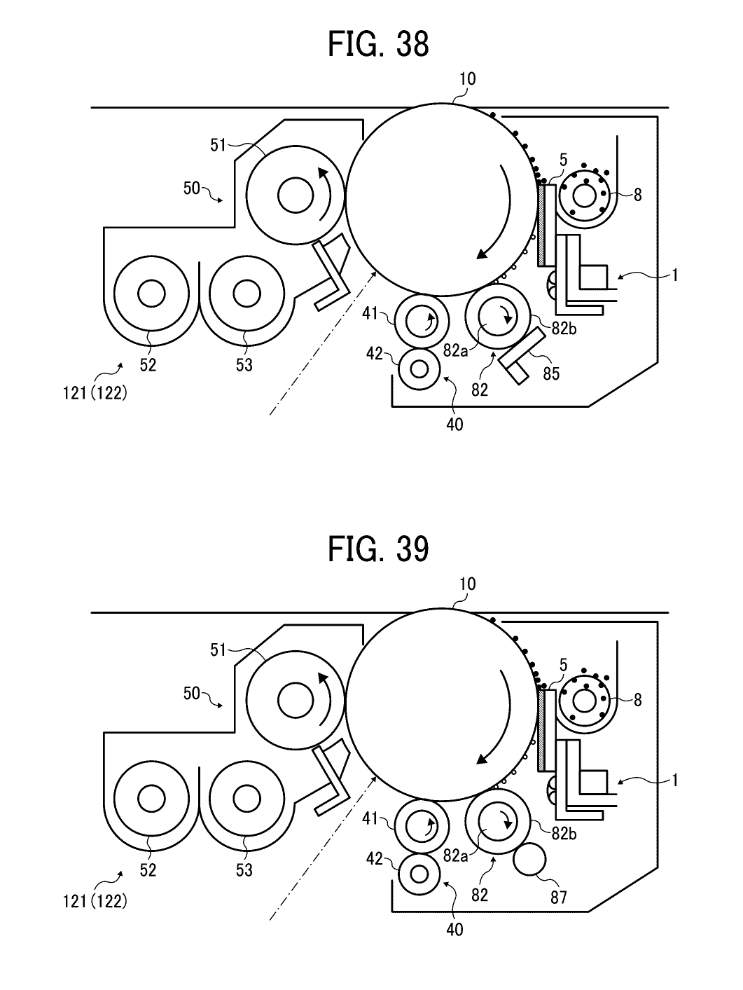

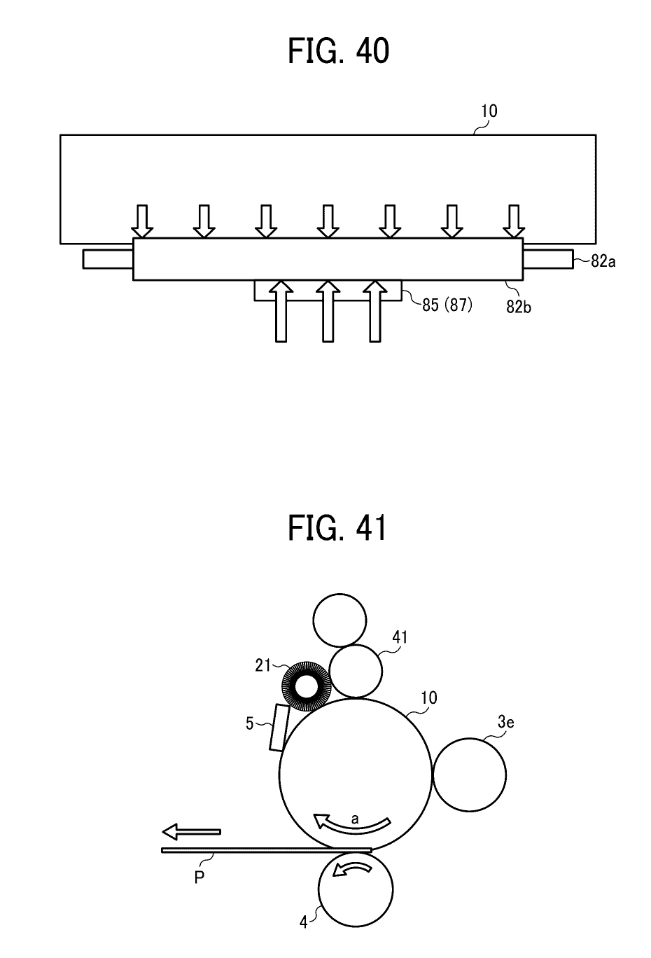

In order to reduce the contact pressure variation between the ends and the center resulting from bending of the center of the melamine roller 82 when the melamine roller 82 which is a roller is pressed against the photoconductor 10, the following configuration is used as a configuration (method) of maintaining the contact pressure uniformly. As illustrated in FIG. 38, a buck-up support 85 formed of a metal plate is disposed on the opposite side from the contact portion between the melamine roller 82 and the photoconductor 10 in the circumferential direction of the melamine roller. Moreover, a back-up roller 87 as illustrated in FIG. 39 instead of the metal plate illustrated in FIG. 38 may be used as the buck-up support. Further, there is no difference in the obtained effect even when the buck-up support 85 (the back-up roller 87) is disposed only at the center of the melamine roller 82 as illustrated in FIG. 40 rather than in the entire width in the longitudinal direction of the melamine roller 82.

Here, the image forming unit 121 of Examples 1 to 9 includes the photoconductor 10 which is an image forming portion and the process cartridge 122 in which the developing device 50, the charging device 40, and the photoconductor cleaning device 1 are integrated. Since the respective image forming portions are integrated, the setting and maintenance properties are improved. Further, the positioning accuracy in relation to the photoconductor, of rollers such as the developing roller 51 which is a developing unit, the charging roller 41 which is a charger, the cleaning blade 5 which is a cleaner, or the polishing roller 2 is improved. Moreover, the process cartridge 122 of Examples 1 to 9 includes at least the charging roller 41 that charges the photoconductor 10 and the photoconductor cleaning device 1 that removes the adhered substances on the surface of the photoconductor 10 and is detachably attached to the printer 100. When the photoconductor cleaning device 1 of Examples 1 to 9 is included (used) in the process cartridge 122, it is possible to provide the process cartridge 122 capable of providing the same effects as the photoconductor cleaning device 1 of Examples 1 to 9.

Moreover, in the printer 100 of the present embodiment, the image forming unit 121 that form a toner image on the photoconductor 10 includes the photoconductor 10 and the process cartridge 122 that includes at least one of the charging device 40, the developing device 50, and the photoconductor cleaning device 1. Due to this, it is possible to provide the printer 100 in which a plurality of image forming portions is integrated and which provides satisfactory setting and maintenance properties. Further, since these components are integrated with the photoconductor 10, the positioning accuracy in relation to the photoconductor 10, of the developing roller 51 as an integrated developing unit, the charging roller 41 as a charger, and a cleaner such as the cleaning blade 5, the polishing roller 2, or the melamine roller 82 is improved.

Moreover, in the printer 100 of the present embodiment, the photoconductor 10 and any one of the photoconductor cleaning devices 1 described in Examples 1 to 9 are included in the image forming unit 121. That is, any one of the photoconductor cleaning devices 1 described in Examples 1 to 9 is included (used) in the printer 100 which includes at least the charging roller 41 that charges the photoconductor 10 and a photoconductor cleaning device that removes adhered substances on the surface of the photoconductor 10 and which finally transfers an image formed on the photoconductor 10 to a sheet. Due to this, the printer 100 of the present embodiment can provide the same effects as any one of the photoconductor cleaning devices 1 of Examples 1 to 9.

While the present embodiment has been described with reference to the drawings, the specific configuration is not limited to the configuration of the printer 100 and the photoconductor cleaning device 1 of the present embodiment, but changes or the like can be made in design without departing from the spirit of the present disclosure. For example, the printer may be modified to an image forming apparatus having only one image forming unit and an image forming apparatus in which the image forming unit has a different configuration.

<Configuration Example of Removing Toner Aggregates According to Embodiment>

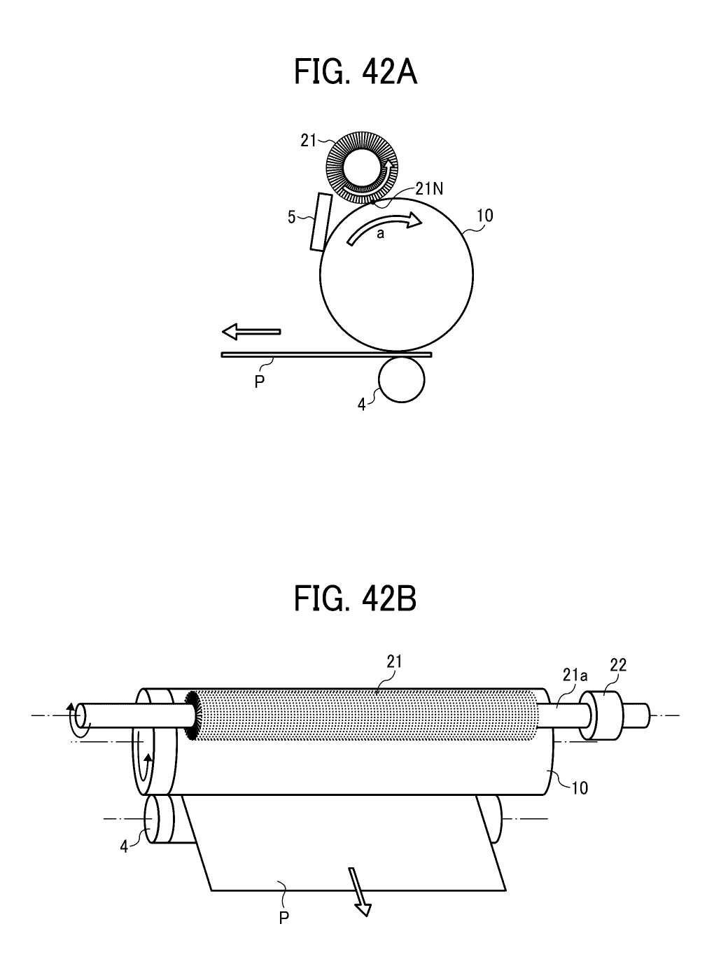

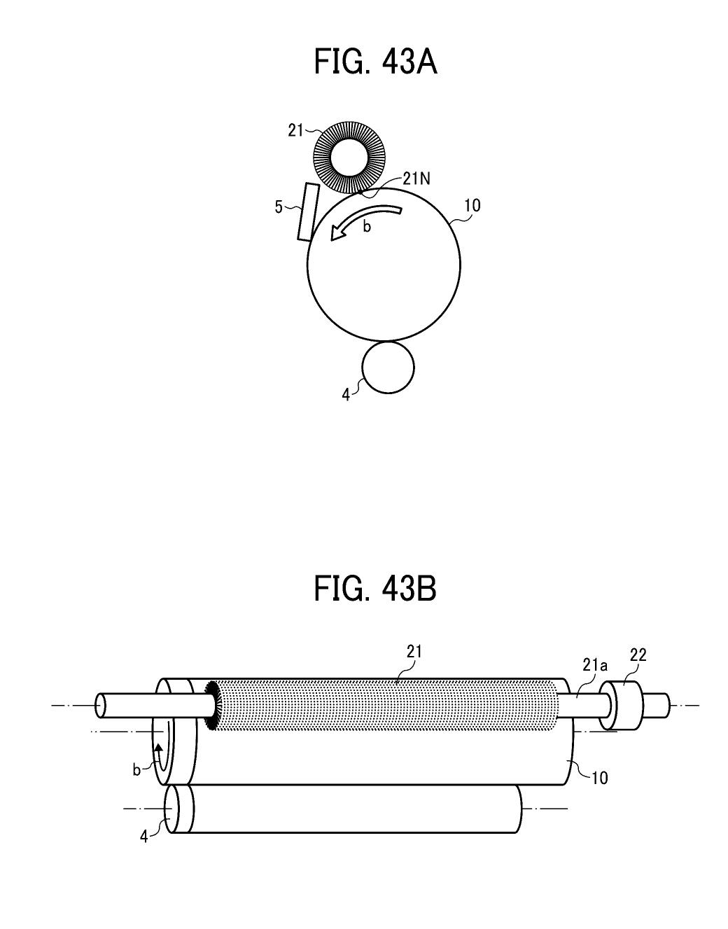

Next, a configuration example for removing toner aggregates will be described with reference to FIG. 41 to FIGS. 48A and 48B. FIG. 41 is an enlarged schematic front view of a portion near the drum-shaped photoconductor 10. FIG. 42A is a schematic front view illustrating a configuration of a drive assembly of a polisher (shoal-shaped toner removing roller) according to an embodiment and an operation during forward rotation of a photoconductor and FIG. 42B is a perspective view seen from the downstream side in a conveyance direction. FIG. 43A is a schematic front view illustrating a configuration of a drive assembly of the polisher according to the embodiment and an operation during reverse rotation of a photoconductor and FIG. 43B is a perspective view seen from the downstream side in a conveyance direction. In FIGS. 42B and 43B, the cleaning blade 5 is not depicted for better understanding.

In FIG. 41, in an image forming mode, the photoconductor 10 rotates in the direction of rotation indicated by arrow a and conveys a transfer sheet P by pinching the same between the photoconductor 10 and a transfer roller 4. A shoal-shaped toner removing roller (polisher) 21 is a toner aggregate remover that removes “shoal-shaped toner aggregate” (that is so-called “shoal-shaped toner”) formed of toner aggregate containing silica as nucleus. The shoal-shaped toner removing roller (polisher) 21 is disposed on the downstream side of the cleaning blade 5 and the upstream side of the charging roller 41 to make contact with the surface of the photoconductor. A characteristic configuration of the present disclosure is that a photoconductor linear velocity ratio of the shoal-shaped toner removing roller is changed between an image forming mode and a non-image forming mode. Specifically, in the image forming mode, since the shoal-shaped toner removing roller is rotated following the photoconductor (image bearer), a toner aggregate removing function is not performed and wearing of the photoconductor does not occur. In contrast, in the non-image forming mode, since the shoal-shaped toner removing roller stops rotating or rotates (in a reverse rotation) without following the photoconductor, the toner aggregate removing function can be enhanced.

In a drive assembly of the shoal-shaped toner removing roller 21 illustrated in FIGS. 42A, 42B, 43A, and 43B, the function of an one-way clutch is provided to one bearing 27 of the bearings that support both lateral ends of a shaft 21a of the shoal-shaped toner removing roller 21. In this configuration, by the function of the one-way clutch, the shaft 21a and the shoal-shaped toner removing roller 21 integrated with the shaft 21a can rotate following (rotate with) the photoconductor 10 when the photoconductor 10 rotates in the forward direction which is the direction of rotation in the image forming mode. Moreover, when the photoconductor rotates in the reverse direction, the shaft 21a and the shoal-shaped toner removing roller 21 cannot rotate and a strong sliding force is generated between the shoal-shaped toner removing roller and the photoconductor 10. That is, FIGS. 42A and 42B illustrate the state in the image forming mode, in which the photoconductor 10 makes forward rotation in the direction as indicated by arrow a. In this case, the shoal-shaped toner removing roller 21 (the shaft 21a) makes idle rotation by the effect of the one-way clutch and is rotated (in the direction in which the one-way clutch can rotate) by the friction force with the photoconductor 10. In this case, since no sliding force acts on the nip 21N between the shoal-shaped toner removing roller 21 and the photoconductor 10, the toner aggregate removing function is not performed and thus, wearing of the photoconductor does not occur.

On the other hand, FIGS. 43A and 43B illustrate the state when the photoconductor rotates in the reverse direction. In this configuration example, the cleaning blade 5 that slides on the surface of the photoconductor to remove residual toner is provided, and control is performed to rotate the photoconductor in the reverse direction b in order to remove paper dust or the like entering between the cleaning blade and the photoconductor surface. During reverse rotation of the photoconductor, although rotating force acts on the shoal-shaped toner removing roller 21 (the shaft 21a) in a direction (the clockwise direction) of following the photoconductor 10, since the rotation is hampered by the one-way clutch function of the bearing 27, desired sliding force acts on the nip 21N between the shoal-shaped toner removing roller 21 and the photoconductor 10 and the toner aggregate removing function is performed. In this example, the photoconductor linear velocity is set to 180 mm/sec and the linear velocity difference is set to 180 mm/sec.

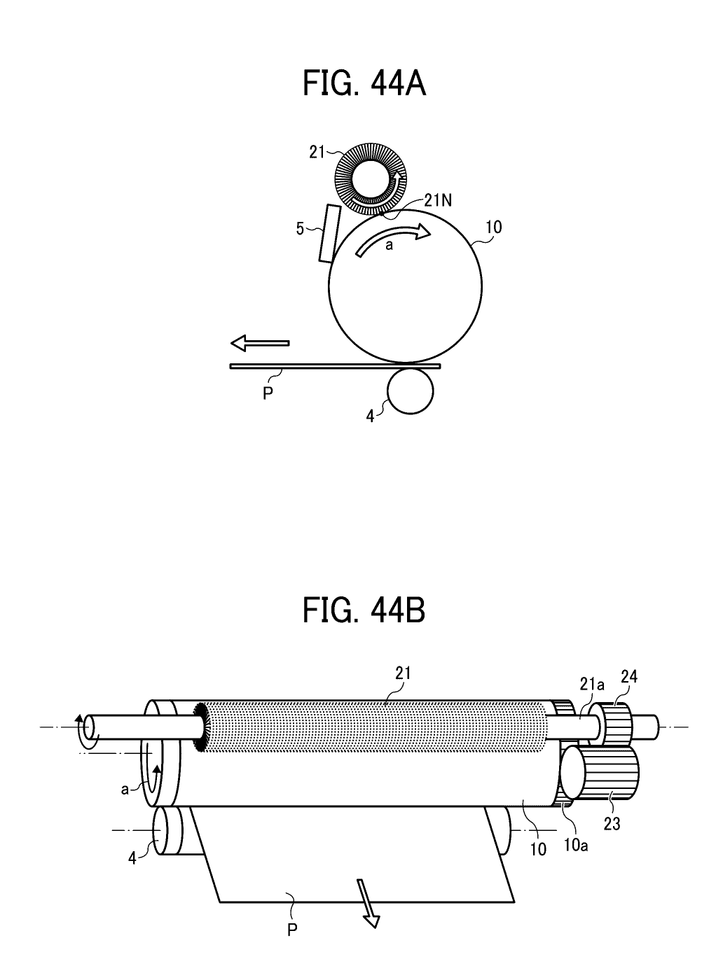

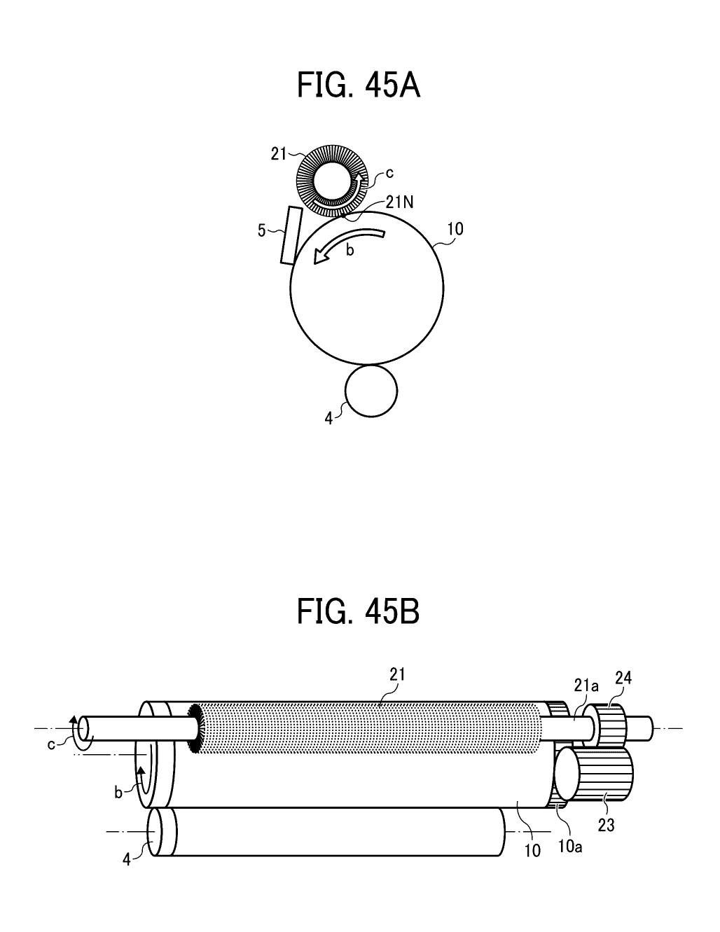

FIG. 44A is a schematic front view illustrating a configuration of a drive assembly of a polisher according to another embodiment and an operation during forward rotation of a photoconductor and FIG. 44B is a perspective view seen from the downstream side in a conveyance direction. FIG. 45A is a schematic front view illustrating a configuration of a drive assembly of a polisher according to the embodiment and an operation during reverse rotation of a photoconductor and FIG. 45B is a perspective view seen from the downstream side in a conveyance direction.

In FIGS. 44A, 44B, 45A, and 45B, the shoal-shaped toner removing roller 21 is connected to the photoconductor via a gear 24 having a one-way clutch therein, an idler gear 23, and a photoconductor gear 1a provided on the same shaft as the photoconductor. The rotating force of the photoconductor 10 driven by a motor is transmitted to the shoal-shaped toner removing roller 21 via the photoconductor gear 1a, the idler gear 23, and the gear 24 (one-way clutch). Since the gear 24 of which the shaft is supported by the shaft 21a of the shoal-shaped toner removing roller 21 has the one-way clutch, the rotating force in one direction only is transmitted to the shoal-shaped toner removing roller 21 (the shaft 21a) and transmission of rotating force in the other direction is blocked.

FIGS. 44A and 44B illustrate the state in the image forming mode. In the image forming mode, similarly to the embodiment illustrated in FIGS. 42A and 42B, the photoconductor 10 makes forward rotation in the direction indicated by arrow a. In this case, the shoal-shaped toner removing roller 21 makes idle rotation by the effect of the one-way clutch and is rotated (in the direction in which the one-way clutch can rotate) by the friction force with the photoconductor. In this case, since no sliding force acts on the nip 21N between the shoal-shaped toner removing roller 21 and the photoconductor 10, the shoal-shaped toner removing function is not performed and thus, wearing of the photoconductor does not occur.

FIGS. 45A and 45B illustrate the state during reverse rotation of the photoconductor in the non-image forming mode. Similarly to the embodiment illustrated in FIGS. 43A and 43B, although rotating force acts on the shoal-shaped toner removing roller 21 in a direction of rotating following the photoconductor, by the action of the gear 24 connected via the one-way clutch, rotating force in a reverse direction c opposite to the following rotation is obtained from the photoconductor (the photoconductor gear 1a). In this case, since the photoconductor 10 and the shoal-shaped toner removing roller 21 rotate in opposite directions (counter directions) with a large linear velocity difference, large sliding force acts on the nip 21N. In this example, since the linear velocity of the shoal-shaped toner removing roller is 250 mm/sec, the linear velocity difference is 430 mm/sec.

In this configuration example, a period in which the photoconductor is rotated in a reverse direction is controlled to be equal to or larger than on circumferential length of the photoconductor so that the entire circumferential surface of the photoconductor is slid and grounded by the shoal-shaped toner removing roller (so that shoal-shaped toner is removed). In this configuration, since the outer diameter (φ) of the photoconductor is 30 mm and the circumferential length is approximately 94 mm, a reverse rotation operation is performed for approximately 2 sec. In this way, a removing operation can be performed on the entire circumferential length of the photoconductor and a shoal-shaped toner (toner aggregate) removal leakage does not occur.

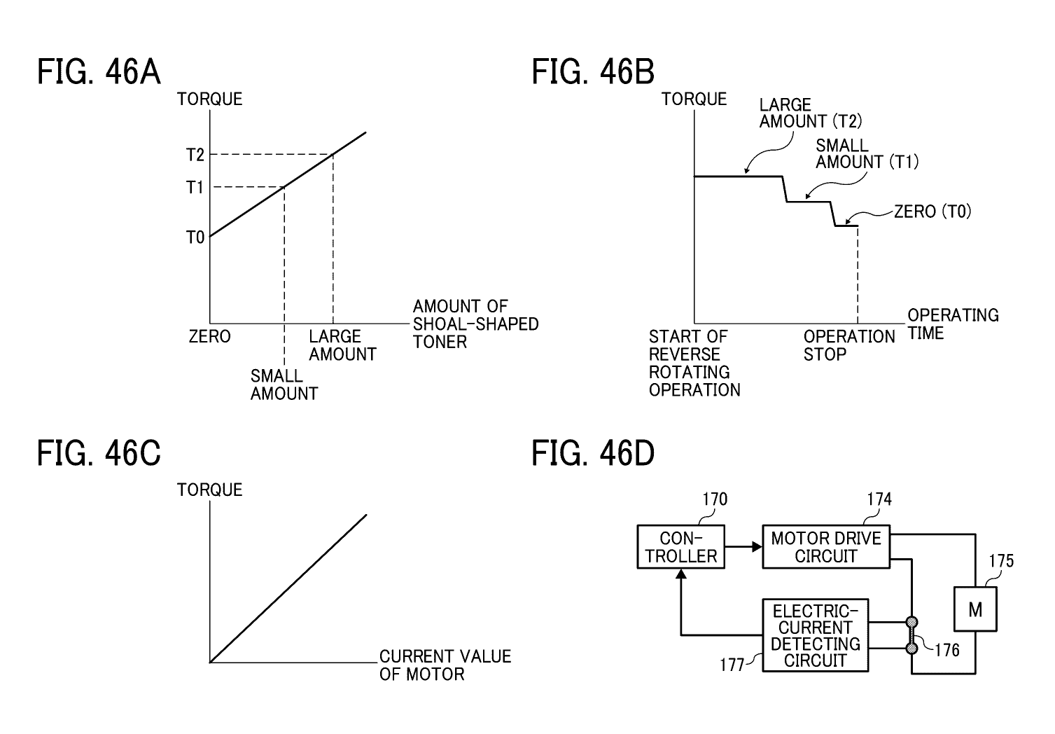

FIGS. 46A to 46D illustrate the relation between the amount of shoal-shaped toner aggregates (shoal-shaped toner) formed on the photoconductor surface and the torque value during reverse rotation of the photoconductor, and both values are correlated. That is, when the adhesion amount of shoal-shaped toner aggregates (toner aggregates) is large, since the resistance on the shoal-shaped toner removing roller that removes the toner aggregates increases, and the increase in the resistance on rotation of the shoal-shaped toner removing roller results in an increase in the resistance on rotation of the photoconductor, the torque during reverse rotation of the photoconductor increases. Thus, it is possible to understand the adhesion amount of shoal-shaped toner aggregates from an increase and decrease in the torque value during reverse rotation of the photoconductor accurately.

In the present embodiment, the torque value of the photoconductor during reverse rotation is detected, and reverse rotation is continued (FIG. 46B) until the torque value changes from the torque T2 when the adhesion amount of shoal-shaped toner aggregates is large to the torque T1 when the amount of shoal-shaped toner stain is small and then reaches the torque T0 when shoal-shaped toner aggregates are not present. In this way, it is possible to reliably remove shoal-shaped toner aggregates. The torque value of the photoconductor can be detected from a current value of a photoconductor drive motor. As illustrated in FIG. 46C, the motor current value and the torque value are correlated. In this configuration, as illustrated in FIG. 46D, an electric current detecting circuit 177 for detecting a current value flowing into a motor 175 is provided, and a controller 170 calculates a torque value of the photoconductor from the current value detected by the electric current detecting circuit 177 to control the reverse rotation time. A resistor 176 is inserted in an energization circuit that drives the motor 175 with the aid of the motor drive circuit 174 in series to the motor 175, and the electric current detecting circuit 177 detects a motor current based on a voltage across both ends of the resistor 176, converts the current to a digital value, and inputs the digital value to the controller 170. The resistor 176 and the electric current detecting circuit 177 form an electric current detector. The electric current detecting circuit 177 may also function as the controller 170.

<Configuration Example of Removing Toner Aggregates According to another Embodiment>

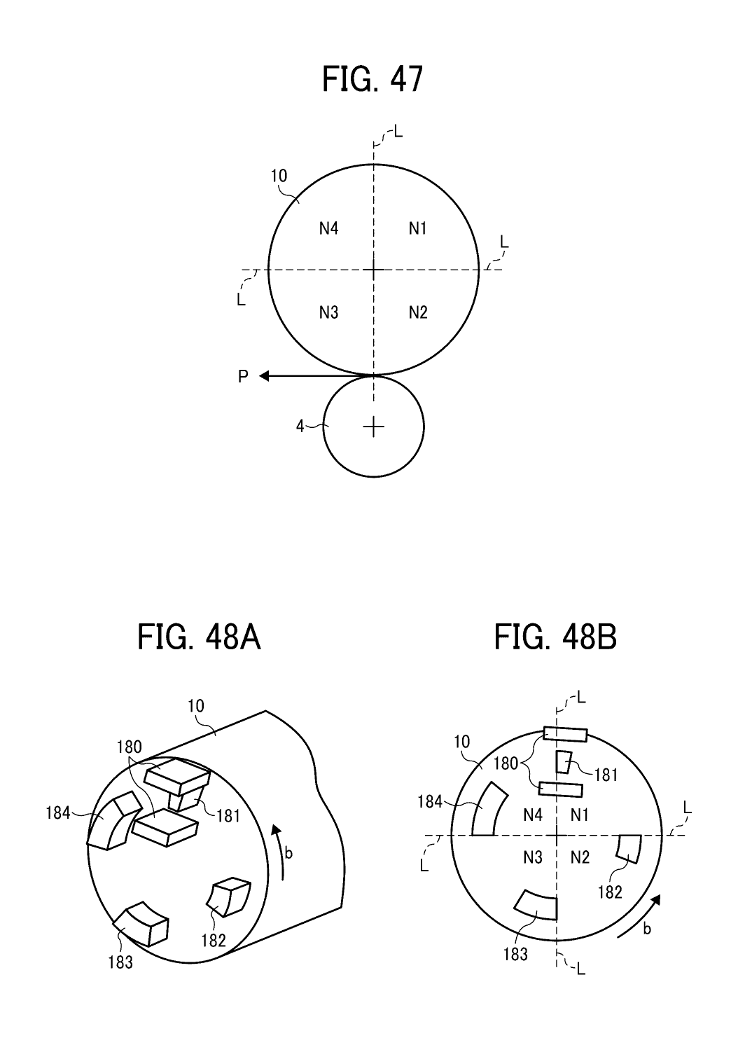

FIG. 47 illustrates a configuration example according to another embodiment of the present disclosure, in which the outer circumference of a photoconductor is evenly divided into four segments N1 to N4 in the circumferential direction. A circumferential position (rotation angle=rotational position) of the photoconductor is detected, and one circumference of the photoconductor is slid by four reverse rotation operations each by 90°. In this way, it is possible to shorten each reverse rotation time and to shorten the down time. FIGS. 48A and 48B are a perspective view and a front view illustrating a configuration example for detecting the rotational position of the photoconductor.

The circumferential position of the photoconductor is detected in the following manner. For example, as illustrated in FIGS. 48A and 48B, four feelers 181, 182, 183, and 184 having different lengths (circumferential lengths) are disposed on an end face of the photoconductor, a photointerrupter 180 is provided on the apparatus body side (fixed side), and the position is detected based on a difference in time at which each feeler passes through the photointerrupter 180. That is, the feelers 181, 182, 183, and 184 each are disposed at positions in the four segments N1 to N4 illustrated in FIG. 47, corresponding to the boundary lines L on the downstream side in the reverse direction so that the positions can be detected by the photointerrupter 180 provided on the fixed side. The photointerrupter 180, the feelers 181, 182, 183, and 184, and the controller form a circumferential position detector of the image bearer.

In this configuration example, in one reverse rotation operation, reverse rotation is performed only in a period (rotation angle) elapsed from detection of one feeler to detection of the next feeler. This reverse rotation operation is intermittently performed four times whereby a toner aggregate removal operation on the entire circumferential length of the photoconductor is completed. That is, for example, the rotation of the photoconductor 10 is stopped until the photointerrupter 180 detects one feeler 181 in the present reverse rotation. After that, the toner aggregate removal operation starts with reverse rotation. The first toner aggregate removal operation is performed in an angular range of 45°. This operation is repeated four times. The controller 170 stores the data related to the history of detection of each feeler and resets the history after all feelers 181, 182, 183, and 184 are detected.

By using the circumferential position detector of the image bearer, the shoal-shaped toner removing roller (polisher) 21 can polish one circumference of the image bearer by a number of reverse rotation operations corresponding to A/B. Here, A is the circumferential length of the image bearer and B is the moving distance (rotation distance) of the surface of the image bearer during reverse rotation of the image bearer. According to this configuration, it is possible to prevent a decrease in the print speed by decreasing one reverse rotation operation time and to slide (polish) on the surface corresponding to one circumference of the image bearer with several reverse rotation operations. In this embodiment, although the image bearer is partitioned into four segments at an angle of 45° in the circumferential direction, this is an example only, and the rotation distance B may be set arbitrarily.

Next, an example of a specific toner aggregate removing process will be described based on FIGS. 48A and 48B. For example, a case in which a series of image forming operations ends, the photoconductor stops, and the photointerrupter 180 is positioned between the feeler 184 and the feeler 181 will be described as an example. When the photoconductor starts reverse rotation to remove foreign substances pushed between the cleaning blade 5 and the photoconductor in this state, reverse rotation is performed until the feeler 181 is detected firstly. Subsequently, the photoconductor starts reverse rotation using the state in which the photointerrupter 180 detects the feeler 181 as a start position, and the reverse rotation is performed until the photointerrupter 180 detects the feeler 182 firstly. With this reverse rotation operation, shoal-shaped toner in the segment N1 is removed.

After that, the photoconductor is rotated in the forward direction to resume an image forming operation, and a toner aggregate removal operation is performed on the next segment N4 after a predetermined image forming operation ends. That is, the photoconductor is rotated in the reverse direction and is stopped when the feeler 184 is detected firstly. Reverse rotation is started in a state in which the photointerrupter has detected the feeler 184, and the reverse rotation is stopped when the feeler 181 is detected firstly. In this way, the toner aggregate removal operation on the segment N4 is completed. After that, when photoconductor is rotated in the forward direction to resume the image forming operation, and a toner aggregate removal operation on the next segment N3 is performed after a predetermined image forming operation ends. That is, the photoconductor is rotated in the reverse direction and is stopped when the feeler 183 is detected firstly. Reverse rotation is started in a state in which the photointerrupter has detected the feeler 183, and the reverse rotation is stopped when the feeler 184 is detected firstly. In this way, the toner aggregate removal operation on the segment N3 is completed. After that, when photoconductor is rotated in the forward direction to resume the image forming operation, and a toner aggregate removal operation on the next segment N2 is performed after a predetermined image forming operation ends. That is, the photoconductor is rotated in the reverse direction and is stopped when the feeler 182 is detected firstly. Reverse rotation is started in a state in which the photointerrupter has detected the feeler 182, and the reverse rotation is stopped when the feeler 183 is detected firstly. In this way, the toner aggregate removal operation on the segment N2 is completed.

With the above-described operations, the toner aggregate removing operation on all the four segments N1 to N4 ends, and the controller resets the history. The specific example is an example only and a feeler that the photointerrupter detects firstly when the toner aggregate removal operation on the four segments starts may be a feeler that is detected firstly when the reverse rotation operation starts. That is, the feeler that is detected when the reverse rotation starts is not always the feeler 181. After that, the toner aggregate removing operation on the next segment is performed based on an adjacent feeler (in the above example, the feeler 184) closet to the feeler that is detected firstly after the reverse rotation starts. A reverse rotation operation of approximately one rotation may be required depending on the stop position of the photoconductor.

<Configuration Example of Toner Aggregate Removing Roller (Polisher)>

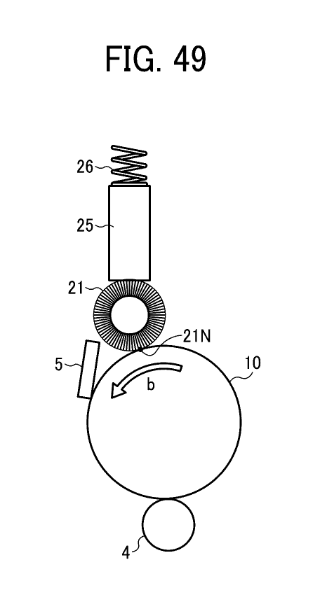

In this example, a foamed urethane roller (foamed polishing roller), for example, may be used as the shoal-shaped toner removing roller 21. Since the urethane roller has a small permanent compressive strain, the urethane roller is an optimal material in a configuration in which the roller always makes contact with the photoconductor. Although the outer diameter (φ) is 10 mm, the Asker-C hardness is 30°, the cell diameter is 450 μm, and the drum pushing depth is 0.3 mm, these characteristic values can be set to optimal values depending on the toner aggregate removing function. As illustrated in FIG. 49, an alumina block 25 as a polishing agent may be elastically pressed against the surface of a shoal-shaped toner removing roller (foamed polishing roller) with the aid of a biasing unit 26 such as a spring, and the shoal-shaped toner removing roller may scrape alumina powder (an alumina resin as a polishing agent) so that the surface of the shoal-shaped toner removing roller is coated with the alumina powder. In this way, it is possible to improve the toner aggregate removing performance during reverse rotation. Since sliding force does not act during forward rotation, the presence of alumina powder has no influence on the forward rotation.

That is, in this example, when an alumina resin as a polishing agent is attached to the surface of the urethane roller as a foamed polishing roller, it is possible to improve the polishing function. Moreover, a foamed melamine roller (foamed polishing roller) may be used as the shoal-shaped toner removing roller (polisher) 21. Although melamine has high hardness and provides an excellent toner aggregate removing function, the pushing depth is set to 0.05 mm in this example since melamine is disadvantageous to wearing. When a foamed melamine roller is used as the shoal-shaped toner removing roller (polisher) 21, it is possible to improve the polishing function.

The examples and embodiments described above are examples only, and the following aspects provide unique effects.

Aspect A

A photoconductor cleaning device (for example, the photoconductor cleaning device 1) in which a roller (for example, the polishing roller 2) and a cleaner (for example, the cleaning blade 5) are disposed in contact with a photoconductor (for example, the photoconductor 10) to remove adhered substances (for example, residual toner and external additives) on a surface of the surface of the photoconductor, in which the roller is disposed between the cleaner and a charger (for example, the charging roller 41) that charges the photoconductor.

According to this aspect, as described in the present embodiment, the following effects can be obtained. In the conventional photoconductor cleaning device in which the cleaner is disposed between the roller and the charger that charges the photoconductor, since the roller is disposed on the upstream side in the direction of rotation of the photoconductor, of the cleaner, the amount of toner supplied to the roller is different depending on an image to be formed. In a high-density image forming mode, an excessively large amount of toner is supplied to the roller, the contact area with the photoconductor decreases, and the photoconductor sliding action of the roller weakens. When high-density images are to be formed continuously, the photoconductor sliding and removing performance (foreign substance removing performance) of the roller becomes insufficient. Moreover, the amount of toner supplied to the roller according to an image to be formed is different in a longitudinal direction (axial direction) of the roller, and the photoconductor sliding and removing performance of the roller may become insufficient depending on a difference in the thickness in the longitudinal direction of the toner. Further, in a high-temperature environment in which the ability of foreign substances to adhere to the photoconductor increases, it is difficult to completely remove foreign substances (adhered substance) adhered to the surface of the photoconductor due to the insufficient photoconductor sliding and removing performance. Moreover, the foreign substances on the surface of the photoconductor accumulate and grow and an abnormal image such as white spots occurs.

On the other hand, in the photoconductor cleaning device of this aspect, since the roller is disposed on the downstream side of the cleaner in relation to the direction of rotation of the photoconductor, it is possible to reduce the amount of residual toner supplied to the contact portion between the roller and the photoconductor. Due to this, it is possible to reduce a difference in the longitudinal direction in the thickness of the supplied toner while reducing a decrease or a variation in the contact area between the roller and the photoconductor. Moreover, since the foreign substance removing performance of the roller does not become insufficient but becomes stable, it is possible to remove foreign substances (adhered substances) on the photoconductor stably. Moreover, since the roller is disposed on the upstream side in the direction of rotation of the photoconductor, of the charger, it is possible to remove external additives such as silica on the surface of the photoconductor before the surface of the photoconductor is activated by the charging current and foreign substances easily adhere to the surface. Due to these reasons, it is possible to prevent foreign substances from adhering to the photoconductor and to reduce the occurrence of an abnormal image such as white spots resulting from the adhered foreign substances. Therefore, it is possible to provide the photoconductor cleaning device capable of reducing the occurrence of an abnormal image such as white spots resulting from the adhered foreign substances.

Aspect B

In Aspect A, spiral projections are formed on a shaft (for example, the metal core 2a) of the roller (for example, the polishing roller 2) using an elastic material (for example, the foamed urethane 2b). According to this aspect, as described in the present embodiment, the following effects can be obtained. In the conventional photoconductor cleaning device in which the roller (for example, a cleaning roller) is disposed, when a roller formed of a material having high hardness slides on the photoconductor in the axial-position fixed state, a variation in the pushing pressure on the photoconductor increases due to a variation in the outer diameter of the roller. Moreover, when the pushing depth is large, a photoconductor driving load increases and an abnormal image such as banding or jitter also occurs. On the other hand, when the pushing depth is small, a foreign substance removal defect occurs due to insufficient pressure. Moreover, when the photoconductor driving load is large, the sliding load may increase and the wearing of the photoconductor may be accelerated.

On the other hand, in the photoconductor cleaning device of this aspect, it is possible to improve the foreign substance removing performance by the scraping effect of the edge portions of the projections sliding on the surface of the photoconductor when the spiral projections formed of a foamed urethane rotate to make contact with and separate from the surface of the photoconductor. In this way, it is possible to reduce the pressure on the photoconductor, of the roller. Further, since the projections making contact with the photoconductor are formed (disposed) on the roller in a spiral form and the contact area with the photoconductor decreases, it is possible to reduce the pressure on the photoconductor, of the roller. Moreover, due to these pressure reducing effects, it is possible to reduce a variation in the pushing pressure on the photoconductor, of the roller and to prevent the occurrence of an abnormal image such as banding or jitter which may occur when the photoconductor driving load increases. Further, it is possible to prevent the occurrence of a foreign substance removal defect which may occur when the pressure is insufficient. Moreover, due to the effect of reducing the photoconductor driving load resulting from a reduction in the pressure when the roller makes contact with the photoconductor, it is possible to reduce the wearing of the photoconductor. Thus, it is possible to provide the photoconductor cleaning device capable of reducing the wearing of the photoconductor while reducing the occurrence of an abnormal image such as banding or jitter.

Aspect C

In Aspect A or B, the roller (for example, the polishing roller 2) slides on the surface of the photoconductor with a linear velocity difference from the surface of the photoconductor (for example, the photoconductor 10). According to this aspect, as described in the present embodiment, since the surface of the roller slides on the surface of the photoconductor with a linear velocity difference from the surface of the photoconductor, it is possible to effectively remove adhered substances on the surface of the photoconductor.

Aspect D

In any one of Aspects A to C, the roller (for example, the polishing roller 2) rotates in an opposite direction from the direction of rotation of the photoconductor at a contact portion between the photoconductor (for example, the photoconductor 10) and the roller. According to this aspect, as described in the present embodiment, the following effects can be obtained. Since the roller rotates in the opposite direction from the direction of rotation of the photoconductor at the contact portion, the linear velocity difference of the roller in relation to the surface of the photoconductor increases, the sliding effect of the roller sliding on the surface of the photoconductor increases, and the effect of removing adhered substances on the surface of the photoconductor is improved.

Aspect E

In any one of Aspects A to D, the elastic material is formed of a foamed material (for example, the foamed urethane 2b) having a cell structure formed of a number of fine holes. According to this aspect, as described in the present embodiment, the following effects can be obtained. Since the elastic material that forms spiral projections on the roller (for example, the polishing roller 2) (that is, spiral projections are disposed in a spiral form) has a cell structure having an enormously large number of fine holes, the edges of the fine holes effectively slide on the surface of the photoconductor. Thus, the effect of removing adhered substances on the surface of the photoconductor is improved.

Aspect F

In any one of Aspects A to E, an adhered substance removing performance (for example, a foreign substance removing performance) of the roller (for example, the polishing roller 2 or the melamine roller 82) is decreased with the elapse of time. According to this aspect, as described in the present embodiment, it is possible to set a foreign substance removing performance capable of preventing adhesion of toner, external additives, or the like on the flat surface of the photoconductor in an initial use state of the photoconductor (for example, the photoconductor 10) and to set a foreign substance removing performance capable of preventing acceleration of the wearing of the photoconductor in the time-elapsed state. Thus, it is possible to maintain the adhered substance removing performance of the roller appropriately with the elapse of time and to prevent acceleration of the wearing of the photoconductor resulting from an excessive adhered substance removing performance.

Aspect G

In any one of Aspects A to F, a sliding speed of a contact face of the roller (for example, the polishing roller 2) in relation to the surface of the photoconductor (for example, the photoconductor 10) is decreased with the elapse of time (for example, by decreasing the number of rotations per unit time of the roller). According to this aspect, as described in the present embodiment, it is possible to set the sliding speed of the contact face of the roller in relation to the surface of the photoconductor so that the foreign substance removing performance such as the foreign substance removing performance capable of preventing adhesion of toner, external additives, or the like on the flat surface of the photoconductor can be obtained in the initial use state of the photoconductor. Moreover, it is possible to set the sliding speed of the contact face of the roller in relation to the surface of the photoconductor so that acceleration of the wearing of the photoconductor resulting from an excessive adhered substance removing performance can be prevented in the time-elapsed state. Thus, it is possible to maintain the adhered substance removing performance of the roller appropriately with the elapse of time and to prevent acceleration of the wearing of the photoconductor resulting from an excessive adhered substance removing performance.

Aspect H

In any one of Aspects A to G, an outer diameter of the roller (for example, the melamine roller 82) decreases with the elapse of time. According to this aspect, as described in the present embodiment, the following effects can be obtained. When the contact pressure on the photoconductor (for example, the photoconductor 10) and the adhered substance removing performance such as the foreign substance removing performance are decreased, it is possible to obtain the adhered substance removing performance capable of preventing adhesion of toner, external additives, or the like on the surface of the photoconductor in the initial use state and to prevent acceleration of wearing of the photoconductor resulting from an excessive adhered substance removing performance in the time-elapsed state. Thus, it is possible to maintain the adhered substance removing performance of the roller appropriately with the elapse of time and to prevent acceleration of wearing of the photoconductor resulting from an excessive adhered substance removing performance.

Aspect I

A process cartridge (for example, the process cartridge 122) which includes a charger (for example, the charging roller 41) that charges a photoconductor (for example, the photoconductor 10) and a photoconductor cleaning device that removes adhered substances on a surface of the photoconductor, and which is detachably attached to an image forming apparatus (for example, the printer 100), in which the photoconductor cleaning device (for example, the photoconductor cleaning device 1) of any one of Aspects A to H is provided as the photoconductor cleaning device. According to this aspect, as described in the present embodiment, it is possible to provide a process cartridge capable of providing the same effects as the photoconductor cleaning device of any one of Aspects A to H.

Aspect J

An image forming apparatus (for example, the printer 100) which includes a charger (for example, the charging roller 41) that charges a photoconductor (for example, the photoconductor 10) and a photoconductor cleaning device that removes adhered substances on a surface of the photoconductor, and which finally transfers an image formed on the photoconductor to a recording medium (for example, a sheet), in which the photoconductor cleaning device (for example, the photoconductor cleaning device 1) of any one of Aspects A to H is provided as the photoconductor cleaning device. According to this aspect, as described in the present embodiment, it is possible to provide an image forming apparatus capable of providing the same effects as the photoconductor cleaning device of any one of Aspects A to H.

Aspect K

An image forming apparatus according to Aspect K including an image bearer (1) that bears a toner image on a surface thereof and rotates in forward and reverse directions, a polisher (21) that rotates to polish the surface of the image bearer to remove adhered toner aggregates, a transferor (4) that transfers the toner image on the surface of the image bearer to a transfer material, and a cleaner (5) that removes residual toner remaining on the image bearer after the transferring, in which in a configuration in which the image bearer is rotated in a reverse direction in a non-image forming mode in order to remove foreign substances (for example, paper dust) pushed between the cleaner and the drum, the polisher rotates following the image bearer during forward rotation of the image bearer and stops rotating or does not rotate following the image bearer during reverse rotation of the image bearer.

In Aspect K, a photoconductor linear velocity ratio of the polisher (21) is changed between the image forming mode and the non-image forming mode. That is, in the image forming mode in which the image bearer makes forward rotation, since the polisher (21) rotates following (rotates with) the image bearer (1), the toner aggregate removing function is not performed and wearing of the image bearer does not occur. In contrast, in the non-image forming mode in which the image bearer makes reverse rotation, since the polisher does rotate following (including stops rotating) the image bearer, it is possible to improve the toner aggregate removing function. That is, in the conventional configuration in which driving force of the polisher (the toner aggregate removing roller) is obtained from the image bearer, since the toner aggregate removing function is continuously performed in a period in which the image bearer operates, it is necessary to decrease the toner aggregate removing function by decreasing the linear velocity difference or decreasing the pushing depth so that the image bearer wears less.

In contrast, in Aspect K, when the linear velocity rate of the polisher (the toner aggregate removing roller) to the linear velocity of the image bearer is changed between the image forming mode and the non-image forming mode, since the toner aggregate removing function can be activated only during the reverse rotation of the image bearer, it is possible to enhance the toner aggregate removing function while reducing wearing of the image bearer. That is, in Aspect K, since the polisher (21) rotates following (rotates with) the image bearer in the image forming mode, the toner aggregate removing function is not performed and the wearing of the image bearer does not occur. In contrast, since the polisher does not rotate following the image bearer in the non-image forming mode, it is possible to enhance the toner aggregate removing function. That is, in the conventional configuration in which the driving force of the polisher is obtained from the image bearer, since the toner aggregate removing function is continuously performed in a period in which the image bearer operates, it is necessary to decrease the toner aggregate removing function by decreasing the linear velocity difference or decreasing the pushing depth so that the image bearer wears less. In Aspect K, since the toner aggregate removing function can be activated only during the reverse rotation of the image bearer, it is possible to enhance the toner aggregate removing function.

Aspect L

In the image forming apparatus of Aspect L, a reverse rotation operation of the image bearer is performed in a period corresponding to one circumferential length or more of the image bearer. According to this aspect, it is possible to remove toner aggregates on an entire circumferential surface of the image bearer.

Aspect M

In the image forming apparatus of Aspect M, the reverse rotation operation is performed until a torque value of the image bearer detected actually reaches a value corresponding to a state in which no toner aggregate is present based on the correlation between a torque value of the image bearer during reverse rotation, calculated in advance and the amount of toner aggregates on the surface of the image bearer. According to this aspect, it is possible to reliably remove the toner aggregates.

Aspect N

The image forming apparatus according to Aspect N includes a circumferential position detector (180 and 181 to 184) that detects a circumferential position of the image bearer, and the polisher polishes one circumference of the image bearer by a number of reverse rotation operations corresponding to A/B where A is a circumferential length of the image bearer and B is a moving distance of the surface of the image bearer. According to this aspect, it is possible to prevent a decrease in the print speed by decreasing one reverse rotation operation time and to slide (polish) on the surface corresponding to one circumference of the image bearer with several reverse rotation operations.

Aspect O

In the image forming apparatus according to Aspect O, the polisher rotates in one direction only with the aid of a bearing that includes a one-way clutch. When the bearing of the polisher includes the one-way clutch, it is possible to change the linear velocity difference with low costs.

Aspect P

The image forming apparatus according to Aspect P, the polisher (21) is geared to the image bearer via a one-way clutch, the polisher makes idle rotation during forward rotation of the image bearer, and the polisher is rotated during reverse rotation of the image bearer. According to this aspect, it is possible to set the linear velocity difference freely with low costs.

Aspect Q

In the image forming apparatus according to Aspect Q, the polisher (21) is a foamed polishing roller. According to this aspect, it is possible to enhance a polishing function and to provide advantages against wearing.

Aspect R

In the image forming apparatus according to Aspect R, an alumina resin as a polishing agent is attached to the surface of the foamed polishing roller. According to this aspect, it is possible to enhance the polishing function.

Aspect S

In the image forming apparatus according to Aspect S, the foamed polishing roller is formed of melamine. According to this aspect, it is possible to enhance the polishing function.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A photoconductor cleaning device comprising:
a photoconductor;
a cleaner disposed in contact with the photoconductor to remove adhered substances on a surface of the photoconductor, a charger to charge the photoconductor;
a roller disposed between the cleaner and the charger to remove adhered substances on the surface of the photoconductor.

2. The photoconductor cleaning device according to claim 1,
wherein the roller includes a foamed material having a cell structure with a plurality of fine holes.

3. The photoconductor cleaning device according to claim 2,
wherein
the roller is configured such that an outer diameter at a center in a longitudinal direction of the roller is larger than an outer diameter at an end in the longitudinal direction of the roller.

4. The photoconductor cleaning device according to claim 1,
wherein
an adhered substance removing performance of the roller is configured to decrease with an elapse of time.

5. The photoconductor cleaning device according to claim 1,
wherein a sliding speed of a contact face of the roller relative to the surface of the photoconductor is configured to decrease with an elapse of time.

6. The photoconductor cleaning device according to claim 1,
wherein an outer diameter of the roller is configured to decrease with an elapse of time.

7. The photoconductor cleaning device according to claim 1,
wherein the roller slides on the surface of the photoconductor with a linear velocity different from a linear velocity of the surface of the photoconductor.

8. The photoconductor cleaning device according to claim 1,
wherein the roller rotates in a direction opposite a direction of rotation of the photoconductor at a contact portion with the photoconductor.

9. The photoconductor cleaning device according to claim 1,
further comprising spiral projections on a shaft of the roller.

10. A process cartridge comprising the photoconductor cleaning device according to claim 1,
wherein the process cartridge is configured to be detachably attachable relative to an image forming apparatus.

11. An image forming apparatus comprising:
the photoconductor cleaning device according to claim 1; and
a transfer unit configured to transfer an image from the photoconductor onto a recording medium.

12. An image forming apparatus, comprising:
the photoconductor cleaning device according to claim 8; and
the photoconductor to bear a toner image on the surface of the photoconductor and rotate forward and in reverse; and
wherein the photoconductor rotates in reverse when image formation is not performed, and
the roller rotates following the photoconductor during forward rotation of the photoconductor and stops rotating or rotates in the direction opposite to the direction of rotation of the photoconductor during reverse rotation of the photoconductor.
